(19) United States
(12) Patent Application Publication
(10) Pub. No.: US 2022/0348501 A1
(43) Pub. Date: Nov. 3, 2022

(54) ALKALI-SILICA MITIGATION ADMIXTURE, METHODS OF MAKING AND KITS COMPRISING THE SAME

(71) Applicant: The Penn State Research Foundation, University Park, PA (US)

(72) Inventors: Farshad Rajabipour, State College, PA (US); Gopakumar Kaladharan, State College, PA (US); Tiffany Szeles, Keansburg, NJ (US); Shelley M. Stoffels, State College, PA (US)

(21) Appl. No.: 17/641,188

(22) PCT Filed: Sep. 9, 2020
(86) PCT No.: PCT/US2020/049881

§ 371 Date: Mar. 8, 2022

Related U.S. Application Data
(60) Provisional application No. 62/897,431, filed on Sep. 9, 2019.
(60) Provisional application No. 62/978,890, filed on Feb. 20, 2020.

(51) Int. Cl. C04B 24/10; C04B 28/04; C04B 24/04; C04B 24/06; C04B 22/08; C04B 22/12; C04B 22/16; C04B 22/14; C04B 22/06; C04B 20/10; C04B 40/00

(52) U.S. Cl. CPC C04B 24/10; C04B 28/04; C04B 24/04; C04B 24/06; C04B 22/085; C04B 22/128; C04B 22/16; C04B 22/126; C04B 22/142; C04B 22/06; C04B 20/10; C04B 40/0046; C04B 2111/2023

(57) ABSTRACT

The present invention relates in part to an alkali-silica reaction mitigation admixture comprising an organic or inorganic salt that provides an aluminum, calcium, magnesium, or iron cation. The present invention also relates to a method of mitigating the alkali-silica reaction in a concrete product. The invention is further related to kits comprising the alkali-silica mitigation admixture and an instruction booklet.

### CROSS-REFERENCE TO RELATED APPLICATIONS

The present application is a 35 U.S.C. § 371 national phase application from, and claiming priority to, International Application No. PCT/US2020/049881, filed Sep. 9, 2020, which claims priority to U.S. Provisional Application Nos. 62/897,431, filed Sep. 9, 2019, and 62/978,890, filed Feb. 20, 2020, all of which are incorporated by reference herein in their entireties.

### STATEMENT REGARDING FEDERALLY SPONSORED RESEARCH OR DEVELOPMENT

This invention was made with government support under Grant No. CMMI1254333 awarded by the National Science Foundation. The Government has certain rights in the invention.

### BACKGROUND OF THE INVENTION

Concrete is the most widely produced human-made material in the world. The per-capita concrete production in the United States is estimated at 2 tons/year (van Oss, H. G., Cement statistics and information, USGS Minerals Information, 2017), and globally the industry is worth $500 billion (Ready-mix concrete market size and forecast by application, by region, and trend analysis from 2013-2024, Grand View Research, 2016).

Alkali-silica reaction (ASR), along with reinforcing steel corrosion, is one of the most major issues plaguing concrete structures, requiring significant investment for maintenance, repair, or replacement of critical structures. For example, in Pennsylvania, PennDOT recently replaced 46 miles of I-84 concrete highway in Pike County that was damaged by ASR. The construction cost alone (user cost ignored) was over $66 million (http://www.pahighways.com/interstates/I84.html, Accessed: Nov. 8, 2018). Similarly, over 500 bridges in Pennsylvania are being replaced through a public-private partnership (P3), many of which are affected by ASR. The total cost of this P3 project is estimated to be $899 million (http://www.pennlive.com/politics/index.ssf/2014/10/team_awarded_multi-year_contra.html, Accessed: Nov. 8, 2018; http://parapidbridges.com/, Accessed: Nov. 8, 2018).

ASR is a deleterious reaction between certain reactive silicates (found in natural aggregates, sand, and gravel used in concrete) and the high-pH pore solution of concrete, which primarily initiates from the alkali sulfates present in Portland cement (Poole, A. B., “Introduction to alkali-aggregate reaction in concrete”, The Alkali Silica Reaction in Concrete, R. N. Swamy Ed., Van Nostrand Reinhold, New York, 1992; Glasser, F. P., Chemistry of the alkali-aggregate reaction, in: R. N. Swamy (Ed.), Alkali-Silica React. Concr., Van Nostrand Reinhold, New York, 1992; Rajabipour, F., et al., Alkali-silica reaction: Current understanding of the reaction mechanisms and the knowledge gaps, Cem. Concr. Res. 76 (2015), 130-146). Other sources of high pH could include alkalis originating from aggregates, supplementary cementitious materials (SCMs), chemical admixtures, and de-icing chemicals applied to concrete structures. ASR produces a form of silica gel (known as the ASR gel) which can absorb water and expand, thus cracking concrete from within (Gholizadeh-Vayghan, A., et al., J. Am. Ceram. Soc. 100 (2017) 3801-3818). This cracking would also accelerate other forms of concrete damage such as freezing and thawing and corrosion of reinforcing steel. To date, ASR has caused significant damage to critical infrastructure around the world, including roads, bridges, dams, retaining walls, and power plants. The deterioration of infrastructure due to this issue reduces the service life and increases the costs for maintenance, repair, and replacement (Poole, A. B., “Introduction to alkali-aggregate reaction in concrete”, The Alkali Silica Reaction in Concrete, R. N. Swamy Ed., Van Nostrand Reinhold, New York, 1992; Rajabipour, F., et al., Alkali-silica reaction: Current understanding of the reaction mechanisms and the knowledge gaps, Cem. Concr. Res. 76 (2015), 130-146; Fournier, B. et al., Report on the diagnosis, prognosis, and investigation of alkali-silica reaction (ASR) in transportation structures, Report #FHWA-HIF-09-004, Federal Highway Administration, Washington, D. C, 2010; U.S. Nuclear Regulatory Commission, Special NRC oversight at Seabrook Nuclear Power Plant: concrete degradation, (n.d.). https://www.nrc.gov/reactors/operating/ops-experience/concrete-degradation.html (accessed Jun. 14, 2020)).

Current ASR mitigation strategies, such as lithium-based admixtures and use of SCMs such as fly ash and slag, have a variety of concerns associated with them. Lithium admixtures are expensive (adding ˜50% to the cost of concrete) and there is high demand for lithium in other industries (e.g., car batteries). There has been a steady decline in the supply and quality of fly ash, with the supply declining by over 50% during the last decade due to coal power plant closures or conversion to natural gas fuel. It is estimated that by the year 2030, the annual supply of specification-compliant freshly produced fly ash in the United States will be ˜14 million tons, while the demand will exceed ˜35 million tons (American Road & Transportation Builders Association, “Production and use of coal combustion products in the U.S.; Market forecast through 2033”, 2015, 1-48). Ground granulated blast furnace slag is less effective at mitigating ASR and is available in even shorter supply—North America relies on imports from Europe and Asia and total world supply is only 5% of cement clinker produced (Thomas, M. D. A., Cement and Concrete Research, 2011, 41:1224-1231; van Oss, H. G., USGS data on iron and steel slag, USGS Mineral Resources Program, 2017; Scrivener, K. L, The Indian Concrete Journal, 2014, 88:11-21). It is estimated that the global concrete admixtures market is worth over $18 billion in 2019 (http://www.prnewswire.com/news-releases/concrete-admixtures-market-consumption-worth-1826362-million-by-2019-278367321.html), Accessed Jan. 27, 2020). Given the issues with the current ASR mitigation strategies, there is a good market for a new and reliable ASR inhibiting admixture.

There is a need in the art for ASR mitigating admixtures and for methods of using such admixtures to mitigate ASR in a cured concrete. The present invention is directed to these and other important ends.

### SUMMARY OF THE INVENTION

Some embodiments of the invention disclosed herein are set forth below, and any combination of these embodiments (or portions thereof) may be made to define another embodiment.

In a first aspect of the invention, there is provided a cementitious composition comprising: i) cement; and ii) an admixture for mitigating alkali-silica reaction, the admixture comprising an organic or inorganic salt selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof, wherein the organic or inorganic salt is present in the cementitious composition in an amount of between 0.5% to 12% based on the weight of solids of the organic or inorganic salt as a percentage of the weight of solids of the cement. In an embodiment, the organic or inorganic salt is present in the cementitious composition in an amount of between 3.0% to 12% based on the weight of solids of the organic or inorganic salt as a percentage of the weight of solids of the cement.

In an embodiment, the organic or inorganic salt is selected from the group consisting of: magnesium acetate, magnesium bromide, magnesium nitrate, magnesium nitrite, calcium acetate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, calcium acetate, calcium bromide, calcium formate, calcium nitrate, and combinations thereof.

In an embodiment, the cementitious composition comprises a slowly dissolving source of aluminum in an amount of between about 2% and 10% based on the weight of solids of the slowly dissolving source of aluminum as a percentage of the weight of solids of the cement.

In an embodiment, the slowly dissolving source of aluminum comprises one or more of aluminum hydroxide, aluminum oxyhydroxide, aluminum phosphate, aluminum oxalate, aluminum oleate, aluminum hypophosphite, aluminum benzoate, aluminum fluoride.

In an embodiment, the cementitious composition further comprises one or more additional additives selected from the group consisting of: water, coarse aggregates, fine aggregates, mineral fillers, retarders, accelerators, water-reducing additives, plasticizers, air entrainers, corrosion inhibitors, specific performance admixtures, lithium admixtures, supplementary cementitious materials (SCMs), fibers, and combinations thereof.

In an embodiment, the organic or inorganic salt further comprises a coating of a polymeric or non-polymeric delayed release agent.

In an embodiment, the cementitious composition comprises: i) cement; ii) an admixture for mitigating alkali-silica reaction, the admixture comprising an organic or inorganic salt selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof, wherein the organic or inorganic salt is present in the cementitious composition in an amount of between 0.5% to 12% based on the weight of solids of the organic or inorganic salt as a percentage of the weight of solids of the cement. In an embodiment, the organic or inorganic salt is present in the cementitious composition in an amount of between 3.0% to 12% based on the weight of solids of the organic or inorganic salt as a percentage of the weight of solids of the cement; iii) one or more of coarse aggregates, fine aggregates, and mineral fillers; and iv) water. The invention further relates to a concrete product comprising the cementitious composition. For each embodiment herein describing a cementitious composition there is a corresponding embodiment describing a concrete product comprising the cementitious composition.

The invention also relates to a method of mitigating alkali-silica reaction in a concrete product, the method comprising: providing cement, cement clinker, or cement clinker derived material; providing an organic or inorganic salt comprising an aluminum, calcium, magnesium, or iron cation; mixing the cement, cement clinker, or cement clinker derived material with an amount of the organic or inorganic salt to form a cement mixture; adding water and, optionally, aggregates or other concrete additives or both, to the cement mixture to form a fresh concrete mixture having a pH of between about 12.0 and 13.65; and pouring and curing the fresh concrete mixture to form a concrete product having a pore solution pH that is maintained between about 12.0 and 13.65 over a period of 28 days after forming the fresh concrete; wherein the cement, cement clinker, or cement clinker derived material and the organic or inorganic salt are provided in powder or granular form before or after mixing them, but before forming a fresh concrete mixture.

In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, magnesium nitrite, calcium acetate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, calcium acetate, calcium bromide, calcium formate, calcium nitrate, and combinations thereof.

In an embodiment, the step of mixing the cement, cement clinker, or cement clinker derived material with an amount of an organic or inorganic salt to form a cement mixture comprises the step of adding the organic or inorganic salt in an amount of between about 0.5 wt % and 12 wt %, or between about 3 wt % and 12 wt %, based on the weight of solids of the organic or inorganic salt as a percentage of the weight of solids of the cement.

In an embodiment, the method, or any step thereof, further comprises the step of adding a slowly dissolving source of aluminum.

In an embodiment, the cement, cement clinker, or cement clinker derived material solids are dry-blended or inter-ground with the organic or inorganic salt solids at an amount of the organic or inorganic salt so that a homogeneous concrete mixture made with the cement mixture will have a pH of between about 12.0 and 13.65.

In an embodiment, the method, or any step thereof, further comprises the step of dry-blending or inter-grinding one or more supplementary cementitious material (SCM) with the organic or inorganic salt.

In an embodiment, the organic or inorganic salt is provided as a coating on an SCM.

In an embodiment, the organic or inorganic salt is dissolved or dispersed in a solvent to form a liquid admixture.

The invention further relates to a method of mitigating alkali silica reaction in a concrete product, the method comprising: providing cement; mixing the cement with an organic or inorganic salt, which provides an aluminum, calcium, magnesium, or iron cation, and water and other concrete ingredients to form a fresh concrete mixture; and pouring and curing the fresh concrete mixture to form a concrete product with a corresponding pore solution pH of between 12.0 and 13.65.

In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, magnesium nitrite, calcium acetate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof.

In an embodiment, the organic or inorganic salt is selected from the group consisting of: magnesium acetate, magnesium bromide, magnesium nitrate, calcium acetate, calcium bromide, calcium formate, calcium nitrate, and combinations thereof.

In an embodiment, the step of mixing the cement with an organic or inorganic salt and other concrete ingredients to form a fresh concrete mixture comprises the step of adding the organic or inorganic salt in an amount of between about 0.5 wt % and 12 wt %, or between about 3 wt % and 12 wt %, based on the weight of solids of the organic or inorganic salt as a percentage of the weight of solids of the cement.

In an embodiment, the method, or any step thereof, further comprises the step of adding a slowly dissolving source of aluminum.

In an embodiment, the slowly dissolving source of aluminum comprises one or more of aluminum hydroxide, aluminum oxyhydroxide, aluminum phosphate, aluminum oxalate, aluminum oleate, aluminum hypophosphite, aluminum benzoate, aluminum fluoride.

In an embodiment, the fresh concrete mixture has a pH of between about 12.0 and 13.65 and the pore solution pH of the concrete product is maintained between about 12.0 and 13.65 over a period of 28 days after forming the fresh concrete mixture.

In an embodiment, the method, or any step thereof, further comprises the step of dry-blending or inter-grinding one or more SCM with the organic or inorganic salt.

In an embodiment, the organic or inorganic salt is provided as a coating on an SCM.

In an embodiment, the organic or inorganic salt is dissolved or dispersed in a solvent to form a liquid admixture.

### BRIEF DESCRIPTION OF THE DRAWINGS

The following detailed description of various embodiments of the invention will be better understood when read in conjunction with the appended drawings. For the purpose of illustrating the invention, there are shown in the drawings illustrative embodiments. It should be understood, however, that the invention is not limited to the precise arrangements and instrumentalities of the embodiments shown in the drawings.

FIG. 1 is a flowchart of exemplary method 100 of introducing ASR mitigating salts into cement or cement clinker in order to mitigate ASR in a resulting concrete product.

FIG. 2 is a flowchart of exemplary method 200 of introducing ASR mitigating salts into a fresh concrete mixture in order to mitigate ASR in a resulting concrete product.

FIG. 3 is a flowchart of exemplary method 300 for introducing ASR inhibiting salts in a solid form inter-ground with Portland cement clinker.

FIG. 4 is a flowchart of exemplary method 400 for introducing the ASR inhibiting salts in a solid form pre-blended with Portland cement.

FIG. 5 is a flowchart of exemplary method 500 for introducing the ASR inhibiting salts in a solid form pre-blended or inter-ground with supplementary cementitious materials (SCMs).

FIG. 6 is a flowchart of exemplary method 600 for introducing the ASR inhibiting salts in a solid form admixed into a concrete mixture at the time of preparing such a mixture.

FIG. 7 is a flowchart of exemplary method 700 for introducing the ASR inhibiting salts in a pre-dissolved (liquid) form admixed into a concrete mixture at the time of preparing such mixture.

FIG. 8 is a flowchart of exemplary method 800 for introducing the ASR inhibiting salts in a pre-dissolved (liquid) form sprayed onto or mixed with supplementary cementitious materials (SCMs).

FIG. 9 depicts the abundance (atom fraction) of elements in Earth's upper continental crust as a function of atomic number.

FIG. 10, comprising FIG. 10A, FIG. 10B, FIG. 10C, FIG. 10D, and

FIG. 10E depicts speciation plots for various metal hydroxides. FIG. 10A depicts a speciation plot of Ca. FIG. 10B depicts a speciation plot of Mg. FIG. 10C depicts a speciation plot of Fe(II). FIG. 10D depicts a speciation plot of Fe(III). FIG. 10E depicts a speciation plot of Al.

FIG. 11 depicts the ASTM C1293 concrete prism test results for concrete containing 10% aluminum nitrate (AN), 10% ferric nitrate (FN), or 10% AN+5% aluminum hydroxide (AH) salts in comparison with a control mixture without salt (100% Ordinary Portland Cement (OPC)). A highly reactive (R2) coarse aggregate was used in all concretes. Percentage of salts is expressed as a replacement percentage of the OPC.

FIG. 12 depicts the pore solution pH of 100% OPC, 10% AN, and 10% FN mixtures at 0, 7, and 28 days of age. Percentage of salts is expressed as a replacement percentage of the OPC.

FIG. 13 depicts the compressive strength of mortars incorporating the listed salts with 100% OPC (control), 10% AN, and 10% FN as a function of age. Percentage of salts is expressed as a replacement percentage of the OPC.

FIG. 14 depicts the relative flow of mortar mixtures incorporating the listed salts as a percentage of control OPC mortar flow. Percentage of salts is expressed as a replacement percentage of the OPC.

FIG. 15 depicts the compressive strength of mortar mixtures over time as a percentage of control OPC strength. Percentage of salts is expressed as a replacement percentage of the OPC.

FIG. 16 depicts the setting times of tested mortars prepared with various salts, measured according to ASTM C403. Percentage of salts is expressed as a replacement percentage of the OPC.

FIG. 17 depicts the ASTM C1293 concrete prism test results for concrete containing candidate salts in comparison with a control mixture without salt (100% Ordinary Portland Cement (OPC)). A highly reactive (R2) aggregate was used in all concretes. Percentage of salts is expressed as a replacement percentage of the OPC.

### DETAILED DESCRIPTION

The present invention can be understood more readily by reference to the following detailed description, examples, drawings, and claims, and their previous and following description. However, it is to be understood that this invention is not limited to the specific compositions, articles, devices, systems, and/or methods disclosed unless otherwise specified, and as such, of course, can vary. While aspects of the present invention can be described and claimed in a particular statutory class, such as the composition of matter statutory class, this is for convenience only and one of skill in the art will understand that each aspect of the present invention can be described and claimed in any statutory class.

It is to be understood that the Figures and descriptions of the present invention have been simplified to illustrate elements that are relevant for a clear understanding of the present invention, while eliminating, for the purpose of clarity, many other elements found in composite materials and methods of making. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any manner. Embodiments illustrated under any heading or in any portion of the disclosure may be combined with embodiments illustrated under the same or any other heading or other portion of the disclosure.

Any combination of the elements described herein in all possible variations thereof is encompassed by the invention unless otherwise indicated herein or otherwise clearly contradicted by context.

Unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification. It is to be understood that both the foregoing general description and the following detailed description are exemplary and explanatory only and are not restrictive.

All publications mentioned herein are incorporated herein by reference to disclose and describe the methods and/or materials in connection with which the publications are cited.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e. to at least one) of the grammatical object of the article. By way of example, “an element” means one element or more than one element.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of 20% or ±10%, more preferably ±5%, even more preferably ±1%, and still more preferably ±0.1% from the specified value, as such variations are appropriate to perform the disclosed methods.

As used herein, the term “cement” refers to an inorganic material or a mixture of inorganic materials that sets and develops strength by chemical reaction with water by formation of hydrates. Examples of cement include, but are not limited to, Portland cement (meeting ASTM C150 specifications or equivalent—ASTM C150/C150M-19a—Standard Specification for Portland Cement, ASTM International, 2019, West Conshohocken, Pa., USA), hydraulic cement (meeting ASTM C1157 specifications or equivalent—ASTM C1157/C1157M-20—Standard Performance Specification for Hydraulic Cement, ASTM International, 2020, West Conshohocken, Pa., USA), and blended hydraulic cements (meeting ASTM C595 specifications or equivalent—ASTM C595/C595M-20—Standard Specification for Blended Hydraulic Cement, ASTM International, 2020, West Conshohocken, Pa., USA).

As used herein, the term “cement clinker” refers to a solid material produced in the manufacture of cement as an intermediary product. The lumps or nodules of clinker are usually of diameter 3-25 mm and dark grey in color. Portland cement clinker is produced by heating limestone powder and pulverized aluminum silicate materials, such as clay, sand, or fly ash, to the point of clinkerization at about 1400-1500° C. inside a cement kiln.

As used herein, the term “supplementary cementitious material (SCM)” refers to an inorganic material that contributes to the properties of a cementitious mixture through hydraulic or pozzolanic activity, or both. Examples of SCM include, but are not limited to, fly ash (meeting ASTM C618 specifications or equivalent—ASTM C618-19—Standard Specification for Coal Fly Ash and Raw or Calcined Natural Pozzolan for Use in Concrete, ASTM International, 2019, West Conshohocken, Pa., USA), silica fume (meeting ASTM C1240 specifications or equivalent—ASTM C1240-20—Standard Specification for Silica Fume Used in Cementitious Mixtures, ASTM International, 2020, West Conshohocken, Pa., USA), slag cement (meeting ASTM C989 specifications or equivalent—ASTM C989/C989M-18a—Standard Specification for Slag Cement for Use in Concrete and Mortars, ASTM International, 2018, West Conshohocken, Pa., USA), rice husk ash, raw or calcined natural pozzolans (meeting ASTM C618 specifications or equivalent, see above), ground/powder limestone, ground/powder quartz, blended supplementary cementitious materials (meeting ASTM C1697 specifications or equivalent—ASTM C1697-18—Standard Specification for Blended Supplementary Cementitious Materials, ASTM International, 2018, West Conshohocken, Pa., USA), and alternative supplementary cementitious materials (meeting ASTM C1709 or equivalent—ASTM C1709-18—Standard Guide for Evaluation of Alternative Supplementary Cementitious Materials for Use in Concrete, ASTM International, 2018, West Conshohocken, Pa., USA).

As used herein, the term “concrete product” refers to a product formed from a mixture of cement, water, and aggregates and can include products such as, but not limited to, concrete, stucco, fiber cement composites, and mortar. This includes pre-cast, cast-in-place, and ready-mixed concrete materials and products. Herein, use of the term “fresh concrete” is consistent with its use in the art. Fresh concrete includes a freshly made concrete (from 0 hours) that is still wet and extends to that stage of concrete in which the concrete can be molded and it is in plastic (deformable) state. Concrete hardening can take as long as 6 hours, or even as long as 18 hours.

The terms “ASR mitigating salt” and “ASR inhibiting salt” are used interchangeably throughout the disclosure and refer to an organic or inorganic salt which can lower/mitigate/inhibit/prevent/decrease/etc. the occurrence of an alkali-silica reaction.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. Further, for lists of ranges, including lists of lower preferable values and upper preferable values, unless otherwise stated, the range is intended to include the endpoints thereof, and any combination of values therein, including any minimum and any maximum values recited.

### ASR Mitigation Admixture

In one aspect, the present invention relates to an admixture for ASR mitigation comprising one or more organic or inorganic salts which provide an aluminum, calcium, magnesium, or iron cation. The aluminum, calcium, magnesium, or iron salt can be any such salt known to a person of skill in the art. Such salts include, but are not limited to, aluminum acetate, aluminum benzoate, aluminum bromate, aluminum bromide, aluminum chlorate, aluminum chloride, aluminum citrate, aluminum fluoride, aluminum formate, aluminum gluconate, aluminum hypophosphite Al(H₂PO₂)₃, aluminum iodate, aluminum iodide, aluminum lactate, aluminum aluminum nitrate, aluminum oleate, aluminum oxalate, aluminum perchlorate, aluminum phosphate, aluminum propionate, aluminum salicylate, aluminum sulfate, ferrous acetate, ferrous bicarbonate, ferrous bromate, ferrous bromide, ferrous carbonate, ferrous chloride, ferrous citrate, ferrous dihydrogen phosphate, ferrous fluoride, ferrous formate, ferrous fumarate, ferrous gluconate, ferrous hydrogen phosphate, ferrous hypophosphite, ferrous iodate, ferrous iodide, ferrous lactate, ferrous nitrate, ferrous nitrite, ferrous oleate, ferrous oxalate, ferrous perchlorate, ferrous phosphate, ferrous phosphite, ferrous sulfate, ferrous sulfite, ferric acetate, ferric benzoate, ferric bicarbonate, ferric bromate, ferric bromide, ferric citrate, ferric chloride, ferric fluoride, ferric formate, ferric glycerophosphate, ferric hypophosphite, ferric iodate, ferric nitrate, ferric nitrite, ferric oxalate, ferric oxide, ferric perchlorate, ferric phosphate, ferric phosphide, ferric pyrophosphate, ferric sulfate, magnesium acetate, magnesium bicarbonate, magnesium bromate, magnesium bromide, magnesium carbonate, magnesium chlorate, magnesium chloride, magnesium citrate, magnesium dibenzoate, magnesium dihydrogen phosphate, magnesium fluoride, magnesium formate, magnesium di-gluconate, magnesium glycerophosphate, magnesium hydrogen phosphate, magnesium iodate, magnesium iodide, magnesium lactate, magnesium laurate, magnesium malate, magnesium myristate, magnesium nitrate, magnesium nitrite, magnesium oleate, magnesium oxalate, magnesium perchlorate, trimagnesium phosphate, magnesium phosphonate, magnesium stearate, magnesium sulfate, magnesium sulfite, magnesium tetrahydrogen phosphate, calcium acetate, calcium benzoate., calcium bicarbonate, calcium bromate, calcium bromide, calcium carbonate (calcite), calcium carbonate (aragonite), calcium carbonate (vaterite), calcium chlorate, calcium chloride, calcium citrate, calcium di-gluconate, calcium dihydrogen phosphate, calcium fluoride, calcium formate, calcium fumarate, calcium glycerophosphate, calcium hydrogen phosphate, calcium hypophosphite (phosphinate), calcium iodate, calcium iodide, calcium isobutyrate, calcium lactate, calcium 1-quinate, calcium malate, calcium methylbutyrate, calcium nitrate, calcium nitrite, calcium oleate, calcium oxalate, calcium perchlorate, calcium permanganate, calcium phosphate, calcium phosphite, calcium phosphonate, calcium propionate, calcium salicylate, calcium sulfate, calcium sulfite, calcium valerate, and combinations thereof.

In one embodiment, the salt comprises magnesium acetate. In one embodiment, the salt comprises magnesium acetate tetrahydrate. In one embodiment, the salt comprises magnesium bromide. In one embodiment, the salt comprises magnesium bromide hexahydrate. In one embodiment, the salt comprises magnesium nitrate. In one embodiment, the salt comprises magnesium nitrate hexahydrate. In one embodiment, the salt comprises magnesium nitrite. In one embodiment, the salt comprises calcium acetate. In one embodiment, the salt comprises calcium acetate monohydrate. In one embodiment, the salt comprises calcium benzoate. In one embodiment, the salt comprises calcium benzoate trihydrate. In one embodiment, the salt comprises calcium bromide. In one embodiment, the salt comprises calcium bromide dihydrate. In one embodiment, the salt comprises calcium formate. In one embodiment, the salt comprises calcium nitrate. In one embodiment, the salt comprises calcium nitrate tetrahydrate. In one embodiment, the salt comprises calcium nitrite. In one embodiment, the salt comprises magnesium sulfate. In one embodiment, the salt comprises anhydrous magnesium sulfate. In one embodiment, the salt comprises ferric nitrate. In one embodiment, the salt comprises iron (II) fumarate. In one embodiment, the salt comprises anhydrous iron (II) fumarate. In one embodiment, the salt is selected from one or more of the above salts.

In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, and combinations thereof.

In one embodiment, the mixture of organic or inorganic salt and cement or cement clinker (or cement clinker derived material, such as ground or partially ground cement clinker) comprises between about 0.1% and 50% (w/w) of organic or inorganic salt (percentage based on weight of solids of the organic or inorganic salt as a percentage of the weight of solids of cement or cement clinker). In one embodiment, the mixture comprises between about 0.1% and 45% (w/w) of organic or inorganic salt. In one embodiment, the mixture comprises between about 0.1% and 40% (w/w) of organic or inorganic salt. In one embodiment, the mixture comprises between about 0.1% and 35% (w/w) of organic or inorganic salt. In one embodiment, the mixture comprises between about 0.1% and 30% (w/w) of organic or inorganic salt. In one embodiment, the mixture comprises between about 0.1% and 25% (w/w) of organic or inorganic salt. In one embodiment, the mixture comprises between about 0.1% and 20% (w/w) of organic or inorganic salt. In one embodiment, the mixture comprises between about 0.1% and 15% (w/w) of organic or inorganic salt. In one embodiment, the mixture comprises between about 0.5% and 12% (w/w) of organic or inorganic salt, such as, for example, between about 2.0% and 12%, between about 2.5% and 12%, between about 3.0% and 12%, between about 3.5% and 12%, between about 4.0% and 12%, between about 5.0% and 12%, or between about 6.0% and 12% (w/w) of organic or inorganic salt. In one embodiment, the mixture comprises between about 0.5% and 10% (w/w) of organic or inorganic salt, such as, for example, between about 2.0% and 10%, between about 2.5% and 10%, between about 3.0% and 10%, between about 3.5% and 10%, between about 4.0% and 10%, between about 5.0% and 10%, or between about 6.0% and 10% (w/w) of organic or inorganic salt. In one embodiment, the mixture comprises between about 0.5% and 8% (w/w) of organic or inorganic salt, such as, for example, between about 2.0% and 8%, between about 2.5% and 8%, between about 3.0% and 8%, between about 3.5% and 8%, between about 4.0% and 8%, between about 5.0% and 8%, or between about 6.0% and 8% (w/w) of organic or inorganic salt. In one embodiment, the mixture comprises between about 2% and 12% (w/w) of organic or inorganic salt. In one embodiment, the mixture comprises between about 3% and 10% (w/w) of organic or inorganic salt.

In one embodiment, the organic or inorganic salt has a water solubility limit that is greater than the water solubility limit of its respective hydroxide.

In one embodiment, the ASR mitigation admixture comprises a slowly dissolving source of aluminum. Exemplary slowly dissolving sources of aluminum include, but are not limited to, aluminum hydroxide, aluminum oxyhydroxide, aluminum phosphate, aluminum oxalate, aluminum oleate, aluminum hypophosphite, aluminum benzoate, aluminum fluoride, and combinations thereof. Herein, a slowly dissolving source of aluminum is a source of aluminum having a solubility at pH=13 of 0.2 mol/lit or lower.

In one embodiment, the (w/w) ratio of the organic or inorganic salt to the slowly dissolving source of aluminum is between about 20:1 and 1:1. In one embodiment, the (w/w) ratio of the organic or inorganic salt to the slowly dissolving source of aluminum is between about 18:1 and 1:1; or between about 16:1 and 1:1; or between about 14:1 and 1:1; or between about 12:1 and 1:1; or between about 10:1 and 1:1; or between about 8:1 and 1:1; or between about 6:1 and 1:1; or between about 4:1 and 1:1. In one embodiment, the (w/w) ratio of the organic or inorganic salt to the slowly dissolving source of aluminum is between about 3:1 and 1:1.

In one embodiment, the ASR mitigation admixture comprises a solvent. In one embodiment, the ASR mitigation admixture comprises an organic solvent. Exemplary organic solvents include, but are not limited to, diethyl ether, dichloromethane, acetone, methanol, ethanol, isopropanol, n-propanol, chloroform, hexanes, benzene, toluene, dimethylformamide, xylenes, and combinations thereof. In one embodiment, the ASR mitigation admixture comprises an aqueous solvent. Exemplary aqueous solvents include, but are not limited to, tap water, distilled water, deionized water, saline, saltwater, and combinations thereof. In one embodiment, the ASR mitigation admixture is mixed with an aqueous solvent. In one embodiment, the ASR mitigation admixture is dissolved in an aqueous solvent. In one embodiment, the ASR mitigation admixture comprises an organic or inorganic salt that provides an aluminum, calcium, magnesium, or iron cation which dissolves in the aqueous solvent. In one embodiment, the ASR mitigation admixture comprises a combination of two or more organic or inorganic salts, at least one of which provides an aluminum, calcium, magnesium, or iron cation which dissolves in the aqueous solvent. In one embodiment, the ASR mitigation admixture comprises one or more additives described elsewhere herein. In an embodiment, one or more of the additives dissolves in the aqueous solvent.

In one embodiment, the ASR mitigation admixture comprises one or more additives. The additive can be any additive known to a person of skill in the art.

In one embodiment, the ASR mitigation admixture comprises an organic or inorganic salt, or combinations thereof, which provides an aluminum, calcium, magnesium, or iron cation that is blended with one or more additives. In one embodiment, the ASR mitigation admixture comprises an organic or inorganic salt which provides an aluminum, calcium, magnesium, or iron cation that is inter-ground with one or more additives. In one embodiment, the ASR mitigation admixture comprises an organic or inorganic salt, or combinations thereof, which provides an aluminum, calcium, magnesium, or iron cation that is inter-ground with cement clinker. In one embodiment, the ASR mitigation admixture comprises an organic or inorganic salt, or combinations thereof, which provides an aluminum, calcium, magnesium, or iron cation that is inter-ground with cement clinker and with one or more additives. In one embodiment, the ASR mitigation admixture comprises an organic or inorganic salt, or combinations thereof, which provides an aluminum, calcium, magnesium, or iron cation that is blended with cement. In one embodiment, the ASR mitigation admixture comprises an organic or inorganic salt, or combinations thereof, which provides an aluminum, calcium, magnesium, or iron cation that is blended with cement and with one or more additives. In one embodiment, the ASR mitigation admixture comprises an organic or inorganic salt, or combinations thereof, which provides an aluminum, calcium, magnesium, or iron cation that is inter-ground or blended with an SCM. In one embodiment, the ASR mitigation admixture comprises an organic or inorganic salt, or combinations thereof, which provides an aluminum, calcium, magnesium, or iron cation that is inter-ground or blended with an SCM and with one or more additives.

In one embodiment, the ASR mitigation admixture comprises an organic or inorganic salt, or combinations thereof, which provides an aluminum, calcium, magnesium, or iron cation that is dissolved in an aqueous solvent, forming a liquid admixture. In one embodiment, the liquid admixture is added to fresh concrete during mixing. In one embodiment, the liquid admixture is applied to an SCM. In one embodiment, the liquid admixture is applied to one or more additives. In one embodiment, the liquid admixture coats one or more additives. In one embodiment, the liquid admixture is sprayed onto one or more additives.

In some embodiments, the mode of addition of an additive, or the order of addition of an additive, is not particularly limited. In some embodiments, there may be a preferred mode of addition of an additive, or a preferred order of addition of an additive, or both. The additives disclosed herein may find use in any of these scenarios.

In one embodiment, the additive comprises a retarder. The retarder can be any retarding agent known to a person of skill in the art. In one embodiment, when the ASR mitigation admixture is mixed with cement, the retarder decreases the rate of cement hydration and/or increases the setting time of the cement. Exemplary retarders include, but are not limited to, calcium lignosulfonate; sodium and calcium salts of hydroxycarboxylic acids, including salts of gluconic, citric, and tartaric acid; salts of lignosulfonic acids; hydroxycarboxylic acids; carbohydrates; oxides of Pb and Zn; phosphates; magnesium salts; fluorates; borates; calcium sulfate; gypsum; starch and cellulose products; sugar; and combinations thereof. In one embodiment, organic or inorganic salt which provides an aluminum, calcium, magnesium, or iron cation acts as a retarder in concrete.

In one embodiment, the additive comprises a reaction accelerator. The accelerator can be any accelerating agent known to a person of skill in the art. In one embodiment, when the ASR mitigation admixture is mixed with cement, the accelerator increases the rate of cement hydration and/or decreases the setting time of the cement. Exemplary accelerating agents include, but are not limited to, calcium chloride, calcium formate, calcium nitrate, calcium nitrite, triethanolamine, sodium thiocyanate, calcium sulfoaluminate, sodium chloride, and combinations thereof. In one embodiment, the organic or inorganic salt which provides an aluminum, calcium, magnesium, or iron cation acts as an accelerator in concrete.

In one embodiment, the additive comprises a water-reducing agent or plasticizer. The water-reducing agent or plasticizer can be any water-reducing agent or plasticizer known to a person of skill in the art. Exemplary water-reducing agents or plasticizers include, but are not limited to, lignosulfonates; sulfonated naphthalene formaldehyde condensate; sulfonated melamine formaldehyde condensate; acetone formaldehyde condensate; polycarboxylate ethers; cross-linked melamine- or naphthalene-sulfonates, referred to as PMS (polymelamine sulfonate) and PNS (polynaphthalene sulfonate); and combinations thereof.

In one embodiment, the additive comprises a lithium admixture. The lithium admixture can be any admixture known to a person of skill in the art. Exemplary lithium admixtures include, but are not limited to, lithium carbonate, lithium nitrate, lithium hydroxide, lithium chloride, lithium fluoride, lithium sulfate, and combinations thereof.

In one embodiment, the additive comprises an SCM. The SCM can be any SCM known to a person of skill in the art. Exemplary SCMs include, but are not limited to, ground granulated blast furnace slag, slag cement, fly ash, silica fume, natural pozzolans, ground bottom ash, ground glass, quartz powder, ground limestone, and combinations thereof. In one embodiment, the SCM is inter-ground or blended with a solid ASR mitigating admixture. In one embodiment, the SCM is coated with the liquid ASR mitigating admixture described elsewhere herein. In one embodiment, the SCM is coated with the liquid ASR mitigating admixture by spraying the admixture onto the SCM. In one embodiment, the SCM is fully coated with the ASR mitigating admixture. In another embodiment, the SCM is partially coated with the ASR mitigating admixture. In one embodiment, the SCM coated with the liquid admixture is a form of fly ash.

In one embodiment, the ASR mitigation admixture is coated with an agent that delays the dissolution or dispersion of the salt. In one embodiment, the organic or inorganic salt which provides an aluminum, calcium, magnesium, or iron cation is coated with a delayed release agent. In one embodiment, the slowly dissolving aluminum source is coated with a delayed release agent. In one embodiment, the ASR mitigation admixture comprises an organic or inorganic salt and a slowly dissolving aluminum source which are both coated with a delayed release coating. In another embodiment, the ASR mitigation admixture comprises an organic or inorganic salt, a slowly dissolving aluminum source, and one or more additives all of which are coated with a delayed release coating. The delayed release agent can be any such agent known to a person of skill in the art.

In one embodiment, the delayed release agent comprises a polymer. Exemplary polymeric delayed release agents include, but are not limited to, homopolymers and copolymers of N-vinyl lactams, e.g., homopolymers and copolymers of N-vinyl pyrrolidone (e.g., polyvinylpyrrolidone), copolymers of N-vinyl pyrrolidone and vinyl acetate or vinyl propionate; cellulose esters and cellulose ethers (e.g., methylcellulose and ethylcellulose) hydroxyalkylcelluloses (e.g., hydroxypropylcellulose), hydroxyalkylalkylcelluloses (e.g., hydroxypropylmethylcellulose), cellulose phthalates (e.g., cellulose acetate phthalate and hydroxylpropylmethylcellulose phthalate) and cellulose succinates (e.g., hydroxypropylmethylcellulose succinate or hydroxypropylmethylcellulose acetate succinate); high molecular weight polyalkylene oxides such as polyethylene oxide and polypropylene oxide and copolymers of ethylene oxide and propylene oxide; polyacrylates and polymethacrylates (e.g., methacrylic acid/ethyl acrylate copolymers, methacrylic acid/methyl methacrylate copolymers, butyl methacrylate/2-dimethylaminoethyl methacrylate copolymers, poly(hydroxyalkyl acrylates), poly(hydroxyalkyl methacrylates)); polyacrylamides; vinyl acetate polymers such as copolymers of vinyl acetate and crotonic acid, partially hydrolyzed polyvinyl acetate; polyvinyl alcohol; oligo- and polysaccharides such as carrageenans, galactomannans and xanthan gum; and combinations thereof.

In one embodiment, the delayed release agent is non-polymeric. Exemplary non-polymeric delayed release agents include, but are not limited to, esters, hydrogenated oils, natural waxes, synthetic waxes, hydrocarbons, fatty alcohols, fatty acids, monoglycerides, diglycerides, triglycerides, and combinations thereof. Exemplary esters include, but are not limited to, glyceryl monostearate, e.g., CAPMUL GMS from Abitec Corp. (Columbus, Ohio); glyceryl palmitostearate; acetylated glycerol monostearate; sorbitan monostearate, e.g., ARLACEL 60 from Uniqema (New Castle, Del.); and cetyl palmitate, e.g., CUTINA CP from Cognis Corp. (DMsseldorf, Germany), magnesium stearate and calcium stearate. Exemplary hydrogenated oils include, but are not limited to, hydrogenated castor oil; hydrogenated cottonseed oil; hydrogenated soybean oil; olive oil; sesame oil; and hydrogenated palm oil. Exemplary waxes include, but are not limited to, carnauba wax, beeswax, and spermaceti wax. Exemplary hydrocarbons include, but are not limited to, microcrystalline wax and paraffin. Exemplary fatty alcohols include, but are not limited to, cetyl alcohol, e.g., CRODACOL C-70 from Croda Corp. (Edison, N.J.); stearyl alcohol, e.g., CRODACOL S-95 from Croda Corp; lauryl alcohol; and myristyl alcohol. Exemplary fatty acids include, but are not limited to, stearic acid, e.g., HYSTRENE 5016 from Crompton Corp. (Middlebury, Conn.); decanoic acid; palmitic acid; lauric acid; and myristic acid.

In one embodiment, the ASR mitigation admixture comprises cement. The cement can be any type of cement known to a person of skill in the art. Exemplary types of cement include, but are not limited to, Portland Cement (PC), Ordinary Portland Cement (OPC), Portland Pozzolana Cement (PPC), Rapid Hardening Cement, Quick Setting Cement, Low Heat Cement, Sulfates Resisting Cement, Blast Furnace Slag Cement, High Alumina Cement, White Cement, Colored Cement, Air Entraining Cement, Expansive Cement, Hydrographic Cement, Calcium Aluminate Cement, Calcium Sulfoaluminate Cement, Blended Hydraulic Cement, and combinations thereof. In one embodiment, the cement comprises OPC. In one embodiment, the cement comprises PC.

In one embodiment, the ASR mitigation admixture is inter-ground or mixed with cement to form blended cement. The cement mixed with the ASR mitigation admixture can be any cement known to a person of skill in the art. Exemplary types of cement are described elsewhere herein. In one embodiment, the cement comprises OPC. In one embodiment, the cement comprises PC. In some embodiments, the blended cement is then mixed with other concrete ingredients. The concrete ingredients mixed with the blended cement can be any concrete ingredients known to a person of skill in the art. In some embodiments, the blended cement is then mixed with other concrete ingredients at a ready-mixed concrete manufacturing plant. In some embodiments, the blended cement is then mixed with other concrete ingredients at a precast concrete manufacturing plant. The concrete ingredients mixed with the blended cement at the concrete manufacturing plant can be any concrete ingredients known to a person of skill in the art.

In one embodiment, the ASR mitigation admixture is mixed with cement clinker (or cement clinker derived material, such as ground or partially ground cement clinker). In one embodiment, the ASR mitigation admixture is inter-ground with cement clinker. The cement clinker can be any cement clinker known to a person of skill in the art. Exemplary cement clinkers include, but are not limited to, Portland Cement (PC) clinker, Ordinary Portland Cement (OPC) clinker, Rapid Hardening Cement clinker, Quick Setting Cement clinker, Low Heat Cement clinker, Sulfates Resisting Cement clinker, High Alumina Cement clinker, White Cement clinker, Colored Cement clinker, Expansive Cement clinker, Hydrographic Cement clinker, Calcium Aluminate Cement clinker, Calcium Sulfoaluminate Cement clinker, and combinations thereof. In one embodiment, the cement clinker is OPC clinker. In one embodiment, the cement clinker is PC clinker.

In one embodiment, the ASR mitigation admixture is added into a concrete mixture and mixed with other concrete ingredients such as cement, aggregates, water, and other additives. In one embodiment, the ASR mitigation admixture is added in powder form to a concrete mixture and mixed with other concrete ingredients such as cement, aggregates, water, and other additives. In another embodiment, the ASR mitigation admixture is pre-mixed with an aqueous solvent before it is added into a concrete mixture and mixed with other concrete ingredients such as cement, aggregates, water, and other additives. In one embodiment, the ASR mitigation admixture is dissolved in an aqueous solvent before it is added into a concrete mixture and mixed with other concrete ingredients such as cement, aggregates, water, and other additives. In one embodiment, the ASR mitigation admixture comprises an organic or inorganic salt that provides an aluminum, calcium, magnesium, or iron cation which dissolves in the aqueous solvent before the ASR mitigation admixture is mixed with other concrete ingredients such as cement, aggregates, water, and other additives. In one embodiment, the ASR mitigation admixture comprises one or more additives described elsewhere herein and one or more of the additives dissolves in the aqueous solvent before the ASR mitigation admixture is mixed with other concrete ingredients such as cement, aggregates, water, and other additives.

The concrete ingredients mixed with the ASR mitigation admixture can be any concrete ingredients known to a person of skill in the art. In one embodiment, the concrete ingredients mixed with the ASR mitigation admixture comprise cement. Exemplary types of cement are described elsewhere herein. In one embodiment, the concrete ingredients mixed with the ASR mitigation admixture comprise aggregates. Exemplary aggregates are described elsewhere herein (see, for example, discussion of step 140 of Method 1, below). In one embodiment, the concrete ingredients mixed with the ASR mitigation admixture comprise one or more of: cement, water, coarse aggregates, fine aggregates, mineral fillers, retarders, accelerators, plasticizers, water reducing agents, air entraining agents, lithium admixtures, corrosion inhibitors, specific performance admixtures, SCMs, fibers, and combinations thereof. Exemplary retarders, accelerators, plasticizers, water reducing agents, lithium admixtures, and SCMs are described elsewhere herein.

### Methods of Mitigating ASR in a Concrete Product

### Method 1

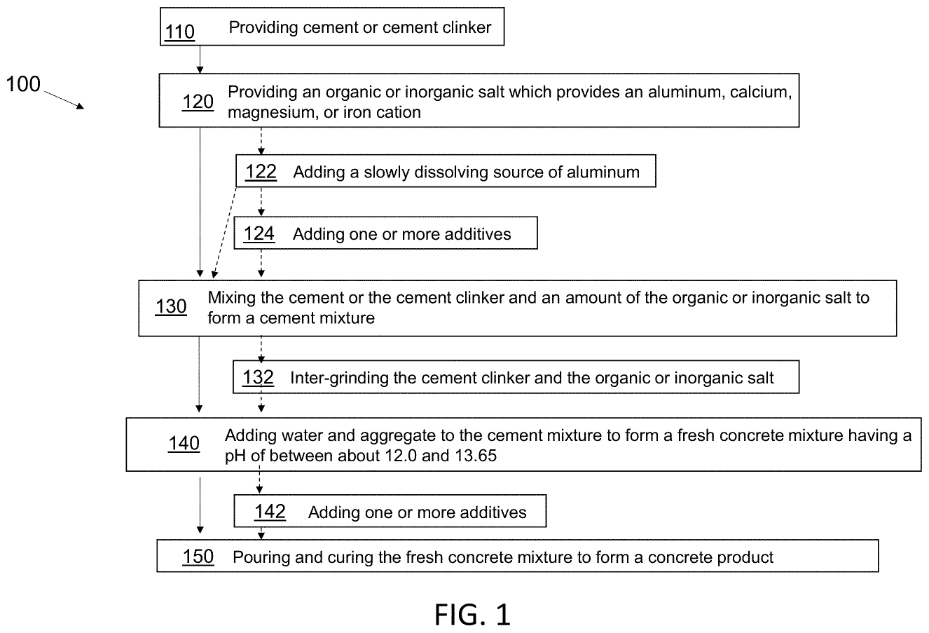

In one aspect, the invention relates to a method of mitigating ASR in a concrete product. Exemplary process 100 is shown in FIG. 1. In step 110, cement or cement clinker (or cement clinker derived material, such as ground or partially ground cement clinker) is provided. In step 120, an organic or inorganic salt which provides an aluminum, calcium, magnesium, or iron cation is provided. In step 130, the cement or cement clinker and an amount of the organic or inorganic salt are mixed to form a cement mixture. The amount of organic or inorganic salt is that amount required so that a homogeneous concrete mixture made with the cement mixture (step 140) will have a pH of between about 12.0 and 13.65. In step 140, water and aggregate are added to the mixture of cement or cement clinker and organic or inorganic salt, forming a fresh concrete mixture having a pH of between about 12.0 and 13.65. In step 150, the fresh concrete mixture is poured and cured to form a concrete product.

In step 110, the cement may be any type of cement known to a person of skill in the art. Exemplary types of cement are described elsewhere herein. In one embodiment, the cement comprises OPC. In one embodiment, the cement comprises PC. The cement clinker may be any type of cement clinker known to a person of skill in the art. Exemplary types of cement clinker are described elsewhere herein. In one embodiment, the cement clinker comprises OPC clinker. In one embodiment, the cement clinker comprises PC clinker. Cement clinker should be ground to a fine powder prior to step 140, in which water and aggregate are added to the cement mixture to form a fresh concrete mixture. Optionally, gypsum and/or other cement mill additives may be added to the cement clinker, either before or after grinding.

In step 120, the organic or inorganic salt that provides an aluminum, calcium, magnesium, or iron cation can be any such salt known to a person of skill in the art. Exemplary organic and inorganic salts are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, more than one organic or inorganic salt is provided. In one embodiment, the organic or inorganic salt is coated with a delayed release agent. In one embodiment, the organic or inorganic salt has a water solubility limit that is greater than the water solubility limit of the base analog (e.g., hydroxide) formed by the salt's cation. In some embodiments, the organic or inorganic salt is dissolved in an aqueous solvent to form the liquid admixture described elsewhere herein. In some embodiments, the liquid admixture comprising the organic or inorganic salt is coated onto one or more additives. Exemplary additives are described elsewhere herein. In one embodiment, the liquid admixture is sprayed onto one or more additives. In one embodiment, the liquid admixture is sprayed onto an SCM additive. In one embodiment, the liquid admixture is sprayed onto a form of fly ash.

In some embodiments, the step of providing an organic or inorganic salt further comprises step 122, wherein a slowly dissolving source of aluminum is added to the organic or inorganic salt. The slowly dissolving source of aluminum can be any slowly dissolving source of aluminum known to a person of skill in the art. Exemplary slowly dissolving sources of aluminum are described elsewhere herein. In one embodiment, the slowly dissolving source of aluminum is coated with a delayed release agent. In one embodiment, the slowly dissolving source of aluminum comprises aluminum hydroxide. In one embodiment, the slowly dissolving source of aluminum dissolves in the liquid admixture comprising the organic or inorganic salt. In one embodiment, the slowly dissolving source of aluminum does not dissolve in the liquid admixture and is dispersed in the liquid admixture. In one embodiment, the slowly dissolving source of aluminum is mixed in a powder form with a powder form of the organic or inorganic salt.

In some embodiments, the step of providing an organic or inorganic salt further comprises step 124, wherein one or more additives are added to the organic or inorganic salt. The additive can be any cement additive known to a person of skill in the art. Exemplary additives are described elsewhere herein. In one embodiment, the organic or inorganic salt is blended with the one or more additives. In one embodiment, the organic or inorganic salt is inter-ground with one or more additives. In one embodiment, the organic or inorganic salt is blended or inter-ground with an SCM. In one embodiment, the organic or inorganic salt is blended or inter-ground with one or more forms of fly ash. In one embodiment, the one or more additives dissolve in the liquid admixture comprising the organic or inorganic salt. In one embodiment, the one or more additives do not dissolve in the liquid admixture and are dispersed in the liquid admixture.

In step 130, the amount of organic or inorganic salt mixed with cement or cement clinker is the amount necessary to produce in step 140 a fresh concrete mixture having a pH of between about 12.0 and 13.65, which amounts are further discussed below. The mixing may occur using any process or method known to a person of skill in the art. In one embodiment, the organic or inorganic salt is blended with the cement or cement clinker. In one embodiment, the organic or inorganic salt is interground with the cement or cement clinker. In one embodiment, the organic or inorganic salt is premixed with the cement or cement clinker to form blended cement or blended cement clinker.

In one embodiment, the organic or inorganic salt has a water solubility limit that is greater than the water solubility limit of the base analog formed by the salt's cation and causes hydroxide or hydroxide complexes to precipitate, thus removing OH⁻ ions and reducing the pH of the fresh concrete mixture of step 140 to between about 12.0 and 13.65. In one embodiment, the organic or inorganic salt reduces the pH of the fresh concrete mixture to between about 12.0 and 13.50. In one embodiment, the hydroxides can be further consumed in the formation of other hydrated phases in the fresh concrete mixture. Exemplary hydrated phases include, but are not limited to, alumino-ferrite triphase (AFt) compounds (such as ettringite), alumino-ferrite monophase (AFm) compounds (such as mono-sulfo-aluminates and carbo-aluminates), calcium hydroxide, calcium aluminum hydrate, calcium silicate hydrate, and calcium alumino-silicate hydrate.

In one embodiment, the mixture of organic or inorganic salt and cement or cement clinker (or cement clinker derived material, such as ground or partially ground cement clinker) comprises between about 0.1% and 50% (w/w) of organic or inorganic salt (percentage based on weight of solids of the organic or inorganic salt as a percentage of the weight of solids of cement or cement clinker). In one embodiment, the mixture comprises between about 0.1% and 45% (w/w) of organic or inorganic salt. In one embodiment, the mixture comprises between about 0.1% and 40% (w/w) of organic or inorganic salt. In one embodiment, the mixture comprises between about 0.1% and 35% (w/w) of organic or inorganic salt. In one embodiment, the mixture comprises between about 0.1% and 30% (w/w) of organic or inorganic salt. In one embodiment, the mixture comprises between about 0.1% and 25% (w/w) of organic or inorganic salt. In one embodiment, the mixture comprises between about 0.1% and 20% (w/w) of organic or inorganic salt. In one embodiment, the mixture comprises between about 0.1% and 15% (w/w) of organic or inorganic salt. In one embodiment, the mixture comprises between about 0.5% and 12% (w/w) of organic or inorganic salt, such as, for example, between about 2.0% and 12%, between about 2.5% and 12%, between about 3.0% and 12%, between about 3.5% and 12%, between about 4.0% and 12%, between about 5.0% and 12%, or between about 6.0% and 12% (w/w) of organic or inorganic salt. In one embodiment, the mixture comprises between about 0.5% and 10% (w/w) of organic or inorganic salt, such as, for example, between about 2.0% and 10%, between about 2.5% and 10%, between about 3.0% and 10%, between about 3.5% and 10%, between about 4.0% and 10%, between about 5.0% and 10%, or between about 6.0% and 10% (w/w) of organic or inorganic salt. In one embodiment, the mixture comprises between about 0.5% and 8% (w/w) of organic or inorganic salt, such as, for example, between about 2.0% and 8%, between about 2.5% and 8%, between about 3.0% and 8%, between about 3.5% and 8%, between about 4.0% and 8%, between about 5.0% and 8%, or between about 6.0% and 8% (w/w) of organic or inorganic salt. In one embodiment, the mixture comprises between about 2% and 12% (w/w) of organic or inorganic salt. In one embodiment, the mixture comprises between about 3% and 10% (w/w) of organic or inorganic salt.

In one embodiment, the mixture of organic or inorganic salt and cement or cement clinker (or cement clinker derived material, such as ground or partially ground cement clinker) comprises between about 10% and 99% (w/w) cement or cement clinker. In one embodiment, the mixture of organic or inorganic salt and cement or cement clinker comprises between about 20% and 99% (w/w) cement or cement clinker. In one embodiment, the mixture of organic or inorganic salt and cement or cement clinker comprises between about 30% and 99% (w/w) cement or cement clinker. In one embodiment, the mixture of organic or inorganic salt and cement or cement clinker comprises between about 40% and 99% (w/w) cement or cement clinker. In one embodiment, the mixture of organic or inorganic salt and cement or cement clinker comprises between about 50% and 99% (w/w) cement or cement clinker. In one embodiment, the mixture of organic or inorganic salt and cement or cement clinker comprises between about 60% and 99% (w/w) cement or cement clinker. In one embodiment, the mixture of organic or inorganic salt and cement or cement clinker comprises between about 70% and 99% (w/w) cement or cement clinker. In one embodiment, the mixture of organic or inorganic salt and cement or cement clinker comprises between about 80% and 99% (w/w) cement or cement clinker. In one embodiment, the mixture of organic or inorganic salt and cement or cement clinker comprises between about 88% and 99% (w/w) cement or cement clinker. In one embodiment, the mixture of organic or inorganic salt and cement or cement clinker comprises between about 85% and 95% (w/w) cement or cement clinker.

In one embodiment, the mixture of organic or inorganic salt and cement or cement clinker comprises between about 0.1% and 50% by weight of a slowly dissolving aluminum source. In one embodiment, the mixture comprises between about 0.1% and 45% by weight of a slowly dissolving source of aluminum; or between about 0.1% and 40% by weight; or between about 0.1% and 35%; or between about 0.1% and 30%; or between about 0.1% and 25%; or between about 0.1% and 20%; or between about 0.1% and 15%; or between about 0.1 and 10% by weight of a slowly dissolving source of aluminum. In one embodiment, the mixture comprises between about 0.5% and 10% by weight of a slowly dissolving source of aluminum. In one embodiment, the mixture comprises between about 2% and 10% by weight of a slowly dissolving source of aluminum.

In some embodiments, the step of mixing an amount of organic or inorganic salt with an amount of cement or cement clinker necessary to form a fresh concrete mixture having a pH of between about 12.0 and 13.65 further comprises step 132, wherein the mixture of the organic or inorganic salt and the cement clinker are inter-ground. The mixture of organic or inorganic salt and cement clinker can be inter-ground to form an inter-ground mixture using any method known to a person of skill in the art. In one embodiment, the mixture of cement clinker and organic or inorganic salt is inter-ground to a fine inter-ground cement powder mixture. In one embodiment, the mixture of cement clinker and organic or inorganic salt further comprises gypsum. In one embodiment, the mixture of cement clinker, gypsum, and organic or inorganic salt is inter-ground to a fine inter-ground cement powder.

In step 140, water and aggregates are added to the mixture of cement or cement clinker and organic or inorganic salt, forming a fresh concrete mixture having a pH of between about 12.0 and 13.65, or between about 12.0 and 13.50. In one embodiment, the mixture comprises cement clinker that has been inter-ground to a fine inter-ground cement powder mixture and the organic or inorganic salt. In one embodiment, water and aggregates are added to the mixture of fine inter-ground cement powder and organic or inorganic salt. The aggregates can be any cement aggregate known to a person of skill in the art. In one embodiment, the aggregate is a Class R0 (nonreactive) aggregate according to ASTM C1778. In one embodiment, the aggregate is a Class R1 (moderately reactive) aggregate according to ASTM C1778. In one embodiment, the aggregate is a Class R2 (highly reactive) aggregate according to ASTM C1778. In one embodiment, the aggregate is a Class R3 (very highly reactive) aggregate according to ASTM C1778. In one embodiment, the aggregate comprises a Class R2 aggregate, according to ASTM C1778 (ASTM C1778-20—Standard Guide for Reducing the Risk of for Deleterious Alkali-Aggregate Reaction in Concrete, ASTM International, 2020, West Conshohocken, Pa., USA). Exemplary aggregates include, but are not limited to, sand, gravel, crushed stone, slag, recycled concrete, geosynthetic aggregates, and combinations thereof. In one embodiment, the aggregate comprises sand. In one embodiment, the aggregate is proportioned according to industry's established methods including those that are published by the American Concrete Institute (e.g., ACI 211 documents). In one embodiment, the aggregate is an aggregate known to be used in concrete. In one embodiment, the concrete aggregate and water are added to the mixture of cement or cement clinker and organic or inorganic salt according to industry's established methods to produce a fresh concrete mixture. The aggregates can be any concrete aggregate known to a person of skill in the art including those that meet the requirements of ASTM C33 or equivalent specifications (ASTM C33/C33M-18—Standard Specification for Concrete Aggregates, ASTM International, 2018, West Conshohocken, Pa., USA.

In one embodiment, the amount of organic or inorganic salt in the fresh concrete mixture of step 140 reduces the alkalinity (OH⁻ ion concentration) of the mixture between about 10% and 95%. In one embodiment, the organic or inorganic salt reduces the alkalinity (OH⁻ ion concentration) of the mixture between about 10% and 85%. In one embodiment, the organic or inorganic salt reduces the alkalinity (OH⁻ ion concentration) of the mixture between about 10% and 75%. In one embodiment, the organic or inorganic salt reduces the alkalinity (OH⁻ ion concentration) of the mixture between about 10% and 65%. In one embodiment, the organic or inorganic salt reduces the alkalinity (OH− ion concentration) of the mixture between about 10% and 55%. In one embodiment, the organic or inorganic salt reduces the alkalinity (OH− ion concentration) of the mixture between about 20% and 55%. In one embodiment, the organic or inorganic salt reduces the alkalinity (OH− ion concentration) of the mixture between about 30% and 55%. In one embodiment, the organic or inorganic salt reduces the alkalinity (OH− ion concentration) of the mixture between about 40% and 55%. In one embodiment, the organic or inorganic salt reduces the alkalinity (OH− ion concentration) of the mixture between about 45% and 55%.

In one embodiment, the fresh concrete comprising an organic or inorganic salt has higher workability than a comparative concrete mixture without the organic or inorganic salt. In one embodiment, the increase in workability as a measure of flow is between about a 1% and a 50% increase. In one embodiment, the increase in workability as a measure of flow is between about a 1% and a 45% increase. In one embodiment, the increase in workability as a measure of flow is between about a 1% and a 40% increase. In one embodiment, the increase in workability as a measure of flow is between about a 1% and a 35% increase. In one embodiment, the increase in workability as a measure of flow is between about a 1% and a 30% increase. In one embodiment, the increase in workability as a measure of flow is between about a 1% and a 25% increase. In one embodiment, the increase in workability as a measure of flow is between about a 1% and a 20% increase.

In one embodiment, the fresh concrete mixture comprising an organic or inorganic salt has the same workability as a comparative concrete mixture without the organic or inorganic salt.

In one embodiment, the fresh concrete mixture comprising an organic or inorganic salt has minimally lower workability than a comparative cement mixture without the organic or inorganic salt. In one embodiment, the decrease in workability as a measure of flow is between about a 0.1% and a 50% decrease. In one embodiment, the decrease in workability as a measure of flow is between about a 0.1% and a 45% decrease. In one embodiment, the decrease in workability as a measure of flow is between about a 0.1% and a 40% decrease. In one embodiment, the decrease in workability as a measure of flow is between about a 0.1% and a 35% decrease. In one embodiment, the decrease in workability as a measure of flow is between about a 0.1% and a 30% decrease. In one embodiment, the decrease in workability as a measure of flow is between about a 0.1% and a 25% decrease. In one embodiment, the decrease in workability as a measure of flow is between about a 0.1% and a 20% decrease. In one embodiment, the decrease in workability as a measure of flow is between about a 0.1% and a 15% decrease.

In some embodiments, the step of adding water and aggregate to the mixture of cement or cement clinker and organic or inorganic salt, forming a fresh concrete mixture further comprises step 142, wherein one or more additives are added to the fresh concrete mixture. In one embodiment, the fresh concrete mixture comprises cement clinker that has been inter-ground to a fine inter-ground cement powder, organic or inorganic salt, water, and aggregates. In one embodiment, the one or more additives are added to the fresh concrete mixture comprising fine inter-ground cement powder, organic or inorganic salt, water, and aggregates. The additives can be any cement additive known to a person of skill in the art. In addition to ground clinker or cement powder, organic or inorganic salt, water, and aggregates, exemplary additives include, but are not limited to, mineral fillers, retarders, accelerators, plasticizers, water reducing agents, air entraining admixtures, corrosion inhibitors, specific performance admixtures, lithium admixtures, SCMs, fibers, and combinations thereof. Exemplary retarders, accelerators, plasticizers, water reducing agents, lithium admixtures, and SCMs are described elsewhere herein.

In step 150, the fresh concrete mixture is poured and cured to form a concrete product. In one embodiment, the fresh concrete mixture is transported to its final destination, poured, cast, consolidated, finished, and cured according to industry's established methods to form a final concrete product.

In one embodiment, the concrete product has ≤20% reduction in compressive strength, beyond seven days of age, compared to cement products not made via the inventive method. In one embodiment, any potential reduction in workability or strength compared to concrete products not made via the inventive method can be avoided by using industry methods known to control the workability or strength of cement products. In one embodiment, one or more cement and/or concrete additives can be used to control the workability or strength of the concrete product (see method steps 124 and 142). Exemplary cement and/or concrete additives are described elsewhere herein. In one embodiment, the additive used to control the workability or strength of the concrete product comprises a plasticizer. Exemplary plasticizers are described elsewhere herein. In one embodiment, the ratio of water to cement or cement clinker (see method step 140) can be adjusted to control the workability or strength of the concrete product.

In one embodiment, the concrete product formed from the fresh concrete mixture comprises mortar. In one embodiment, the concrete product formed from the fresh concrete mixture comprises precast, cast-in-place, or ready mixed concrete. In one embodiment, the concrete product formed from the fresh concrete mixture comprises stucco. In one embodiment, the concrete product formed from the fresh concrete mixture comprises fiber-cement composites.

### Method 2

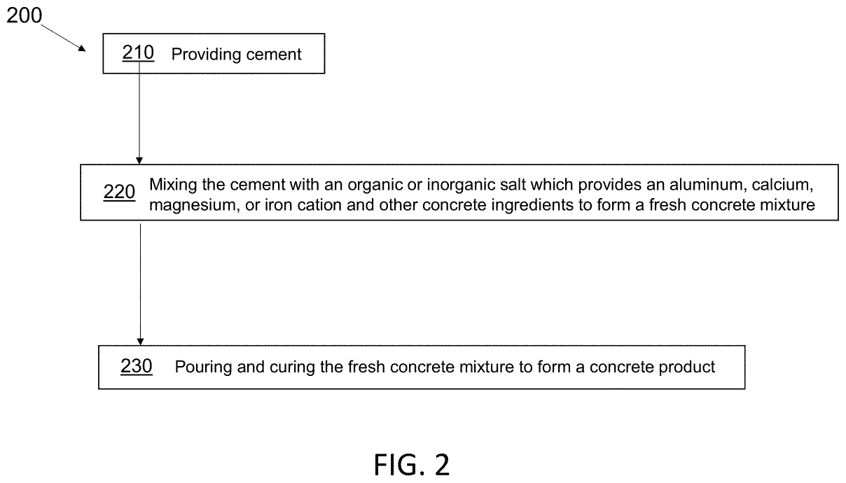

In one aspect, the invention relates to a method of mitigating ASR in a concrete product. Exemplary process 200 is shown in FIG. 2. In step 210, cement is provided. In step 220, the cement is mixed with an organic or inorganic salt, which provides an aluminum, calcium, magnesium, or iron cation, and other concrete ingredients to form a fresh concrete mixture. In step 230, the fresh concrete mixture is poured and cured to form a concrete product.

In step 210, the cement may be any type of cement known to a person of skill in the art. Exemplary types of cement are described elsewhere herein. In one embodiment, the cement comprises OPC. In one embodiment, the cement comprises PC.

In step 220, the organic or inorganic salts, and amounts thereof, are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the organic or inorganic salt is coated with a delayed release agent. In one embodiment, the organic or inorganic salt causes hydroxide or hydroxide complexes to precipitate, as fully described above in step 140 of method 1 of mitigating ASR in a concrete product.

In one embodiment, the organic or inorganic salt further comprises a slowly dissolving source of aluminum. In one embodiment, the slowly dissolving source of aluminum can be any slowly dissolving source of aluminum known to a person of skill in the art. Exemplary slowly dissolving sources of aluminum are described elsewhere herein. In one embodiment, the slowly dissolving source of aluminum is coated with a delayed release agent. In one embodiment, the slowly dissolving source of aluminum comprises aluminum hydroxide.

In one embodiment, the fresh concrete mixture comprises a w/w percentage of inorganic or organic salt, cement, and/or slowly dissolving source of aluminum as described in step 130 of method 1 of mitigating ASR in a concrete product.

In one embodiment, the organic or inorganic salt further comprises one or more additives. The additive can be any cement additive known to a person of skill in the art. Exemplary additives are described elsewhere herein.

The other concrete ingredients in step 220 can be any concrete ingredients known to a person of skill in the art. In one embodiment, the concrete ingredient comprises water. In one embodiment, the concrete ingredient comprises aggregates. The aggregates can be any concrete aggregate known to a person of skill in the art including those that meet the requirements of ASTM C33 or equivalent specifications (see above). Exemplary aggregates and proportioning of the aggregates are described in step 140 of method 1 of mitigating ASR in a concrete product.

Exemplary additives include, but are not limited to, cement, water, coarse aggregates, fine aggregates, mineral fillers, retarders, accelerators, plasticizers, water reducing agents, air entraining admixtures, corrosion inhibitors, specific performance admixtures, lithium admixtures, SCMs, fibers, and combinations thereof. Exemplary retarders, accelerators, plasticizers, water reducing agents, lithium admixtures, and SCMs are described elsewhere herein.

The other concrete ingredients are properly mixed with the cement and the organic or inorganic salt to form a fresh concrete mixture. In one embodiment, the other concrete ingredients comprise water and aggregates which are mixed with the cement and the organic or inorganic salt to form a fresh concrete mixture. In one embodiment, the other concrete ingredients comprise water, coarse aggregates, fine aggregates, mineral fillers, and one or more retarders, accelerators, plasticizers, water reducing agents, air entraining admixtures, lithium admixtures, corrosion inhibitors, specific performance admixtures, fibers, or SCMs which are mixed with the cement and the organic or inorganic salt to form a fresh concrete mixture.

In one embodiment, the amount of organic or inorganic salt in the fresh concrete mixture reduces the alkalinity (OH⁻ ion concentration) of the fresh concrete mixture of step 220 as described elsewhere herein for the fresh concrete mixture of step 140 of method 1 of mitigating ASR in a concrete product.

In one embodiment, the fresh concrete mixture comprising the organic or inorganic salt of step 220 has a workability as described for the fresh concrete mixture of step 130 of method 1 of mitigating ASR in a concrete product.

In step 230, the fresh concrete mixture is poured and cured to form a concrete product. In one embodiment, the fresh concrete mixture is transported to its final destination, poured, cast, consolidated, finished, and cured according to industry's established methods to form the final concrete product. The destination for the fresh concrete mixture can be any destination wherein a concrete product is needed. The strength of the final concrete product as well as techniques to control the workability and/or strength of the concrete product are described in step 150 of method 1 of mitigating ASR in a concrete product.

In one embodiment, the concrete product formed from the fresh concrete mixture comprises mortar. In one embodiment, the concrete product formed from the fresh concrete mixture comprises concrete, such as precast cast-in-place or ready mixed concrete. In one embodiment, the concrete product formed from the concrete mixture comprises stucco. In one embodiment, the concrete product formed from the concrete mixture comprises fiber-cement composites.

### Method 2a

In some embodiments, method 2 of mitigating ASR in a concrete product is further described by method 2a. In one embodiment of method 2a, the organic or inorganic salt of step 220 comprises a powder organic or inorganic salt. The organic or inorganic salt can be any ASR mitigation salt, and amounts thereof, described elsewhere herein, including those disclosed in step 220 of method 2 (above). In one embodiment of method 2a, the organic or inorganic salt of step 220 further comprises an SCM. The SCM can be any SCM described elsewhere herein. In one embodiment, the SCM is one or more forms of fly ash. In one embodiment, the organic or inorganic salt and the SCM are blended together. In one embodiment, the organic or inorganic salt and the SCM are inter-ground.

In one embodiment, all other steps, properties, etc. of method 2a are as described in method 2.

### Method 2b

In some embodiments, method 2 of mitigating ASR in a concrete product is further described by method 2b. In one embodiment of method 2b, the organic or inorganic salt of step 220 is coated onto one or more additives described elsewhere herein. In one embodiment, the organic or inorganic salt is coated onto an SCM. In one embodiment, the organic or inorganic salt is coated onto one or more forms of fly ash.

In one embodiment, the organic or inorganic salt coated additive is formed by dissolving the organic or inorganic salt in a solvent to form a liquid admixture and then coating the additive with the liquid admixture. In one embodiment, the solvent is an organic solvent. The organic solvent can be any organic solvent known to a person of skill in the art. Exemplary organic solvents include, but are not limited to, methanol, ethanol, isopropanol, diethyl ether, acetone, benzene, toluene, chloroform, dichloromethane, ethyl acetate, and combinations thereof. In one embodiment, the solvent is an aqueous solvent. The aqueous solvent can be any aqueous solvent known to a person of skill in the art. Exemplary aqueous solvents include, but are not limited to, water, saltwater, saline, distilled water, deionized water, and combinations thereof. In one embodiment, the organic or inorganic salt which provides an aluminum, calcium, magnesium, or iron cation is dissolved or dispersed in an aqueous solvent, forming a liquid admixture that is applied to one or more additives. In one embodiment, the liquid admixture coats one or more additives. In one embodiment, the liquid admixture is sprayed onto one or more additives.

In one embodiment, all other steps, properties, etc. of method 2b are as described in method 2.

### Method 2c

In some embodiments, method 2 of mitigating ASR in a concrete product is further described by method 2c. In one embodiment, the organic or inorganic salt of step 220 is a liquid admixture comprising the organic or inorganic salt dissolved in a solvent. Exemplary solvents are described elsewhere herein. In one embodiment, the solvent comprises an aqueous solvent. In one embodiment, the solvent is water. In one embodiment, the liquid admixture comprises a slowly dissolving source of aluminum described elsewhere herein, other additives described elsewhere herein, or combinations thereof. In one embodiment, the slowly dissolving source of aluminum and/or other additives are dissolved in the solvent of the liquid admixture. In one embodiment, the slowly dissolving source of aluminum and/or other additives do not dissolve in the solvent of the liquid admixture. In one embodiment, the slowly dissolving source of aluminum and/or other additives are dispersed in the liquid admixture.

In one embodiment of step 220, the liquid ASR mitigation admixture comprising an organic or inorganic salt is mixed with a powder form of the slowly dissolving source of aluminum and/or powder forms of other additives described elsewhere herein, cement, and other concrete ingredients to form a fresh concrete mixture.

In one embodiment, all other steps, properties, etc. of method 2c are as described in method 2.

### Method 3

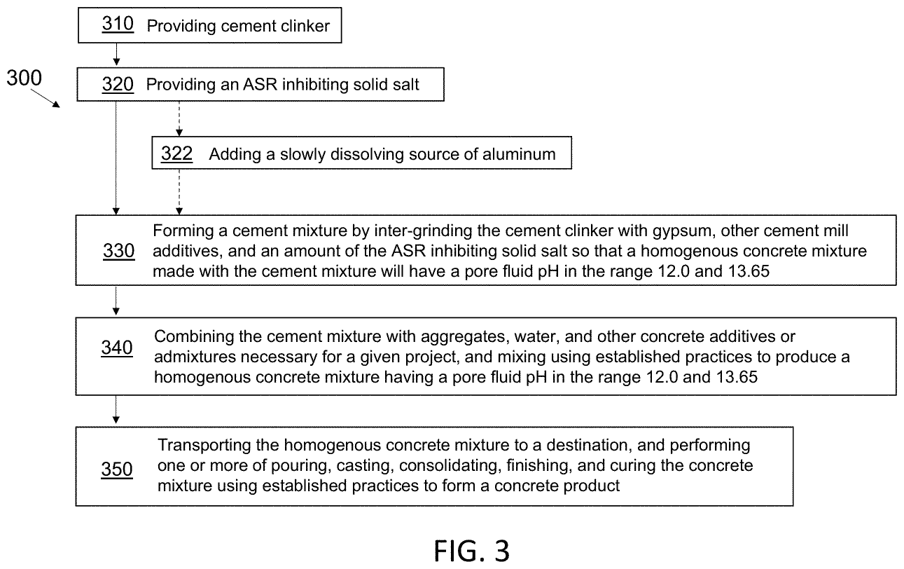

In one aspect, the invention relates to a method of mitigating ASR in a concrete product. Exemplary process 300 is shown in FIG. 3. In step 310, cement clinker (or cement clinker derived material, such as ground or partially ground cement clinker) is provided. In step 320, an ASR inhibiting solid salt is provided. In step 330, a cement mixture is formed by inter-grinding the cement clinker, optionally with gypsum and/or other cement mill additives, and with an amount of the ASR inhibiting salt so that a homogeneous concrete mixture made with the cement mixture will have a pore fluid pH in the range 12.0 and 13.65. In step 340, the cement mixture is combined with aggregates, water, and other concrete additives or admixtures necessary for a given project and mixed using established practices to produce a homogeneous concrete mixture having a pore fluid pH in the range 12.0 and 13.65. In step 350, the homogeneous concrete mixture is transported to a destination, poured, cast, consolidated, finished, and cured using established practices to form a concrete product.

In step 310, the cement clinker may be any type of cement clinker known to a person of skill in the art. Exemplary types of cement clinker are described elsewhere herein. In one embodiment, the cement clinker comprises OPC clinker. In one embodiment, the cement comprises PC clinker. Cement clinker should be ground to a fine powder prior to step 340, in which water and aggregate are added to the cement mixture to form a fresh concrete mixture. Optionally, gypsum and/or other cement mill additives may be added to the cement clinker, either before or after grinding.

In step 320, the ASR inhibiting solid salt can comprise any components described elsewhere herein, and in the quantities described elsewhere herein (see, for example, step 130 of Method 1). In one embodiment, the ASR inhibiting solid salt comprises one or more organic or inorganic salts which provide an aluminum, calcium, magnesium, or iron cation. Exemplary organic or inorganic salts are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the organic or inorganic salt is coated with a delayed release agent. In one embodiment, the ASR inhibiting solid salt further comprises any additives described elsewhere herein. In one embodiment, the ASR inhibiting solid salt further comprises one or more cement and/or concrete additives described elsewhere herein.

In some embodiments, the step of providing an ASR inhibiting solid salt further comprises step 322 wherein a slowly dissolving source of aluminum is added to the ASR inhibiting solid salt. In one embodiment, the slowly dissolving source of aluminum can be any slowly dissolving source of aluminum known to a person of skill in the art. Exemplary slowly dissolving source of aluminum are described elsewhere herein. In one embodiment, the slowly dissolving source of aluminum is coated with a delayed release agent. In one embodiment, the slowly dissolving source of aluminum comprises aluminum hydroxide.

In step 330, the cement mill additives may be any cement additive described elsewhere herein. In one embodiment, the cement clinker can be inter-ground with gypsum, other cement mill additives, and an amount of the ASR inhibiting salt using any grinding method known to a person of skill in the art to form a cement mixture. In one embodiment, the cement mixture comprises the w/w percentage of cement, organic or inorganic salt, and/or slowly dissolving source of aluminum described in step 130 of method 1 of mitigating ASR in a concrete product.

In one embodiment, the organic or inorganic salt has a water solubility limit that is greater than the water solubility limit of the base analog (e.g., hydroxide) formed by the salt's cation and causes hydroxide or hydroxide complexes to precipitate, thus removing OH⁻ ions and reducing the pH of the homogeneous concrete mixture to between about 12.0 and 13.65. In one embodiment, the organic or inorganic salt reduces the pH of the homogeneous concrete mixture to between about 12.0 and 13.50. In one embodiment, the hydroxides can be further consumed in formation of other hydrated phases in concrete. Exemplary hydrated phases include, but are not limited to alumino-ferrite triphase (AFt) compounds (such as ettringite), alumino-ferrite monophase (AFm) compounds (such as mono-sulfo-aluminates and carbo-aluminates), calcium hydroxide, calcium aluminum hydrate, calcium silicate hydrate, and calcium alumino-silicate hydrate.

In one embodiment, the amount of organic or inorganic salt in the homogeneous concrete mixture of step 340 reduces the alkalinity (OH⁻ ion concentration) of the mixture as described in the fresh concrete mixture of step 140 in method 1 of mitigating ASR in a concrete product. In one embodiment, the homogeneous concrete mixture of step 340 comprising the organic or inorganic salt has a workability as described for the fresh concrete mixture of step 130 of method 1 of mitigating ASR in a concrete product.

In one embodiment, the aggregates used in step 340 can be any aggregates known to a person of skill in the art. Exemplary aggregates are described elsewhere herein. In one embodiment, the concrete additives or admixtures can be any concrete additives known to a person of skill in the art. Exemplary concrete additives are described elsewhere herein.

In step 350, the homogeneous concrete mixture is transported to a destination, poured, cast, consolidated, finished, and cured using established practices to form a concrete product. The destination for the homogeneous mixture can be any destination wherein a concrete product is needed. The strength of the final concrete product as well as techniques to control the workability and/or strength of the concrete product are described in step 150 of method 1 of mitigating ASR in a concrete product.

In one embodiment concrete mixture comprises concrete, such as precast cast-in-place or ready mixed concrete. In one embodiment, the concrete product formed from the homogeneous concrete mixture comprises stucco. In one embodiment, the concrete product formed from the homogeneous concrete mixture comprises fiber-cement composites.

### Method 4

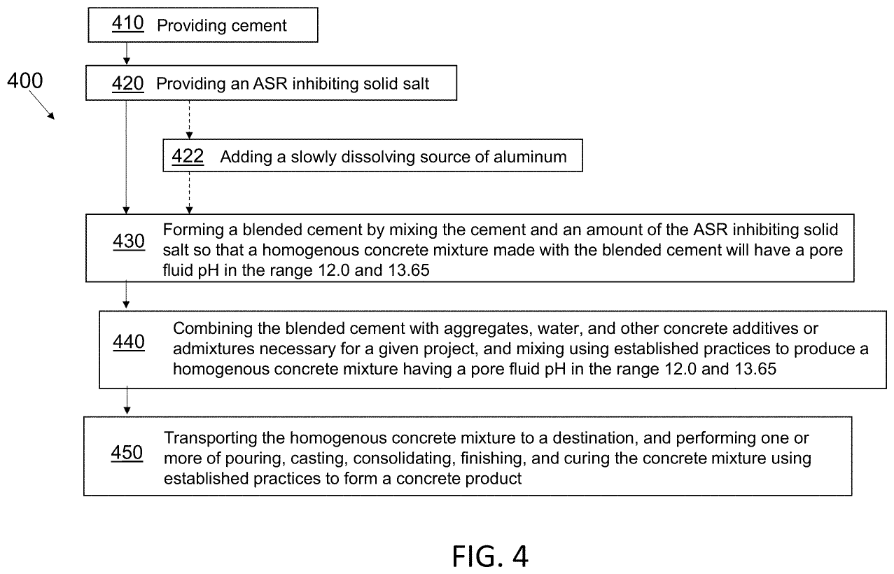

In one aspect, the invention relates to a method of mitigating ASR in a concrete product. Exemplary process 400 is shown in FIG. 4. In step 410, cement is provided. In step 420, an ASR inhibiting solid salt is provided. In step 430, blended cement is formed by mixing the cement and an amount of the ASR inhibiting solid salt so that a homogeneous concrete mixture made (in step 440) with the blended cement will have a pore fluid pH in the range 12.0 and 13.65. In step 440, the blended cement is combined with aggregates, water, and other concrete additives or admixtures necessary for a given project and mixed using established practices to produce a homogeneous concrete mixture having a pore fluid pH in the range 12.0 and 13.65. In step 450, the homogeneous concrete mixture is transported to a destination, poured, cast, consolidated, finished, and cured using established practices to form a concrete product.

In step 410, the cement may be any type of cement known to a person of skill in the art. Exemplary types of cement are described elsewhere herein. In one embodiment, the cement comprises OPC. In one embodiment, the cement comprises PC.

In step 420, the ASR inhibiting solid salt can comprise any components, and amounts thereof, described elsewhere herein. In one embodiment, the ASR inhibiting solid salt comprises one or more organic or inorganic salts which provide an aluminum, calcium, magnesium, or iron cation. Exemplary organic or inorganic salts are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the organic or inorganic salt is coated with a delayed release agent. In one embodiment, the ASR inhibiting solid salt further comprises any additives described elsewhere herein. In one embodiment, the ASR inhibiting solid salt further comprises one or more cement and/or concrete additives described elsewhere herein.

In some embodiments, the step of providing an ASR inhibiting solid salt further comprises step 422 wherein a slowly dissolving source of aluminum is added to the ASR inhibiting solid salt. In one embodiment, the slowly dissolving source of aluminum can be any slowly dissolving source of aluminum known to a person of skill in the art. Exemplary slowly dissolving sources of aluminum are described elsewhere herein. In one embodiment, the slowly dissolving source of aluminum is coated with a delayed release agent. In one embodiment, the slowly dissolving source of aluminum comprises aluminum hydroxide.

In step 430, the cement and ASR inhibiting solid salt can be blended using any method known to a person of skill in the art. In one embodiment, the cement and ASR inhibiting solid salt are mixed together to form blended cement. The ASR inhibiting solid salt and the cement can be mixed using any process or method known to a person of skill in the art. In one embodiment, the cement and ASR inhibiting solid salt are ground together to form blended cement. In one embodiment, the blended cement comprises the w/w percentage of cement, organic or inorganic salt, and/or slowly dissolving aluminum source described in step 130 of method 1 of mitigating ASR in a concrete product.

In one embodiment, the organic or inorganic salt has a water solubility limit that is greater than the water solubility limit of the base analog (e.g., hydroxide) formed by the salt's cation and causes hydroxide or hydroxide complexes to precipitate, thus removing OH⁻ ions and reducing the pH of the homogeneous concrete mixture to between about 12.0 and 13.65. In one embodiment, the organic or inorganic salt reduces the pH of the homogeneous concrete mixture to between about 12.0 and 13.50. In one embodiment, the hydroxides can be further consumed in formation of other hydrated phases in concrete. Exemplary hydrated phases include, but are not limited to alumino-ferrite triphase (AFt) compounds (such as ettringite), alumino-ferrite monophase (AFm) compounds (such as mono-sulfo-aluminates and carbo-aluminates), calcium hydroxide, calcium aluminum hydrate, calcium silicate hydrate, and calcium alumino-silicate hydrate.

In one embodiment, the amount of organic or inorganic salt in the homogeneous concrete mixture of step 440 reduces the alkalinity (OH⁻ ion concentration) of the mixture as described in the fresh concrete mixture of step 140 in method 1 of mitigating ASR in a concrete product. In one embodiment, the homogeneous concrete mixture of step 440 comprising the organic or inorganic salt has a workability as described for the fresh concrete mixture of step 130 of method 1 of mitigating ASR in a concrete product.

In one embodiment, the aggregates used in step 440 can be any aggregates known to a person of skill in the art. Exemplary aggregates are described elsewhere herein. In one embodiment, the concrete additives or admixtures can be any concrete additives known to a person of skill in the art. Exemplary concrete additives are described elsewhere herein.

In step 450, the homogeneous concrete mixture is transported to a destination, poured, cast, consolidated, finished, and cured using established practices to form a concrete product. The destination for the homogeneous mixture can be any destination wherein a concrete product is needed. The strength of the final concrete product as well as techniques to control the workability and/or strength of the concrete product are described in step 150 of method 1 of mitigating ASR in a concrete product.

In one embodiment, the concrete product formed from the homogeneous concrete mixture comprises mortar. In one embodiment, the concrete product formed from the homogeneous concrete mixture comprises concrete, such as precast cast-in-place or ready mixed concrete. In one embodiment, the concrete product formed from the homogeneous concrete mixture comprises stucco. In one embodiment, the concrete product formed from the homogeneous concrete mixture comprises fiber-cement composites.

### Method 5

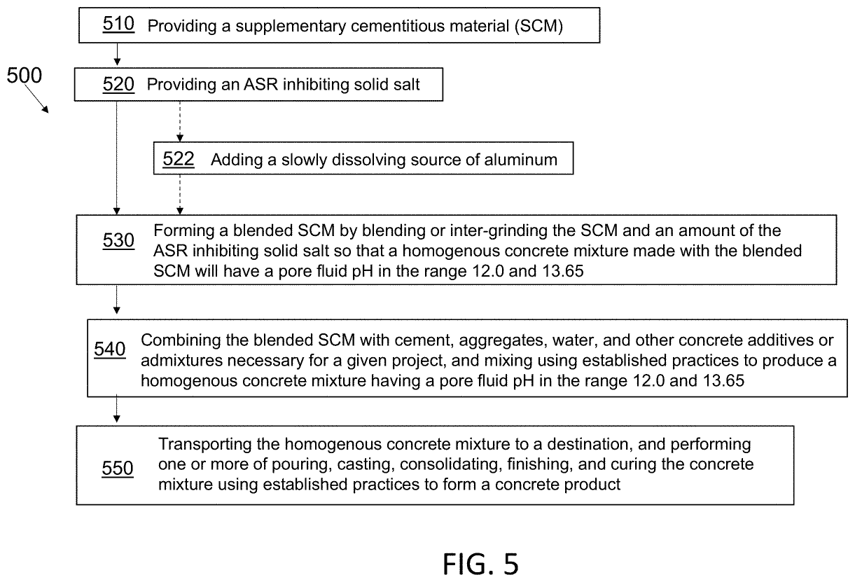

In one aspect, the invention relates to a method of mitigating ASR in a concrete product. Exemplary process 500 is shown in FIG. 5. In step 510, a supplementary cementitious material (SCM) is provided. In step 520, an ASR inhibiting solid salt is provided. In step 530, a blended SCM is formed by blending or inter-grinding the SCM and an amount of the ASR inhibiting solid salt so that a homogeneous concrete mixture (in step 540) made with the blended SCM will have a pore fluid pH in the range 12.0 and 13.65. In step 540, the blended SCM is combined with cement, aggregates, water, and other concrete additives or admixtures necessary for a given project and mixed using established practices to produce a homogeneous concrete mixture. In step 550, the homogeneous concrete mixture is transported to a destination, poured, cast, consolidated, finished, and cured using established practices to form a concrete product.

In step 510, the SCM can be any SCM known to a person of skill in the art. Exemplary SCMs are described elsewhere herein. In one embodiment, the SCM is fly ash.

In step 520, the ASR inhibiting solid salt can comprise any components, and amounts thereof, described elsewhere herein. In one embodiment, the ASR inhibiting solid salt comprises one or more organic or inorganic salts which provide an aluminum, calcium, magnesium, or iron cation. Exemplary organic or inorganic salts are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the organic or inorganic salt is coated with a delayed release agent. In one embodiment, the ASR inhibiting solid salt further comprises any additives described elsewhere herein. In one embodiment, the ASR inhibiting solid salt further comprises one or more cement and/or concrete additives described elsewhere herein.

In some embodiments, the step of providing an ASR inhibiting solid salt further comprises step 522 wherein a slowly dissolving source of aluminum is added to the ASR inhibiting solid salt. In one embodiment, the slowly dissolving source of aluminum can be any slowly dissolving source of aluminum known to a person of skill in the art. Exemplary slowly dissolving sources of aluminum are described elsewhere herein. In one embodiment, the slowly dissolving source of aluminum is coated with a delayed release agent. In one embodiment, the slowly dissolving source of aluminum comprises aluminum hydroxide.

In step 530, the SCM and ASR inhibiting solid salt can be blended or inter-ground using any method known to a person of skill in the art to form a blended SCM.

In step 540, the blended SCM can be mixed with any type of cement known to a person of skill in the art. Exemplary types of cement are described elsewhere herein. In one embodiment, the cement comprises OPC. In one embodiment, the cement comprises PC.

In one embodiment, the organic or inorganic salt has a water solubility limit that is greater than the water solubility limit of the base analog (e.g., hydroxide) formed by the salt's cation and causes hydroxide or hydroxide complexes to precipitate, thus removing OH⁻ ions and reducing the pH of the homogeneous concrete mixture to between about 12.0 and 13.65. In one embodiment, the organic or inorganic salt reduces the pH of the homogeneous concrete mixture to between about 12.0 and 13.50. In one embodiment, the hydroxides can be further consumed in formation of other hydrated phases in concrete. Exemplary hydrated phases include, but are not limited to alumino-ferrite triphase (AFt) compounds (such as ettringite), alumino-ferrite monophase (AFm) compounds (such as mono-sulfo-aluminates and carbo-aluminates), calcium hydroxide, calcium aluminum hydrate, calcium silicate hydrate, and calcium alumino-silicate hydrate.

In one embodiment, the amount of organic or inorganic salt in the homogeneous concrete mixture of step 540 reduces the alkalinity (OH⁻ ion concentration) of the mixture as described in the fresh concrete mixture of step 140 in method 1 of mitigating ASR in a concrete product. In one embodiment, the homogeneous concrete mixture of step 540 comprising the organic or inorganic salt has a workability as described for the fresh concrete mixture of step 130 of method 1 of mitigating ASR in a concrete product.

In one embodiment, the aggregates used in step 540 can be any aggregates known to a person of skill in the art. Exemplary aggregates are described elsewhere herein. In one embodiment, the concrete additives or admixtures can be any concrete additives known to a person of skill in the art. Exemplary concrete additives are described elsewhere herein.

In step 550, the homogeneous concrete mixture is transported to a destination, poured, cast, consolidated, finished, and cured using established practices to form a concrete product. The destination for the homogeneous mixture can be any destination wherein a concrete product is needed. The strength of the final concrete product as well as techniques to control the workability and/or strength of the concrete product are described in step 150 of method 1 of mitigating ASR in a concrete product.

In one embodiment, the concrete product formed from the homogeneous concrete mixture comprises mortar. In one embodiment, the concrete product formed from the homogeneous concrete mixture comprises concrete, such as precast cast-in-place or ready mixed concrete. In one embodiment, the concrete product formed from the homogeneous concrete mixture comprises stucco. In one embodiment, the concrete product formed from the homogeneous concrete mixture comprises fiber-cement composites.

### Method 6

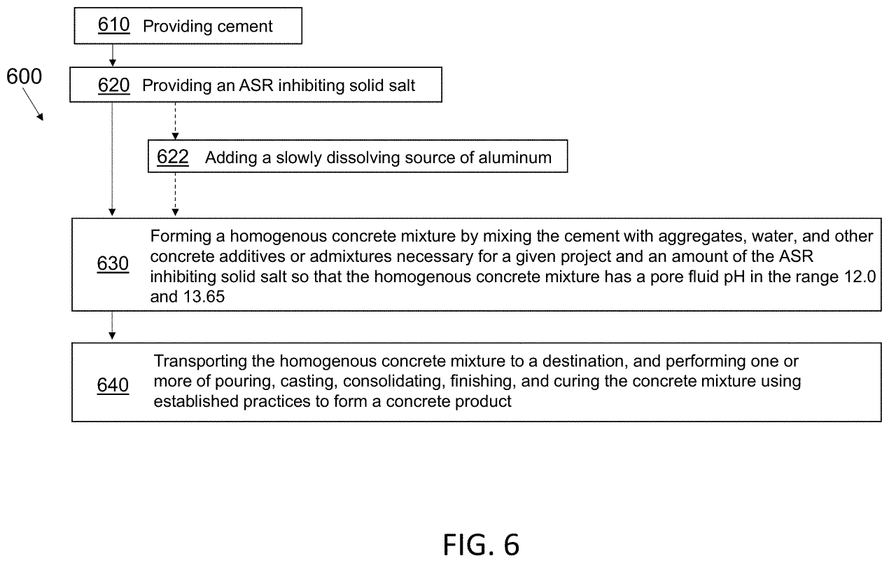

In one aspect, the invention relates to a method of mitigating ASR in a concrete product. Exemplary process 600 is shown in FIG. 6. In step 610, cement is provided.

In step 620, an ASR inhibiting solid salt is provided. In step 630, a homogeneous concrete mixture is formed by mixing the cement, aggregates, water, other concrete additives or admixtures necessary for a given project, and an amount of the ASR inhibiting salt so that the homogeneous concrete mixture has a pore fluid pH in the range 12.0 and 13.65. In step 640, the homogeneous concrete mixture is transported to a destination, poured, cast, consolidated, finished, and cured using established practices to form a concrete product.

In step 610, the cement may be any type of cement known to a person of skill in the art. Exemplary types of cement are described elsewhere herein. In one embodiment, the cement comprises OPC. In one embodiment, the cement comprises PC.

In step 620, the ASR inhibiting solid salt can comprise any components, and amounts thereof, described elsewhere herein. In one embodiment, the ASR inhibiting solid salt comprises one or more organic or inorganic salts which provide an aluminum, calcium, magnesium, or iron cation. Exemplary organic or inorganic salts are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the organic or inorganic salt is coated with a delayed release agent. In one embodiment, the ASR inhibiting solid salt further comprises any additives described elsewhere herein. In one embodiment, the ASR inhibiting solid salt further comprises one or more cement and/or concrete additives described elsewhere herein.

In one embodiment, the organic or inorganic salt has a water solubility limit that is greater than the water solubility limit of the base analog (e.g., hydroxide) formed by the salt's cation and causes hydroxide or hydroxide complexes to precipitate, thus removing OH⁻ ions and reducing the pH of the homogeneous concrete mixture to between about 12.0 and 13.65. In one embodiment, the organic or inorganic salt reduces the pH of the homogeneous concrete mixture to between about 12.0 and 13.50. In one embodiment, the hydroxides can be further consumed in formation of other hydrated phases in concrete. Exemplary hydrated phases include, but are not limited to alumino-ferrite triphase (AFt) compounds (such as ettringite), alumino-ferrite monophase (AFm) compounds (such as mono-sulfo-aluminates and carbo-aluminates), calcium hydroxide, calcium aluminum hydrate, calcium silicate hydrate, and calcium alumino-silicate hydrate.

In some embodiments, the step of providing an ASR inhibiting solid salt further comprises step 622 wherein a slowly dissolving source of aluminum is added to the ASR inhibiting solid salt. In one embodiment, the slowly dissolving source of aluminum can be any slowly dissolving source of aluminum known to a person of skill in the art. Exemplary slowly dissolving sources of aluminum are described elsewhere herein. In one embodiment, the slowly dissolving source of aluminum is coated with a delayed release agent. In one embodiment, the slowly dissolving source of aluminum comprises aluminum hydroxide.

In one embodiment, the amount of organic or inorganic salt in the homogeneous concrete mixture of step 630 reduces the alkalinity (OH⁻ ion concentration) of the mixture as described in the fresh concrete mixture of step 140 in method 1 of mitigating ASR in a concrete product. In one embodiment, the homogeneous concrete mixture of step 630 comprising the organic or inorganic salt has a workability as described for the fresh concrete mixture of step 130 of method 1 of mitigating ASR in a concrete product.

In one embodiment, the cement used in step 630 can be any cement known to a person of skill in the art. Exemplary types of cement are described elsewhere herein. In one embodiment, the cement is OPC. In one embodiment, the cement is PC. In one embodiment, the aggregates used in step 630 can be any aggregates known to a person of skill in the art. Exemplary aggregates are described elsewhere herein. In one embodiment, the concrete additives or admixtures can be any concrete additives known to a person of skill in the art. Exemplary concrete additives are described elsewhere herein.

In step 640, the homogeneous concrete mixture is transported to a destination, poured, cast, consolidated, finished, and cured using established practices to form a concrete product. The destination for the homogeneous mixture can be any destination wherein a concrete product is needed. The strength of the final concrete product as well as techniques to control the workability and/or strength of the concrete product are described in step 150 of method 1 of mitigating ASR in a concrete product.

In one embodiment, the concrete product formed from the homogeneous concrete mixture comprises mortar. In one embodiment, the concrete product formed from the homogeneous concrete mixture comprises concrete, such as precast cast-in-place or ready mixed concrete. In one embodiment, the concrete product formed from the homogeneous concrete mixture comprises stucco. In one embodiment, the concrete product formed from the homogeneous concrete mixture comprises fiber-cement composites.

### Method 7

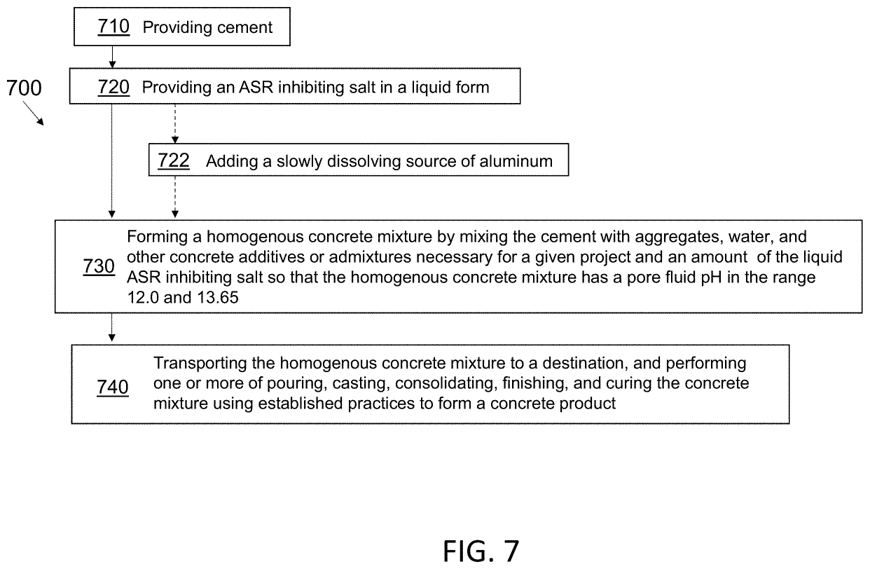

In one aspect, the invention relates to a method of mitigating ASR in a concrete product. Exemplary process 700 is shown in FIG. 7. In step 710, cement is provided. In step 720, an ASR inhibiting salt is provided in a liquid form. In step 730, a homogeneous concrete mixture is formed by mixing the cement, aggregates, water, other concrete additives or admixtures necessary for a given project, and an amount of the ASR inhibiting salt in liquid form using established practices so that the homogeneous concrete mixture has a pore fluid pH in the range 12.0 and 13.65, or between 12.0 and 13.50. In step 740, the homogeneous concrete mixture is transported to a destination, poured, cast, consolidated, finished, and cured using established practices to form a concrete product.

In step 710, the cement may be any type of cement known to a person of skill in the art. Exemplary types of cement are described elsewhere herein. In one embodiment, the cement comprises OPC. In one embodiment, the cement comprises PC.

In step 720, the ASR inhibiting salt provided in liquid form comprises an ASR inhibiting salt which is dissolved or dispersed in a solvent. Exemplary solvents are described elsewhere herein. In one embodiment, the ASR inhibiting salt is dissolved or dispersed in water. In one embodiment, the ASR inhibiting salt comprises one or more organic or inorganic salts which provide an aluminum, calcium, magnesium, or iron cation. Exemplary organic or inorganic salts, and amounts thereof, are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the ASR inhibiting salt provided in liquid form further comprises any additives described elsewhere herein. In one embodiment, the ASR inhibiting salt provided in liquid form further comprises one or more cement and/or concrete additives described elsewhere herein. In one embodiment, the additives are dissolved in the solvent. In one embodiment, the additives are dispersed in the solvent.

In some embodiments, the step of providing an ASR inhibiting salt in liquid form further comprises step 722 wherein a slowly dissolving source of aluminum is added to the ASR inhibiting salt. In one embodiment, the slowly dissolving source of aluminum can be any slowly dissolving source of aluminum known to a person of skill in the art. Exemplary slowly dissolving sources of aluminum are described elsewhere herein. In one embodiment, the slowly dissolving source of aluminum is coated with a delayed release agent. In one embodiment, the slowly dissolving source of aluminum comprises aluminum hydroxide. In one embodiment, the slowly dissolving source of aluminum is dissolved in the solvent used to dissolve/disperse the ASR inhibiting salt. In one embodiment, the slowly dissolving source of aluminum is dispersed in the solvent used to dissolve/disperse the ASR inhibiting salt.

In one embodiment, the organic or inorganic salt has a water solubility limit that is greater than the water solubility limit of the base analog (e.g., hydroxide) formed by the salt's cation and causes hydroxide or hydroxide complexes to precipitate, thus removing OH⁻ ions and reducing the pH of the homogeneous concrete mixture to between about 12.0 and 13.65. In one embodiment, the organic or inorganic salt reduces the pH of the homogeneous concrete mixture to between about 12.0 and 13.50. In one embodiment, the hydroxides can be further consumed in formation of other hydrated phases in concrete. Exemplary hydrated phases include, but are not limited to alumino-ferrite triphase (AFt) compounds (such as ettringite), alumino-ferrite monophase (AFm) compounds (such as mono-sulfo-aluminates and carbo-aluminates), calcium hydroxide, calcium aluminum hydrate, calcium silicate hydrate, and calcium alumino-silicate hydrate.

In one embodiment, the amount of organic or inorganic salt in the homogeneous concrete mixture of step 730 reduces the alkalinity (OH⁻ ion concentration) of the mixture as described in the fresh concrete mixture of step 140 in method 1 of mitigating ASR in a concrete product. In one embodiment, the homogeneous concrete mixture of step 730 comprising the organic or inorganic salt has a workability as described for the fresh concrete mixture of step 130 of method 1 of mitigating ASR in a concrete product.

In one embodiment, the cement used in step 730 can be any cement known to a person of skill in the art. Exemplary types of cement are described elsewhere herein. In one embodiment, the cement is OPC. In one embodiment, the cement is PC. In one embodiment, the aggregates used in step 730 can be any aggregates known to a person of skill in the art. Exemplary aggregates are described elsewhere herein. In one embodiment, the concrete additives or admixtures can be any concrete additives known to a person of skill in the art. Exemplary concrete additives are described elsewhere herein.

In step 740, the homogeneous concrete mixture is transported to a destination, poured, cast, consolidated, finished, and cured using established practices to form a concrete product. The destination for the homogeneous mixture can be any destination wherein a concrete product is needed. The strength of the final concrete product as well as techniques to control the workability and/or strength of the concrete product are described in step 150 of method 1 of mitigating ASR in a concrete product.

In one embodiment, the concrete product formed from the homogeneous concrete mixture comprises mortar. In one embodiment, the concrete product formed from the homogeneous concrete mixture comprises concrete, such as precast cast-in-place or ready mixed concrete. In one embodiment, the concrete product formed from the homogeneous concrete mixture comprises stucco. In one embodiment, the concrete product formed from the homogeneous concrete mixture comprises fiber-cement composites.

### Method 8

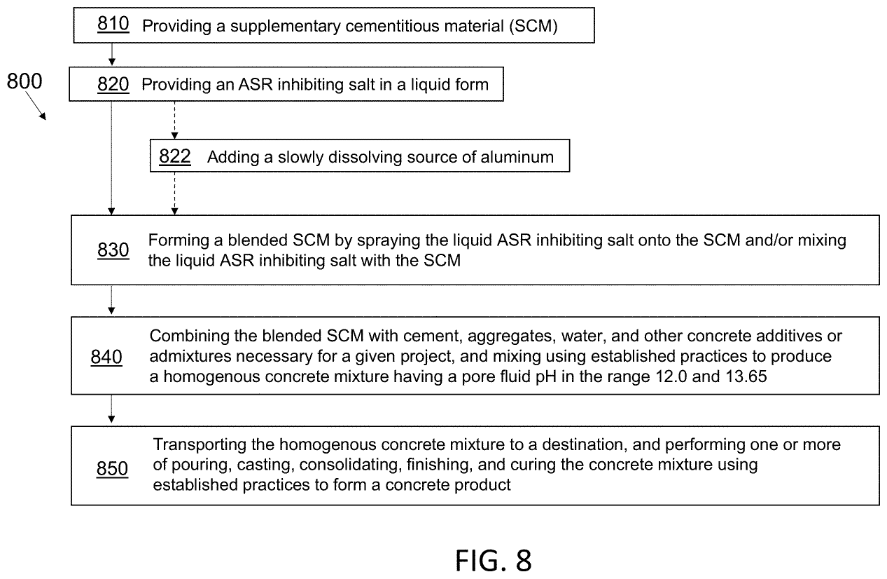

In one aspect, the invention relates to a method of mitigating ASR in a concrete product. Exemplary process 800 is shown in FIG. 8. In step 810, a supplementary cementitious material (SCM) is provided. In step 820, an ASR inhibiting salt is provided in liquid form. In step 830, a blended or treated SCM is formed by mixing the liquid form of the ASR inhibiting salt with the SCM or by spraying the liquid form of the ASR inhibiting salt onto the SCM so that a homogeneous concrete mixture made with the blended or treated SCM will have a pore fluid pH in the range 12.0 and 13.65, or between 12.0 and 13.50. In step 840, the blended or treated SCM is combined with cement, aggregates, water, and other concrete additives or admixtures necessary for a given project and mixed using established practices to produce a homogeneous concrete mixture. In step 850, the homogeneous concrete mixture is transported to a destination, poured, cast, consolidated, finished, and cured using established practices to form a concrete product.

In step 810, the SCM may be any SCM known to a person of skill in the art. Exemplary SCMs are described elsewhere herein. In one embodiment, the SCM is fly ash.

In step 820, the ASR inhibiting salt provided in liquid form comprises an ASR inhibiting salt which is dissolved or dispersed in a solvent. Exemplary solvents are described elsewhere herein. In one embodiment, the ASR inhibiting salt is dissolved or dispersed in water. In one embodiment, the ASR inhibiting salt comprises one or more organic or inorganic salts which provide an aluminum, calcium, magnesium, or iron cation. Exemplary organic or inorganic salts, and amounts thereof, are described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the ASR inhibiting salt provided in liquid form further comprises any additives described elsewhere herein. In one embodiment, the ASR inhibiting salt provided in liquid form further comprises one or more cement and/or concrete additives described elsewhere herein. In one embodiment, the additives are dissolved in the solvent. In one embodiment, the additives are dispersed in the solvent.

In some embodiments, the step of providing an ASR inhibiting salt in liquid form further comprises step 822 wherein a slowly dissolving source of aluminum is added to the ASR inhibiting salt. In one embodiment, the slowly dissolving source of aluminum can be any slowly dissolving source of aluminum known to a person of skill in the art. Exemplary slowly dissolving sources of aluminum are described elsewhere herein. In one embodiment, the slowly dissolving source of aluminum is coated with a delayed release agent. In one embodiment, the slowly dissolving source of aluminum comprises aluminum hydroxide. In one embodiment, the slowly dissolving source of aluminum is dissolved in the solvent used to dissolve/disperse the ASR inhibiting salt. In one embodiment, the slowly dissolving source of aluminum is dispersed in the solvent used to dissolve/disperse the ASR inhibiting salt.

In one embodiment, the organic or inorganic salt has a water solubility limit that is greater than the water solubility limit of the base analog (e.g., hydroxide) formed by the salt's cation and causes hydroxide or hydroxide complexes to precipitate, thus removing OH⁻ ions and reducing the pH of the homogeneous concrete mixture to between about 12.0 and 13.65. In one embodiment, the organic or inorganic salt reduces the pH of the homogeneous concrete mixture to between about 12.0 and 13.50. In one embodiment, the hydroxides can be further consumed in formation of other hydrated phases in concrete. Exemplary hydrated phases include, but are not limited to alumino-ferrite triphase (AFt) compounds (such as ettringite), alumino-ferrite monophase (AFm) compounds (such as mono-sulfo-aluminates and carbo-aluminates), calcium hydroxide, calcium aluminum hydrate, calcium silicate hydrate, and calcium alumino-silicate hydrate.

The liquid form of the ASR inhibiting salt can be mixed with or sprayed onto the SCM in step 830 using any technique known to a person of skill in the art. In one embodiment, the liquid ASR inhibiting salt is sprayed onto the SCM. In one embodiment, the liquid ASR inhibiting salt coats all of the SCM. In one embodiment, the liquid ASR inhibiting salt coats a portion of the SCM. In one embodiment, the solvent that the ASR inhibiting salt is dissolved/dispersed in evaporates after the liquid ASR inhibiting salt coats the SCM. In one embodiment, the solvent evaporates leaving an SCM that is fully or partially coated with the ASR inhibiting salt.

In one embodiment, the cement used in step 840 can be any cement known to a person of skill in the art. Exemplary types of cement are described elsewhere herein. In one embodiment, the cement is OPC. In one embodiment, the cement is PC. In one embodiment, the aggregates used in step 840 can be any aggregates known to a person of skill in the art. Exemplary aggregates are described elsewhere herein. In one embodiment, the concrete additives or admixtures can be any concrete additives known to a person of skill in the art. Exemplary concrete additives are described elsewhere herein.

In one embodiment, the amount of organic or inorganic salt in the homogeneous concrete mixture of step 840 reduces the alkalinity (OH⁻ ion concentration) of the mixture as described in the fresh concrete mixture of step 140 in method 1 of mitigating ASR in a concrete product. In one embodiment, the homogeneous concrete mixture of step 840 comprising the organic or inorganic salt has a workability as described for the fresh concrete mixture of step 130 of method 1 of mitigating ASR in a concrete product.

In step 850, the homogeneous concrete mixture is transported to a destination, poured, cast, consolidated, finished, and cured using established practices to form a concrete product. The destination for the homogeneous mixture can be any destination wherein a concrete product is needed. The strength of the final concrete product as well as techniques to control the workability and/or strength of the concrete product are described in step 150 of method 1 of mitigating ASR in a concrete product.

In one embodiment, the concrete product formed from the homogeneous concrete mixture comprises mortar. In one embodiment, the concrete product formed from the homogeneous concrete mixture comprises concrete, such as precast cast-in-place or ready mixed concrete. In one embodiment, the concrete product formed from the homogeneous concrete mixture comprises stucco. In one embodiment, the concrete product formed from the homogeneous concrete mixture comprises fiber-cement composites.

### Kits of the Invention

The present invention also relates to kits for ASR mitigation. In one embodiment, the kit includes an ASR mitigation admixture comprising one or more organic or inorganic salts which provide an aluminum, calcium, magnesium, or iron cation. The organic or inorganic salt may be one of the exemplary salts described elsewhere herein. In an embodiment, the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof. In an embodiment, the organic or inorganic salt is selected from the group consisting of: magnesium acetate, magnesium bromide, magnesium nitrate, calcium acetate, calcium bromide, calcium formate, calcium nitrate, calcium nitrite, and combinations thereof. In one embodiment, the organic or inorganic salt particles are coated with an agent that delays the dissolution or dispersion of the salt. Exemplary delayed release agents are described elsewhere herein. In one embodiment, the admixture comprises a slowly dissolving source of aluminum. The slowly dissolving source of aluminum may be one of the exemplary sources described elsewhere herein. In one embodiment, the admixture comprises one or more additional additives. The additional additives may be one of the exemplary additives described elsewhere herein. In one embodiment, the ASR mitigation admixture comprises one or more SCMs. In one embodiment, ASR mitigation admixture comprises an organic or inorganic salt coating an additive described elsewhere herein. In one embodiment, the ASR mitigation admixture comprises an organic or inorganic salt coating one or more types of SCM. In one embodiment, the ASR mitigation admixture comprises an organic or inorganic salt coating one or more types of fly ash.

In one embodiment, each component of the ASR mitigation admixture (i.e. the organic or inorganic salt, the slowly dissolving source of aluminum, and the additives) are provided separately in the kit. The components can be separated from each other using any method known to a person of skill in the art. In one embodiment, the components are placed into separate bags. In one embodiment, the components are placed into separate containers. In one embodiment, the components of the admixture are provided as a mixture in the kit. In one embodiment, particles of the entire mixture are coated in an agent that delays the dissolution or dispersion of the salt. Exemplary delayed release agents are described elsewhere herein.

In one embodiment, the kit comprises a solvent. Exemplary solvents are described elsewhere herein. In one embodiment, the kit comprises an aqueous solvent. In one embodiment, the kit comprises water.

In one embodiment, the kit comprises cement. The cement may be one of the exemplary cement types described elsewhere herein. In one embodiment, the cement comprises OPC. In one embodiment, the cement comprises PC. In one embodiment, the cement is provided separately from the ASR mitigation admixture or separately from each component of the ASR mitigation admixture.

In one embodiment, the kit comprises the ASR mitigation admixture blended with cement. In one embodiment, the blend comprises the optimum dosage of ASR mitigation admixture to cement to mitigate ASR in the concrete product. The concrete product can be any concrete product known to a person of skill in the art. Exemplary concrete products include, but are not limited to, pre-cast concrete elements, cast in place concrete, ready mix concrete, fiber-cement composite, mortars, and stucco. In one embodiment, the blend comprises the optimum ratio of ASR mitigation admixture to cement to mitigate ASR in concrete products.

In one embodiment, the blend comprises the optimum ratio of ASR mitigation admixture to cement based on the alkali content of the cement. In one embodiment, the blend comprises the optimum ratio of ASR mitigation admixture to cement based on the climate (e.g. temperatures and rainfall amount) of the area that the concrete product will be formed. In one embodiment, the blend comprises the optimum ratio of ASR mitigation admixture to cement based on the climate (e.g. temperatures and rainfall amount) of the area where the cement product will be used.

In one embodiment, the kit comprises cement clinker (or cement clinker derived material, such as ground, or partially ground cement clinker). The cement clinker may be one of the exemplary cement clinkers described elsewhere herein. In one embodiment, the cement clinker comprises OPC clinker. In one embodiment, the cement clinker comprises PC clinker. In one embodiment, the cement clinker is provided separately from the ASR mitigation admixture or separately from each component of the ASR mitigation admixture.

In one embodiment, the kit comprises the ASR mitigation admixture blended with cement clinker. In one embodiment, the kit comprises the ASR mitigation admixture inter-ground with cement clinker. In one embodiment, the blended/inter-ground admixture comprises the optimum ratio of ASR mitigation admixture to cement clinker to mitigate ASR in the concrete product. The concrete product can be any concrete product known to a person of skill in the art. Exemplary concrete products include, but are not limited to, pre-cast concrete, cast-in-place concrete, ready mix concrete, fiber-cement composite, mortars, and stucco. In one embodiment, the blended/inter-ground admixture comprises the optimum ratio of ASR mitigation admixture to cement clinker to mitigate ASR in concrete products.

In one embodiment, the blended/inter-ground admixture comprises the optimum ratio of ASR mitigation admixture to cement clinker based on the alkali content of the cement clinker. In one embodiment, the blend comprises the optimum ratio of ASR mitigation admixture to cement clinker based on the climate (e.g. temperatures and rainfall amount) of the area that the concrete product will be formed. In one embodiment, the blend comprises the optimum ratio of ASR mitigation admixture to cement clinker based on the climate (e.g. temperatures and rainfall amount) of the area where the cement product will be used.

In one embodiment, the kit comprises the ASR mitigation admixture blended with one or more SCMs. In one embodiment, the kit comprises the ASR mitigation admixture inter-ground with one or more SCMs. In one embodiment, the kit comprises the ASR mitigation admixture blended with one or more SCMs and cement. In one embodiment, the kit comprises the ASR mitigation admixture inter-ground with one or more SCMs and cement.

In one embodiment, the kit comprises aggregate. Exemplary aggregates are described elsewhere herein. In one embodiment, the aggregate comprises Class R1 aggregate. In one embodiment, the aggregate comprises Class R2 aggregate.

In one embodiment, the kit includes an instruction booklet which describes the ratios and method for using a powder ASR mitigation admixture to mitigate ASR in concrete products. In one embodiment, the kit includes an instruction booklet which describes the ratios and method for using a liquid ASR mitigation admixture to mitigate ASR in concrete products. In one embodiment, the instructions comprise when and/or how to add powder ASR mitigation admixture to fresh concrete during mixing. In one embodiment, the instructions comprise when and/or how to add liquid ASR mitigation admixture to fresh concrete during mixing.

In one embodiment, in a kit wherein the ASR mitigation admixture is blended with cement, the instructions comprise the amount of water to mix with the blend. In one embodiment, the instructions comprise the amount of aggregate to mix with the blend.

In one embodiment, in a kit wherein the ASR mitigation admixture is blended with one or more SCMs, the instructions comprise the amount of water to mix with the blend. In one embodiment, the instructions comprise the amount of aggregate to mix with the blend. In one embodiment, the kit comprises the ASR mitigation admixture blended with one or more SCMs and cement, the instructions comprise the amount of water to mix with the blend.

In one embodiment, in a kit comprising a solvent, the instructions comprise the amount of solvent to mix with the organic or inorganic salt to form a liquid admixture. In one embodiment, the instructions comprise how to coat an additive with the liquid admixture. In one embodiment, the instructions comprise how to coat an SCM with the liquid admixture. In one embodiment, the instructions comprise how to coat forms of fly ash with the liquid admixture. In one embodiment, the instructions comprise when and/or how to add the liquid admixture to fresh concrete during mixing.

In one embodiment, in a kit wherein the components of the ASR mitigation admixture are separate, the instructions comprise the proportions of ASR mitigation components that should be mixed to form the ASR mitigation admixture. In one embodiment, the instructions comprise the optimum ratio of organic or inorganic salts to slowly dissolving source of aluminum that should be mixed to form the ASR mitigation admixture. In one embodiment, the instructions comprise the optimum ratio of organic or inorganic salts to additives that should be mixed to form the ASR mitigation admixture.

In one embodiment wherein the kit comprises an ASR mitigation admixture that is separate from the cement or individual components to form the ASR mitigation admixture that are separate from the cement, the instructions comprise the optimum ratio of mixed ASR mitigation admixture to cement that should be used to prevent ASR in the concrete product. In one embodiment, the instructions comprise how the optimum ratio of ASR mitigation admixture to cement is affected by the different types of cement. In one embodiment, the instructions comprise the optimum ratio of ASR mitigation admixture to cement to use based on the alkali content of the cement. In one embodiment, the instructions comprise the optimum ratio of ASR mitigation admixture to cement to use based on the climate (e.g. temperatures and rainfall amount) of the area at which the concrete product will be used.

In one embodiment, wherein the kit comprises an ASR mitigation admixture that is separate from the cement, or individual components to form the ASR mitigation admixture that are separate from the cement, the instructions comprise the amount of water to add to the mixed ASR mitigation admixture. In one embodiment, the instructions comprise the amount of aggregate to add to the mixed ASR mitigation admixture.

### EXPERIMENTAL EXAMPLES

The invention is now described with reference to the following Examples. These Examples are provided for the purpose of illustration only, and the invention is not limited to these Examples, but rather encompasses all variations that are evident as a result of the teachings provided herein.

The objective of this study was to develop new alkali-silica reaction (ASR) inhibiting chemical admixtures that are cheaper and more abundant than lithium admixtures but provide more consistency in terms of quality, supply, and performance in comparison with supplementary cementitious materials (SCMs). A methodical approach was developed to identify such admixtures which primarily mitigate ASR by reducing the pH of the concrete pore solution. The mechanism of pH reduction was identified and a set of guidelines that a potential admixture should meet was developed. The suitable admixtures were also screened using mortar tests to estimate their impact on the performance properties of concrete, such as workability (pre-cure flow), time of setting (conversion of fresh concrete to hardened concrete), and mechanical properties such as compressive strength. A final list of promising admixtures was identified.

ASR mitigation strategies that are currently available for new concrete structures include: (1) use of non-reactive aggregates, (2) limiting alkali content of concrete (primarily by limiting the alkalis contributed by cement), (3) use of SCMs, and (4) use of lithium based admixtures (ASTM C1778-20, Standard Guide for Reducing the Risk of Deleterious Alkali-Aggregate Reaction in Concrete, ASTM International, 2020, West Conshohocken, Pa., USA; Thomas, M., et al., Federal Highway Administration report FHWA-HIF-09-001, National Research Council, Washington, D.C., 2008). Non-reactive aggregates are not available in many locations, while limiting the alkali content of concrete may not be sufficient to mitigate ASR on its own when highly reactive aggregates are used (see ASTM C1778-20, above). Lithium admixtures are expensive—adding 50˜60% to the cost of concrete—and there is high demand for lithium in other industries (e.g., car batteries) (Manissero, C, et al., Concr. Focus. NRMCA. (2006) 43-51; S&P Global (2019), (n.d.). https://www.spglobal.com/en/research-insights/articles/lithium-supply-is-set-to-triple-by-2025-will-it-be-enough (accessed Jun. 14, 2020). The use of SCMs, such as coal fly ash and slag, are currently the most widely used strategy to mitigate ASR; however, SCMs present their own set of challenges. There has been a steady decline in the supply and quality of fly ash in many countries. For example, in the United States, the fly ash supply has declined by more than 50% during the last decade due to coal power plant retirements (American Coal Ash Association (ACAA) Production and Use Reports 2000-2018, (n.d.). https://www.acaa-usa.org/publications/productionusereports.aspx (accessed Jun. 14, 2020). Also, more stringent air emission regulations have resulted in lower quality fly ashes with higher carbon, sulfur, and alkali contents (ACI Committee 232, 232.2R-18: Report on the Use of Fly Ash in Concrete, American Concrete Institute, 2018). It is estimated that by the year 2030, the annual supply of freshly produced ASTM C618 (see above) compliant fly ash in the United States will be ˜14 million tons, while the demand will exceed ˜35 million tons (Production and Use of Coal Combustion Products in the U.S.—Market Forecast Through 2033, American Road & Transportation Builders Association, 2015). While landfilled and ponded fly ash could serve as an alternate source, these materials have not yet been widely adopted due to their poor uniformity, contamination, and the permitting and capital investments required to allow their large-scale extraction, beneficiation, and use (G. Kaladharan, et al., ACI Mater. J. 116 (2019) 113-122). Ground granulated blast furnace slag (GGBFS) is generally less effective at mitigating ASR in comparison with low CaO fly ash and its availability is even more limited—the total world supply is only ˜5% of cement clinker produced (Thomas, M.; Cem. Concr. Res. 41 (2011) 1224-1231. doi:10.1016/j.cemconres.2010.11.003; Scrivener, K., Indian Concr. J. 88 (2014) 11-21).

Any new chemical admixture developed for ASR mitigation should possess certain essential characteristics. It needs to be cheaper and more abundant than lithium-based admixtures. When compared to SCMs, the supply stream of the admixtures should be more consistent in terms of their availability, quality, uniformity, and effectiveness against ASR. These attributes may not be seen with SCMs since they are byproducts of other industries. Additionally, the new ASR inhibiting admixtures should have minimal to no negative impact on other concrete properties, including its workability, setting, mechanical properties, and durability. The following sections provide details on a step-by-step approach that was developed in this study to identify such admixtures for use in concrete.

### Theoretical Considerations

### Pore Solution pH Cap for ASR Mitigation

The first step in ASR is dissolution or alteration of reactive silica as a result of hydroxyl ions (OH⁻) in the pore solution attacking and breaking the siloxane (≡Si—O—Si≡) bonds within the silica structure of the aggregates (Rajabipour, F., et al., Cem. Concr. Res. 76 (2015) 130-146). It is well established that OH⁻ concentration (represented as [OH⁻]) or pH of the pore solution of concrete have a direct impact on the magnitude and rate of silica dissolution and ASR in concrete (Maraghechi, H., et al., Cem. Concr. Res. 87 (2016) 1-13). In other words, ASR can be effectively mitigated by reducing the pH of the pore solution and this has been achieved and documented for many years by using low-alkali cements and/or using SCMs. The maximum pH threshold to prevent a deleterious ASR is related to the alkali tolerance of aggregates. This means that some moderately reactive aggregates may tolerate higher pH levels without exhibiting ASR, while other highly reactive aggregates may undergo ASR at lower pH values (Mukhopadhyay, A, et al., ASR Testing: A New Approach to Aggregate Classification and Mix Design Verification, Texas Department of Transportation, 2014).

Past research has suggested that while in typical portland cement concrete, [OH⁻] can be as high as 1.0 M (pH=14.0), when [OH⁻] is below 0.2 to 0.25 M in the pore solution, ASR cannot be sustained (Thomas, M.; Cem. Concr. Res. 41 (2011) 1224-1231; Diamond, S., J. Am. Ceram. Soc. 66 (1983) 82-84). This corresponds to a pore solution pH of 13.30 to 13.40. This pH level could be considered as a conservative upper limit for preventing ASR. However, such extreme pH reductions may not be necessary for moderately reactive aggregates, such as class R1 aggregates according to ASTM C1778 (see above) or when minor risk of ASR may be acceptable such as in pavements, highway barriers, and other structures with service life less than 75 years. It is sufficient if the ASR rate is reduced to such an extent that the deterioration is not significant during the service life of the structure.

Historically, cements with alkali content less than Na₂O_{eq}=0.6% were designated as low-alkali cement and were used as an acceptable method to mitigate ASR when reactive aggregates are present (Fournier, B., et al, Report on the Diagnosis, Prognosis, and Mitigation of Alkali-Silica Reaction (ASR) in Transportation Structures, 2010; ASTM C1778, see above). For a typical concrete pavement with cement content=350 kg/m³ and w/c=0.45, a low-alkali cement produces a concrete alkali loading of 2.1 kg/m³ or less. Assuming a degree of cement hydration of 70% and that the concrete is kept in saturated condition, a pore solution pH=13.65 is estimated using the NIST pore solution calculator (NIST pore fluid conductivity, NIST. (n.d.). https://www.nist.gov/el/materials-and-structural-systems-division-73100/inorganic-materials-group-73103/estimation-pore (accessed Jun. 14, 2020). A higher degree of hydration or a moisture content below saturation will result in a higher pore solution pH. Thus pH=13.65 can be considered as threshold (i.e., a maximum allowable pore solution pH) for ASR mitigation.

The ASTM guidance document (ASTM C1778, see above) recommends a lower concrete alkali loading of 1.8 kg/m³, resulting in pH=13.57 for the above pavement example. The ASTM document considers this level of alkalinity to be appropriate for mitigating ASR associated with moderately reactive (class R1) aggregates. For highly reactive aggregates, the use of SCM or a combination of SCM and limiting the alkali loading is recommended.

It has been well-established in the literature that SCMs mitigate ASR in concrete primarily by reducing the pore solution pH via alkali dilution and binding within pozzolanic C-S-H (Thomas, M., Cem. Concr. Res. 41 (2011) 1224-1231; Shafaatian, S., et al., Cem. Concr. Compos. 37 (2013) 143-153; Diamond, S., Cem. Concr. Res. 11 (1981) 383-394; Canham, I., et al., Cem. Concr. Res. 17 (1987) 839-844; Duchesne, J. et al., Cem. Concr. Res. 24 (1994) 221-230; T. Ramlochan, T., et al., Cem. Concr. Res. 30 (2000) 339-344; Rasheeduzzafar, S., et al., Cem. Concr. Compos. 13 (1991) 219-225; Shehata, M., et al., Cem. Concr. Res. 29 (1999) 1915-1920; Shehata, M., et al., Cem. Concr. Res. 32 (2002) 341-349. Thomas (Thomas, M.; Cem. Concr. Res. 41 (2011) 1224-1231) provided data on the dosage level of various SCMs required for ASR mitigation for very highly reactive aggregates (class R3 per ASTM C1778, see above) with concrete prism test (ASTM C1293-20a, Standard Test Method for Determination of Length Change of Concrete Due to Alkali-Silica Reaction, ASTM International, 2020, West Conshohocken, Pa.) expansions exceeding 0.24% at 1 year. He also provided the pore solution pH that was achieved by these SCMs at different dosage levels within concrete. Using this data, we can ascertain the pore solution pH that was required for ASR mitigation for the tested aggregates. This data is shown in Table 1. The lowest pH level required among the various SCMs was 13.49 when 40% slag was used to replace portland cement.

TABLE 1
Dosage level of SCMs that was required for ASR mitigation
with very highly reactive aggregates, and their corresponding
pore solution pH (data from Thomas)

| | SCM dosage for | |
|---|---|---|
| SCM | ASR mitigation | Pore solution pH |
| Low-CaO fly ash | 20% | 13.74 |
| High-CaO fly ash | 51% | 13.69 |
| Silica fume (SF) | 11% | 13.51 |
| Metakaolin | 14% | 13.57 |
| Slag | 40% | 13.49 |
| 5% SF + Low-CaO fly ash | 15% | 13.62 |
| 5% SF + High-CaO fly ash | 20% | 13.65 |
| 5% SF + Slag | 23% | 13.51 |

Based on the discussion above, one can choose a reasonable pH threshold to mitigate ASR. More conservative (lower pH) limits are safer but are also costlier in terms of the admixture dosage needed and the potential impacts on other dimensions of concrete performance, such as workability and strength. Here, we chose a pH threshold of 13.50 based on the data provided by Thomas (see above). Meanwhile a higher pH threshold of 13.65 may be chosen for moderately reactive (class R1) aggregates when used in structures with a service life less than 75 years. Thus, the forthcoming ASR inhibiting chemical admixtures can be classified into two categories—“highly effective” admixtures which maintain the pore solution pH below 13.50 and “moderately effective” admixtures which maintain the long-term pore solution pH of from 13.50 to 13.65. A low dose of highly effective admixture could be used instead of a moderately effective admixture where a lower ASR prevention level is sufficient.

### Identification of Suitable ASR Inhibiting Admixtures

Concrete pore solution is in essence a mixture of sodium and potassium hydroxide with small amounts of ions of calcium, aluminum, sulfates, and other ions (Taylor, H., Cement Chemistry, Second ed., Thomas Telford, London, 1997). The pH of the pore solution is typically more than 13.50. At such high pH values, and due to overabundance of OH⁻ ions, many multivalent metal cations (such as those in groups II or III of the periodic table or the transition metals) form metal hydroxide complexes that either precipitate out of the solution or are consumed in some secondary hydration reactions. For example, if one adds calcium chloride (CaCl₂)) salt to the pore solution of concrete, calcium hydroxide (Ca(OH)₂) precipitates due to its low solubility limit (1.9×10 M at pH=13.0), and in doing so, removes OH⁻ ions from (and reduces the pH of) the solution. As [OH⁻] is reduced, the chloride (Cl⁻) anion's charge balances the alkali ions (Na⁺ and K⁺) in the solution:

CaCl₂+2NaOH→2 NaCl+Ca(OH)₂ Eq. (1)

Another example is aluminum salts such as Al(NO₃)₃. Upon dissolution, [Al(OH)₄]⁻ complex forms and is further consumed by secondary reactions to form aluminoferrite hydrates (AFt and AFm), and calcium alumino-silicate hydrate (C-A-S-H) phases in concrete. The net result is again pH reduction and the nitrate (NO₃⁻) anions replacing some of the OH⁻ ions in the solution to charge balance the alkali ions.

Salts containing suitable multivalent cations (such as calcium, magnesium, aluminum, iron (II and III), zinc, copper, manganese, and so on) can potentially reduce the pH of the pore solution via the above-mentioned mechanism. There are over 700 salts which can be considered for pH-reduction in concrete. However, not all of them may efficiently reduce the pH and an even smaller subset would be safe to utilize as an ASR inhibiting concrete admixture due to various negative side-effects that these salts may have on the properties and performance of concrete. Here, we establish a set of guidelines (technical factors) that should be met by a candidate salt to ensure its suitability as an ASR inhibiting concrete admixture.

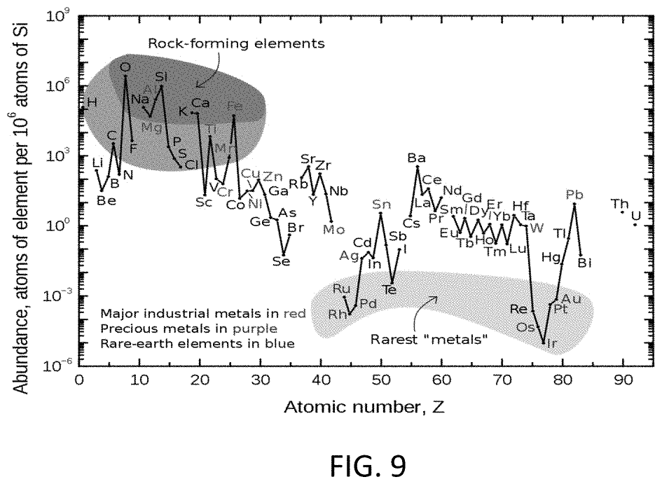

Factor 1—In an embodiment, the salt should have an abundant multivalent cation: From a practical standpoint, it would be ideal if the salt's cation is calcium (Ca), magnesium (Mg), aluminum (Al), or iron (Fe-II or Fe-III). As demonstrated in FIG. 9 (Rare Earth Elements-Critical Resources for High Technology, U.S. Geol. Surv. (n.d.). https://pubs.usgs.gov/fs/2002/fs087-02/(accessed Jun. 14, 2020); Wikipedia, Abundance of elements in Earth's crust, (n.d.). https://en.wikipedia.org/wiki/Abundance_of_elements_in_Earth%27s_crust (accessed Jun. 14, 2020), these are among the most abundant multivalent metallic elements on Earth's upper crust. Note that salts of monovalent metals such as Na and K do not cause pH reduction as their hydroxides are highly soluble. Other less abundant multivalent cations (e.g., copper, zinc, manganese, etc.) are potentially capable of reducing the pH; however, they are foreign to the chemistry of cement and concrete and may lead to significant negative changes in the properties of concrete. Also, heavy metals with potential or proven environmental toxicity should be avoided due to a fear of their leaching out of concrete and into water resources. These potential toxins include cadmium, mercury, lead, arsenic, manganese, chromium, cobalt, nickel, copper, zinc, selenium, silver, antimony, and thallium. Therefore, a total of 174 salts of Ca, Mg, Al, and Fe were considered in this study. These are listed in Table 10.

Factor 2—In an embodiment, the salt should be easily available, stable, non-hazardous, inexpensive, and without known negative effects in concrete: These are self-explanatory and essential for any commercially viable concrete admixture. FIG. 9 shows the abundance (atom fraction) of elements in the earth's upper continental crust as a function of atomic number. The availability, cost, and hazard level of the salts was checked by searching for the salts on various leading chemical vendor websites. The rationale was that if the salt was not readily available for laboratory use in such websites, then it is unlikely to be available for use at an industrial scale. With respect to cost, only the salts that are comparable to or cheaper than LiNO₃ (˜$50/100 g) were considered economically viable. The hazard level of each salt was obtained based on the US Hazardous Materials Identification System (HMIS) and those salts that were deemed highly hazardous (greater than level 2 in either the red, blue or yellow/orange categories) were excluded. Salts that contain deleterious anions such as chlorides were also excluded at this stage. After applying factor 2, a total of 35 salts remained under consideration.

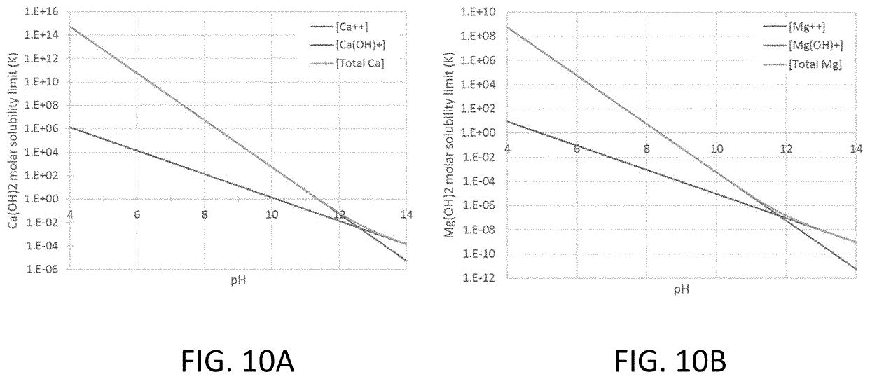

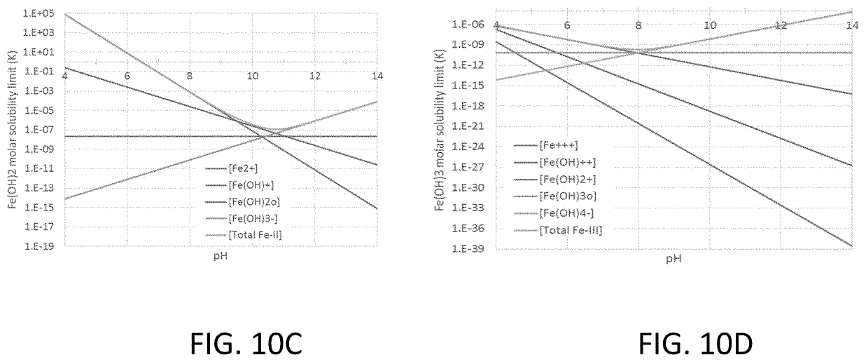

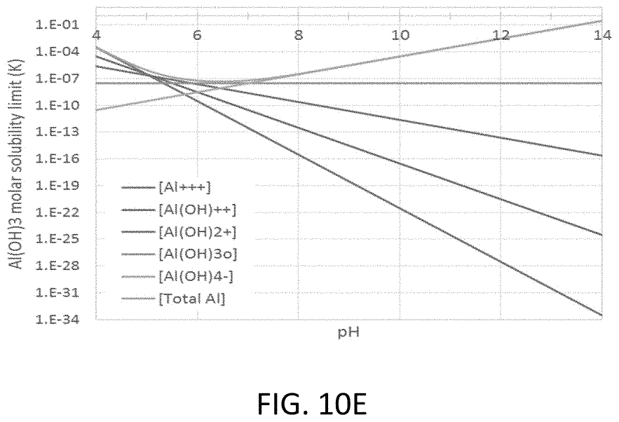

Factor 3—In an embodiment, the water solubility limit of the salt should be higher than that of its hydroxide: The solubility limit of the salt (Q) must be larger than the solubility limit of its hydroxide analog (K); i.e., Q/K>1. This ensures that the metal hydroxide precipitates and reduces [OH⁻] in the pore solution. The hydroxide complexes may be further consumed by some secondary reactions such as in the example of [Al(OH)₄]⁻ provided above. It is noted that K is highly pH dependent (see, for example, FIGS. 10A-10E). In this study, K at pH=13.0 was chosen for comparison with Q as this pH is typical of fresh concrete into which the salt is dissolving. The solubility of the hydroxide precipitates was calculated using the speciation data reported in the literature (Benjamin, M., Water Chemistry, Waveland Press, 2014; Lothenbach, B., et al., Cem. Concr. Res. 115 (2019) 472-506) and is reported in Table 2.

TABLE 2
Calculated molar solubility (K) of hydroxides of Ca, Mg,
Fe(II), Fe(III), and Al at pH values relevant to concrete

| Base | @pH = 12.0 | @pH = 13.0 | @pH = 13.6 |
|---|---|---|---|
| Ca(OH)₂ | 6.9 × 10⁻² | 1.9 × 10⁻³ | 3.8 × 10⁻⁴ |
| Mg(OH)₂ | 1.5 × 10⁻⁷ | 9.7 × 10⁻⁹ | 2.3 × 10⁻⁹ |
| Fe(OH)₂ | 8.2 × 10⁻⁷ | 8.0 × 10⁻⁶ | 3.2 × 10⁻⁵ |
| Fe(OH)₃ | 7.0 × 10⁻⁷ | 7.0 × 10⁻⁶ | 2.8 × 10⁻⁵ |
| Al(OH)3 | 3.0 × 10⁻³ | 3.0 × 10⁻² | 0.12 |

It is also important for the salt's anion to largely remain in the pore solution of concrete and not become absorbed in or adsorbed on to cement hydrated phases. This would result in OH⁻ being released back into the pore solution. An example of the latter is sulfate anions that are consumed by reaction with monosulfate to form ettringite (Eq. 2), thus increasing the [OH⁻] in concrete.

(CaO)₄(Al₂O₃)(SO₃)(H₂O)₁₂+2Ca(OH)₂+2SO₄²⁻+20H₂O→(CaO)₆(Al₂O₃)(SO₃)₃(H₂O)₃₂+40H⁻ Eq. (2)

Other anions which are known to form hydration products with cement include carbonates, chlorides, nitrates, and nitrites (Lothenbach, B., et al., Cem. Concr. Res. 115 (2019) 472-506). This anion uptake reduces the pH reduction efficiency of the salt admixture as discussed later. After applying factor 3, 23 salts remain under consideration. The remaining selection guidelines are based on experimental results and are discussed below.

### Mitigation of ASR by Passivation of Reactive Silica

In addition to (1) the pH reduction mechanism, ASR may be mitigated via (2) passivation of reactive silica within aggregates by aluminum ions that are introduced into the pore solution of concrete, (Iler, R. K., Industrial Chemicals Department, Research Division E. I. du Pont de Nemours & Co, 1973, 43:399-408; Bickmore, B. R. et al., Geochimica et Cosmochimica Acta, 2006, 70:290-305; Chappex, T. et al., Cement and Concrete Research, 2012, 42:1645-1649; Szeles, T. et al., Transportation Research Record, 2017, 2629:15-23). As a result, the optimum salts that produce pH reduction may be mixed together with a slowly dissolving source of aluminum to render a synergistic combination of strategies (1) and (2) above. One compound that can be used for this purpose is aluminum hydroxide (Al(OH)₃) in crystalline or amorphous forms—although other sources of slowly dissolving aluminum such as aluminum oxyhydroxide, aluminum phosphate, aluminum oxalate, aluminum oleate, aluminum hypophosphite, aluminum benzoate, and aluminum fluoride, and combinations thereof, may be used as well.

### Materials and Methods

To assess the effectiveness of the candidate salts for pH reduction and ASR mitigation, the first test conducted was pore solution extraction and pH analysis from cement pastes. Further, the effects of these salts on various mortar properties such as flow, time of setting, and compressive strength were also assessed. Further, ASTM C1293 (concrete prism test for ASR, see above), was completed for two salts and a combination of one salt and aluminum hydroxide. Additional ASTM C1293 tests have been started on the most promising salts and the preliminary results (up to ˜9 months) are presented.

### Materials

The candidate salts tested in this study were sourced from various chemical vendors: Alfa Aesar (Heysham, Lancs, UK), ACROS Organics (Thermo Fisher Scientific, Waltham, Mass., USA), and Spectrum (New Brunswick, N.J., USA). A minimum purity level of 95% was used for all salts.

To measure the performance of candidate ASR inhibiting salts in the presence of various cement compositions, three different ASTM C150/C150M (ASTM C150/C150M-19a—Standard Specification for Portland Cement, ASTM International, 2019, West Conshohocken, Pa., USA) compliant Type I/II portland cements were used in this study. The properties of the three cements, OPC1, OPC2, and OPC3 are shown in Table 3. The results shown are based on data from cement mill certificates and fused bead X-ray fluorescence (XRF) spectroscopy.

All three OPCs were used for the pore solution pH measurements. The lower alkali content of OPC2 enabled testing an exhaustive list of salt admixtures to quantify their impact on the pH. However, OPC1 and OPC3 are more representative of the typical cements used by the industry in terms of their alkali content and hence were also used to verify the effectiveness of the salts. OPC2 was used for the Inductively Coupled Plasma Atomic Emission Spectroscopy (ICP-AES) tests at 7 days. OPC2 was also used for testing the flow, compressive strength, and setting time of mortars.

TABLE 3
Properties of the portland cements used in this study

| | | | |
|---|---|---|---|
| Properties | OPC1 | OPC2 | OPC3 |

Oxide composition (wt. %)

| | | | |
|---|---|---|---|
| CaO | 60.78 | 61.71 | 61.55 |
| SiO₂ | 19.41 | 19.61 | 19.05 |
| Al₂O₃ | 4.61 | 3.86 | 4.19 |
| Fe₂O₃ | 3.82 | 4.24 | 3.98 |
| MgO | 2.91 | 2.79 | 2.90 |
| SO₃ | 4.00 | 3.18 | 3.49 |
| Na₂O_{eq} | 0.90 | 0.79 | 0.95 |

Physical properties

| | | | |
|---|---|---|---|
| Blaine Fineness (m²/kg) | 400 | 400 | 390 |

Phase composition (wt. %)

| | | | |
|---|---|---|---|
| C₃S | 49.54 | 58.62 | 60.27 |
| C₂S | 15.56 | 9.70 | 7.63 |
| C₃A | 5.47 | 2.93 | 4.25 |
| C₄AF | 11.06 | 12.37 | 11.77 |
| Limestone | 4.87 | 4.10 | 2.79 |

Example 1. Cement pastes comprising the inorganic or organic ASR-mitigating salts were prepared by dry-blending cement and inorganic or organic ASR-mitigating salts, then adding water and mixing according to the procedure given in ASTM C305 standard using a Hobart model mixer. An example for 2% calcium acetate on a weight basis as a replacement of portland cement includes the following proportions: 980 g of portland cement, 20 g calcium acetate, and 450 g of water. The salt dosage rates are mentioned in this section (and in the Figures) on a replacement of OPC basis (as the formulations were constructed). However, the salt dosage rates can also be reported as a salt % based on the weight of solids of the salt as a percentage of the weight of solids of cement (such as OPC); the latter format is generally more familiar and is used in the claims. (In the above example, the 2.00% salt dosage on a replacement of OPC basis would be reported as 2.04% based on the weight of the salt as a percentage of the cement (OPC) (that is 20 g/980 g, instead of 20 g/1000 g). Cement pastes were tested for the pore solution analysis as described below at ages of 0, 7, and 28 days.

Example 2. A separate set of cement pastes were prepared wherein each salt was pre-dissolved or suspended in water before mixing the cement paste. As an example, 20 g calcium acetate was pre-dissolved in 450 g of water, and the solution was added to 980 g of portland cement and mixed according to the procedure given in ASTM C305 standard using a Hobart model mixer to prepare a homogenous paste mixture. These cement pastes were tested for the pore solution analysis as described below at ages of 0 and 7 days.

Example 3. Mortar compositions for the flow, setting time, and compressive strength tests described herein were prepared similarly, by dry-blending of portland cement and inorganic or organic ASR-mitigating salts, followed by addition of water and ASTM C33 compliant sand according to the order of addition and mixing procedure of ASTM C305. For example, for the mortar containing 2% by weight of calcium acetate as a replacement of OPC, 490 g of cement and 10 g of calcium acetate were dry blended, followed by the addition of 242 g of water; and then, using a Hobart model mixer, stirring in 1375 g of ASTM C33 compliant sand. In the case of preparing samples for the mortar cube strength test, the batch size used was double the quantity of the one described above but the mixing procedure was the same. Therefore, the batch sizes were 980 g of cement, 20 g of calcium acetate, 484 g of water and 2725 g of ASTM C33 compliant sand (fine aggregate). In the case of the setting time test, the proportions were slightly adjusted to match the concrete proportions. Therefore, 2156 g of cement, 44 g of calcium acetate, 990 g of water, and 6050 g of ASTM C33 compliant sand were used. The mixing procedure was the same as the above.

Example 4. Concrete compositions were prepared similarly, based on the procedure and proportions provided in ASTM C192 and ASTM C1293 (ASTM C192/192M-18—Standard Practice for Making and Curing Concrete Test Specimens in the Laboratory, ASTM International, 2018, West Conshohocken, Pa., USA; ASTM C1293—see above). The cement and ASR-mitigating salt were first dry blended. The concretes were prepared using w/cm=0.45 and cementitious materials content of 420 kg/m³. A highly reactive coarse aggregate, Spratt siliceous limestone from Ontario, Canada, was used having an oven dry specific gravity of 2.64, absorption capacity of 0.74% and dry-rodded unit weight of 1496 kg/m³. The nonreactive fine aggregate was natural sand from Pennsylvania with oven dry specific gravity of 2.70, absorption capacity of 0.46%, and fineness modulus of 2.95. For the example of 2% calcium acetate, the following proportions were used: 5075 g of portland cement and 104 g of calcium acetate were pre-blended. 2330 g of water was spiked with 30 g of sodium hydroxide pellets and used as the concrete mix water, as required by ASTM C1293. 14,090 grams of No. 56 (ASTM C33) coarse aggregate (split evenly between size fractions—4.75 to 9.5 mm, 9.5 to 12.5 mm, and 12.5 to 19 mm) and 6,590 grams of ASTM C33 compliant fine aggregate were also used in preparation of the concrete mixture. The concrete mixtures were cast into 25 mm by 25 mm by 279 mm prism specimens and moist cured at 23° C. and 100% relative humidity for the first 24 hours after casting. Next, the specimens were demolded and stored as per the requirements of the ASTM C1293 standard, and the length change measurements were taken monthly or bi-monthly to evaluate the ASR expansion as a function of time.

### Pore Solution Analysis of Cement Pastes

The pore solution of sealed cement pastes incorporating the candidate salts was extracted and tested at fresh state, 7 days, and 28 days (in promising cases) after casting. The cement paste was prepared with a w/cm=0.45 as described in Examples 1 and 2 above (where w/cm is the ratio of the weight of water to the weight of cementitious materials, and where the cementitious materials include the salt mass). The fresh pore solution of each cement paste was extracted using pressure filtration while the 7-day and 28-day pore solution samples were extracted using a high-pressure pore press die operated up to a maximum pressure of 215 MPa. After extraction, each pore solution was filtered using a 0.45 μm filter and acid titrated using 0.084M HCl and with phenolphthalein indicator to determine its pH. A portion of each 7-day pore solution was analyzed using ICP-AES to determine its ionic composition.

### Flow, Compressive Strength, and Setting Time of Mortar

Mortar mixtures for flow and compressive strength tests containing each candidate salt were prepared with w/cm=0.485 and sand to cement ratio of 2.75 by mass. A natural ASTM C33 sand (ASTM C33/C33M-18 Standard Specification for Concrete Aggregates, 2018; ASTM Int., West Conshohocken, Pa., USA) with oven-dry specific gravity of 2.62, absorption capacity of 1.66%, and fineness modulus of 3.0 was used. Mortars were mixed according to ASTM C305 (ASTM C305-20 Standard Practice for Mechanical Mixing of Hydraulic Cement Pastes and Mortars of Plastic Consistency, 2020; ASTM Int., West Conshohocken, Pa., USA) as described in Example 3 above. Flow test for each mortar was conducted within 6 minutes after contact between cement and water and according to ASTM C1437 (ASTM C1437-15, Standard Test Method for Flow of Hydraulic Cement Mortar, 2015; ASTM Int., West Conshohocken, Pa., USA). A set of 5×5×5 cm cubes were cast for compressive strength measurement at 1, 7, and 28 days of age and according to ASTM C109/C109M (ASTM C109/C109M-20b Standard Test Method for Compressive Strength of Hydraulic Cement Mortars (Using 2-in. or 50-mm Cube Specimens), 2020; ASTM Int., West Conshohocken, Pa., USA). Three cubes were tested at each age. Further, the setting time test was conducted using the penetration resistance method according to ASTM C403 (ASTM C403/C403M-16, Standard Test Method for Time of Setting of Concrete Mixtures by Penetration Resistance, 2016; ASTM Int., West Conshohocken, Pa., USA). Mortar mixtures for setting time test containing each candidate salt were prepared with w/cm=0.45 and sand to cement ratio of 2.75 by mass. Three specimens were prepared and tested for each candidate salt.

### Concrete Prism Test to Evaluate ASR Mitigation

Concrete prism tests were performed according to ASTM C1293 (see above) to provide a confirmation of whether a candidate salt admixture can mitigate ASR.

A first series of concrete prism tests used a control mixture (100% OPC1) and three test mixtures containing either Al(NO₃)₃.9H₂O (abbreviated as AN), AN and aluminum hydroxide (abbreviated as AH), or Fe(NO₃)₃.9H₂O (abbreviated as FN) were prepared. AN and FN salts were used at an OPC1 replacement level of 10% by mass whereas in the combination mixture, 10% AN and 5% AH were used on a mass replacement basis of OPC1. The concretes were prepared using w/cm=0.45 and cementitious materials content of 420 kg/m³ as described in Example 4 above. A highly reactive coarse aggregate, Spratt siliceous limestone from Ontario, Canada, was used having an oven dry specific gravity of 2.64, absorption capacity of 0.74% and dry-rodded unit weight of 1496 kg/m³. The nonreactive fine aggregate was natural sand from Pennsylvania with oven dry specific gravity of 2.70, absorption capacity of 0.46%, and fineness modulus of 2.95. The specimens were demolded and stored as per the requirements of the ASTM C1293 standard, and the length change measurements were taken monthly or bi-monthly (at a higher frequency than that specified in the standard).

A second series of concrete prism tests used a similar control mixture (100% OPC) and test mixtures containing a final list of promising salts. While the first concrete prism test was tested to completion (2 years), the second series ran for approximately 9 months (which, in this case, was sufficient to show the appropriate differentiation). These concrete prism tests were performed with the same w/cm ratio and cementitious materials content as the above test. The coarse aggregate used (Bakersville quarry, PA, USA) was highly reactive and the fine aggregate used (Northumberland, Pa., USA) was non-reactive. Both aggregates were sourced from Pennsylvania, USA. The coarse aggregate had an oven dry specific gravity of 2.66, absorption capacity of 0.56%, and dry rodded unit weight of 1623 kg/m³. The fine aggregate was the same as the one described for the mortar testing.

### Results and Discussion

### Pore Solution of Cement Pastes

The pore solution pH data for cement pastes incorporating various candidate salts and at various dosages is shown in Table 4 (for OPC1), Table 5 (for OPC2), and Table 6 (for OPC3). Salts that had a 28-day pH value less than 13.65 are distinguished using a bold font.

TABLE 4
Pore solution pH of cement pastes at fresh state, 7, and 28
days for mixtures containing OPC1 and candidate salts (bold
fonts represent salt/dosage combinations resulting in 28-
day pH lower than the ASR triggering threshold of 13.65)

| | Cement paste age (days) | | |
|---|---|---|---|
| Mixture | 0 | 7 | 28 |
| 100% OPC1 | 13.02 | 13.80 | 13.86 |
| 10% Aluminum Nitrate•9H₂O | 11.02 | 13.51 | 13.56 |
| 10% Ferric Citrate•5H₂O | 12.32 | 13.32 | N/A |
| (very poor strength) | | | |
| 10% Ferric Nitrate•9H₂O | 11.65 | 13.55 | 13.60 |
| 10% Ferrous Oxalate•2H₂O | 11.78 | 13.77 | N/A |
| 10% Magnesium Bromide•6H₂O | 12.50 | 13.20 | 13.25 |
| 5% Magnesium Bromide•6H₂O | 12.50 | 13.50 | 13.61 |
| 10% Magnesium Citrate | 12.50 | Did not set at 7 days | |
| 10% Magnesium Nitrate•6H₂O | 12.32 | 13.32 | 13.44 |
| 10% Magnesium Oxalate•2H₂O | 13.10 | 13.75 | N/A |
| 10% Calcium Acetate•1H₂O | Poor workability | | |
| 10% Calcium Bromide•2H₂O | 12.50 | 12.72 | 12.92 |
| 5% Calcium Bromide•2H₂O | 12.50 | 13.24 | 13.44 |
| 10% Calcium Dihydrogen | 8.10 | 13.67 | N/A |
| Phosphate•H₂O | | | |
| 10% Calcium Formate | 12.80 | 12.87 | 13.04 |
| 5% Calcium Formate | 12.72 | 13.25 | 13.32 |
| 4% Calcium Formate | 12.72 | 13.30 | 13.38 |
| 10% Calcium Nitrate•4H₂O | 12.62 | 12.90 | 13.17 |
| 5% Calcium Nitrate•4H₂O | 12.50 | 13.57 | 13.58 |
| 4% Calcium Formate + | 12.62 | 13.30 | 13.44 |
| 1% Calcium Bromide•2H₂O | | | |

TABLE 5
Pore solution pH of cement pastes at fresh state, 7, and 28
days for mixtures containing OPC2 and candidate salts (bold
fonts represent salt/dosage combinations resulting in 28-
day pH lower than the ASR triggering threshold of 13.65)

| | Cement paste age (days) | | |
|---|---|---|---|
| Mixture | 0 | 7 | 28 |
| 100% OPC2 | 13.00 | 13.75 | 13.77 |
| 4% Aluminum Fluoride | 12.87 | 13.68 | 13.68 |
| 5% Aluminum Nitrate•9H₂O | 12.32 | 13.54 | 13.55 |
| 5% Ferric Fluoride | 11.97 | 13.68 | 13.72 |
| 10% Ferric Phosphate Hydrate | 12.98 | 13.76 | N/A |
| 10% Ferrous Fumarate | 12.67 | 13.21 | 13.26 |
| 5% Ferrous Fumarate | 12.80 | 13.30 | 13.40 |
| 5% Ferrous Fumarate - | 12.87 | 13.32 | N/A |
| pre-suspended | | | |
| 10% Magnesium Acetate•4H₂O | 12.50 | 12.72 | No fluid* |
| 5% Magnesium Acetate•4H₂O | 12.50 | 13.00 | 13.10 |
| 4% Magnesium Acetate•4H₂O | 12.50 | 13.10 | 13.17 |
| 2% Magnesium Acetate•4H₂O | 12.50 | 13.38 | 13.41 |
| 2% Magnesium Acetate•4H₂O - | 12.62 | 13.36 | N/A |
| pre-dissolved | | | |
| 5% Magnesium Bromide•6H₂O | 12.62 | 13.44 | 13.53 |
| 5% Magnesium Bromide•6H₂O - | 12.50 | 13.45 | N/A |
| pre-dissolved | | | |
| 5% Magnesium Fluoride | 12.92 | 13.73 | N/A |
| 5% Magnesium Nitrate•6H₂O | 12.32 | 13.53 | 13.57 |
| 5% Magnesium Nitrate•6H₂O - | 12.50 | 13.55 | N/A |
| pre-dissolved | | | |
| 5% Magnesium Sulfate | 12.67 | 13.34 | 13.62 |
| 5% Calcium Acetate•1H₂O | 12.57 | 12.83 | 12.98 |
| 4% Calcium Acetate•1H₂O | 12.50 | 13.02 | 13.10 |
| 2% Calcium Acetate•1H₂O | 12.50 | 13.32 | 13.33 |
| 2% Calcium Acetate•1H₂O - | 12.62 | 13.30 | N/A |
| pre-dissolved | | | |
| 10% Calcium Benzoate•3H₂O | 12.42 | 12.95 | 13.02 |
| 5% Calcium Benzoate•3H₂O | 12.67 | 13.12 | 13.14 |
| 4% Calcium Benzoate•3H₂O | 12.67 | 13.17 | 13.23 |
| 2% Calcium Benzoate•3H₂O | 12.72 | 13.44 | 13.47 |
| 5% Calcium Bromide•2H₂O | 12.50 | 13.30 | 13.42 |
| 5% Calcium Bromide•2H₂O - | 12.62 | 13.30 | N/A |
| pre-dissolved | | | |
| 10% Calcium Di-Gluconate•H₂O | Rapid setting & poor strength | | |
| 4% Calcium Formate | 12.62 | 13.32 | 13.34 |
| 4% Calcium Formate - | 12.62 | 13.30 | N/A |
| pre-dissolved | | | |
| 2% Calcium Formate | 12.62 | 13.50 | 13.58 |
| 5% Calcium L-lactate•5H₂O - | 12.92 | 13.68 | 13.82 |
| pre-suspended | | | |
| 5% Calcium Nitrate•4H₂O | 12.62 | 13.50 | 13.55 |
| 5% Calcium Nitrate•4H₂O - | 12.62 | 13.51 | N/A |
| pre-dissolved | | | |
| 5% Calcium Nitrite - | 12.72 | 13.02 | 13.17 |
| pre-dissolved | | | |
| 3% Calcium Nitrite - | 12.50 | 13.17 | TBD |
| pre-dissolved | | | |
| 2% Calcium Nitrite - | 12.62 | 13.36 | TBD |
| pre-dissolved | | | |

| | | |
|---|---|---|
| 10% Calcium Propionate | 12.92 | High porosity and no |
| | | fluid* |

*No pore fluid could be extracted from these samples

TABLE 6
Pore solution pH of cement pastes at fresh state, 7, and 28
days for mixtures containing OPC3 and candidate salts (bold
fonts represent salt/dosage combinations resulting in 28-
day pH lower than the ASR triggering threshold of 13.65)

| | Cement paste age (days) | | |
|---|---|---|---|
| Mixture | 0 | 7 | 28 |
| 100% OPC3 | 13.02 | 13.91 | 13.94 |
| 2% Calcium Acetate•1H₂O | 12.72 | 13.50 | 13.57 |
| 3% Calcium Acetate•1H₂O | 12.62 | 13.32 | 13.40 |
| 2% Magnesium Acetate•4H₂O | 12.62 | 13.60 | 13.62 |
| 3% Magnesium Acetate•4H₂O | 12.32 | 13.47 | 13.53 |
| 5% Ferrous Fumarate | 12.98 | 13.50 | 13.59 |
| 6% Ferrous Fumarate | 12.98 | 13.44 | 13.48 |
| 5% Magnesium Nitrate•6H₂O | 12.42 | 13.79 | N/A |
| 6% Magnesium Nitrate•6H₂O | 12.32 | 13.76 | N/A |

A number of important observations can be made from the results in Tables 4 to 6. First, it can be seen that salts containing fluorides, oxalates, and various forms of phosphates consistently underperform irrespective of the cation of the salt. This is due to the low solubility of the calcium salt of these anions. As mentioned earlier, the salt's anion needs to stay in the pore solution in order to charge balance the alkali ions and keep the pH low. When the calcium salt of a given anion has low solubility, it precipitates, thus lowering [Ca²⁺] in the pore solution. To compensate for Ca ion deficiency, solid calcium hydroxide, which is abundant in cement systems, dissolves and increases [OH⁻] in the pore solution. In effect, hydroxyl ion replaces the salt's anion, resulting in an increase in the pH of the pore solution. An example of this effect if observed for ferric fluoride (Table 5) where the pH initially drops due to formation of ferric hydroxide complex/precipitate. However, once the fluoride ions also precipitate out of the pore solution via formation of calcium fluoride, the pH goes back up at 7 and 28 days. The underlying reactions are shown in Eqs. (3) and (4).

FeF₃+3NaOH→Fe(OH)₃+3Na⁺+3F⁻ Eq. (3)

2Na⁺+2F⁻+Ca(OH)₂→CaF₂+2Na⁺+2OH⁻ Eq. (4)

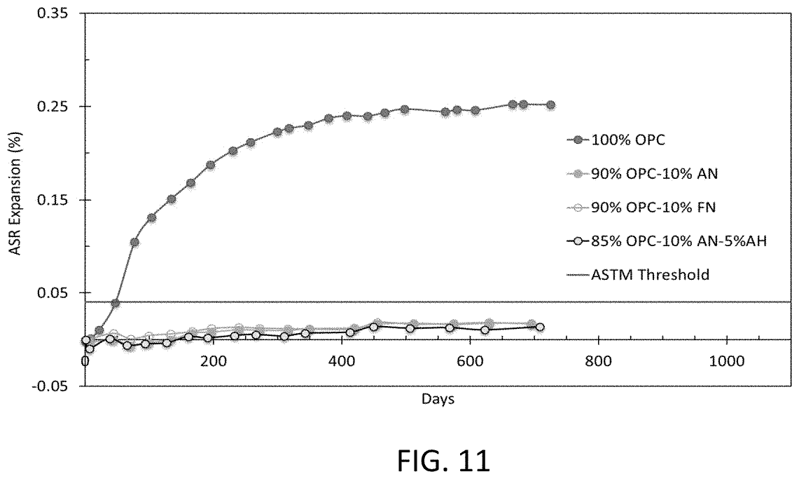

Second, as shown in Table 4, aluminum nitrate (AN) and ferric nitrate (FN) go on to maintain a 28-day pore solution pH below 13.65. ASTM C1293 (cement prism test, see above) test results presented in FIG. 11 show that 10% AN and 10% FN are capable of mitigating ASR in concrete containing a highly reactive coarse aggregate (Class R2 aggregate according to ASTM C1778 (see above). Additionally, the combination 10% AN+5% AH performed better than 10% AN and 10% FN mixtures in controlling ASR. This is due to the additional mitigatory effect provided by AH via passivating the reactive silica. It is possible that combination of acidifying salts and AH (or another source of slowly dissolving aluminum) would lead to synergistic effects such that a lower dosage of salt can be used to mitigate ASR, and this could reduce the cost and side-effects on the properties of concrete.

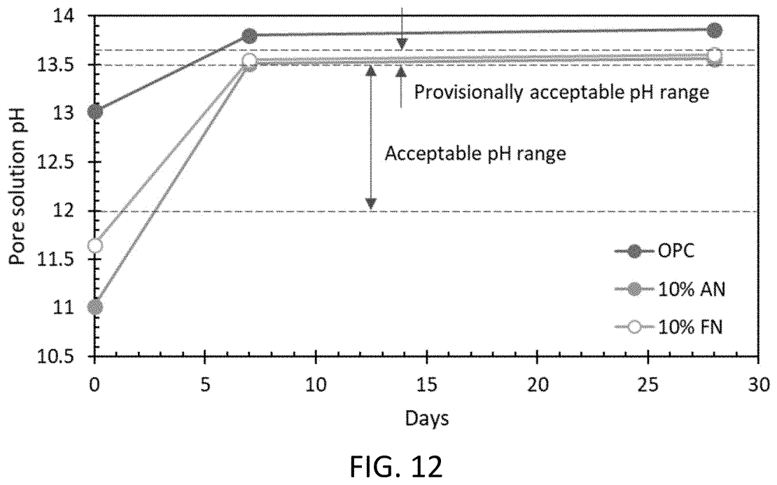

FIG. 12 shows the pore solution pH of AN and FN mixtures, demonstrating that the long-term pH of concrete has decreased from 13.86 for the control mixture (100% OPC) to 13.60 or below for concretes containing 10% FN or 10% AN. Since pH is a logarithmic scale, this amounts to reducing the alkalinity (OH⁻ ion concentration) of the pore solution by nearly 50% as a result of admixing 10% AN or 10% FN salt. This pH reduction has led to mitigation of ASR in these concrete mixtures.

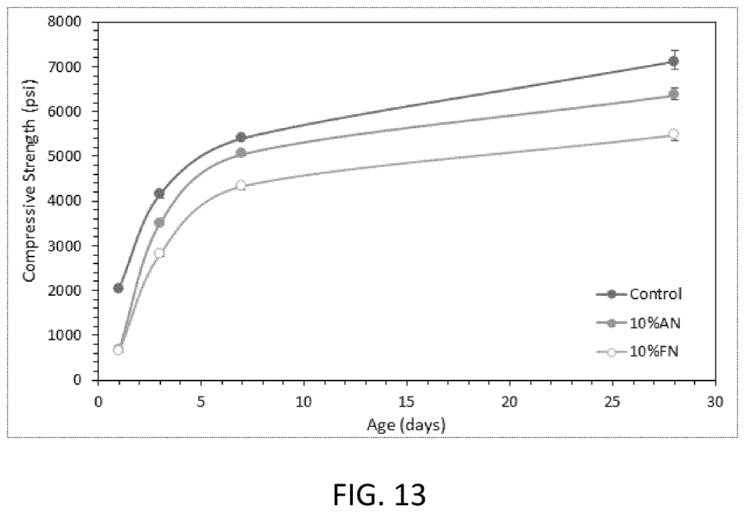

While acidification of the concrete pore solution is effective for mitigation of ASR, too much or too early acidification can negatively affect the workability, setting, and strength development of concrete. FIG. 12 shows that the pH of fresh concrete (age=0) has dropped from 13.02 for the control mixture to 11.65 for 10% FN and 11.02 for 10% AN mixtures. Such drastic early-age pH reduction (to below 12.0) interferes with the hydration of Portland cement (specifically with the reaction of calcium silicates) (Nicoleau, L. et al., Cement and Concrete Research, 2014, 59:118-138), resulting in a loss of concrete strength, as demonstrated in FIG. 13. A 69% drop in the 1-day strength is observed when using 10% AN or 10% FN. This would necessitate extended curing and would prevent a timely opening of the structure to use. The strength loss improves with age but never reaches similar strength to that of the control mixture. In addition, the excessive pH drop at early-age, in combination with the available Al or Fe contributed by the cement and/or the salt, promote rapid formation of mineral ettringite, which significantly reduces the fluidity and workability of concrete. The testing of mortar mixtures (according to ASTM C1437-15, see above) showed a drastic drop of workability from 123% flow for the control mixture to 44% and 77% for mixtures containing 10% AN and 10% FN, respectively. Similarly, 10% AN and 10% FN were observed to interfere with the time of setting of mortar (i.e., conversion from fluid to hardened state) by increasing the initial setting time from 5.2 hrs (control) to 8.7 hrs and 9.7 hrs, respectively, while also delaying the final setting time significantly. Both effects are due to reduced reactivity of calcium silicates at low pH. Such interferences in early-age properties of concrete impose tremendous and costly challenges to constructability of such concretes and would prevent industry adoption of AN and FN salts as viable ASR-mitigating admixtures.

Indeed, past research has shown that when the fresh state pH is below 12, aluminum ions in the pore solution interact with the C₃S grain surfaces and temporarily prevent their hydration [42]. This effect can be seen in the mortar compressive strength results in FIG. 13. The early age strength for mortars with 10% AN or 10% FN is poor (69% strength reduction at 1 day compared to the control) but the strength improves at later ages as the pH increases. This fresh state pH plunge is likely due to very rapid precipitation of metal hydroxides or their consumption in secondary hydration reactions (e.g., AFm and AFt formation). To prevent such adverse early age effects, the fresh pH of the pore solution should remain greater than 12.0. The cement retardation effect may also be a problem when the fresh pH is between 12.0 and 12.5, but this needs to be analyzed on a case-to-case basis (Nicoleau, L., et al., Cem. Concr. Res. 59 (2014) 118-138).

The total magnitude of [OH⁻] reduction due to introduction of a cation-anion salt can be described as:

Δ[OH⁻]=nΔ[Cat]=n(Q′−K)(eff)≅nQ′(eff) Eq. (5)

where, n is the cation valence, Δ[Cat] is the reduction in the cation concentration due to precipitation of the cation hydroxide, Q′ is the number of moles of salt admixed per unit volume of pore solution (salt+mix water), K (often <<Q′) is the molar solubility of the cation hydroxide, and eff is the pH reduction efficiency of the admixed salts. The efficiency has been found to be related to the dosage of the salt (i.e., more efficient at lower dosages). In addition, when a salt's anion does not largely remain in the pore solution (e.g., as in the case of fluorides and sulfates discussed earlier), the efficiency factor of the admixture diminishes in proportions with the fraction of anions removed from the pore solution.

As an example, for 10% AN admixed into cement paste with water to cementitious materials ratio (w/cm)=0.45, Q′=(0.027 moles AN)/(50.9 cc solution)=0.52M. Since n=3 and using data in Table 4 which show a pH reduction at 28 days of 13.86 (control paste) to 13.56 (10% AN paste), Δ[OH⁻]=0.36M resulting in eff=0.23. This low efficiency is partly due to uptake of nitrate anions to form a nitrate AFm phase in reaction with available C₃A or monosulfate, as described by Eqs. (6) and (7) below (Lothenbach, B., et al., Cem. Concr. Res. 115 (2019) 472-506; Duran, A., et al., Cem. Concr. Res. 81 (2016) 1-15). While Eq. (6) directly results in release of OH⁻ ions back into the pore solution, in Eq. (7), sulfate ion is released which further reacts with monosulfate to form ettringite according to Eq. (2), thus releasing OH⁻ ions. In either case, the latent release of OH⁻ ions reduce the pH-reduction efficiency of the admixed nitrate salt.

(CaO)₃(Al₂O₃)+Ca(OH)₂+2NO₃⁻+10H₂O→Ca₄Al₂(OH)₁₂(NO₃)₂(H₂O)₄+20H⁻ Eq. (6)

(CaO)₄(Al₂O₃)(SO₃)(H₂O)₁₂+2NO₃⁻→Ca₄Al₂(OH)₁₂(NO₃)₂(H₂O)₄+2H₂O+SO₄²⁻ Eq. (7)

The efficiency factor for a number of the ASR inhibiting salts was calculated similarly and is provided in Table 7. It is noted that acetate salts are highly efficient, followed by bromides, fumarates, formates, and nitrates. Salts whose anion does not stay in the pore solution (i.e., fluorides, sulfates, and to a lesser extent, nitrates) are less efficient. It is also noted that the estimate of efficiency is cement dependent and that in two cases, the estimated efficiency is greater than 100%. These are likely because Eq. (5) does not account for the reduction in the volume of pore solution with time due to cement hydration. This effect causes Q′ to increase with time while Eq. (5) assumes Q′ to be constant and only a function of the salt dosage and w/cm of the paste. Neglecting this effect inflates the value of eff. Also, the salts are more efficient against high alkali cements (OPC1 and OPC3). Overall, the estimated efficiencies should be only considered qualitatively.

TABLE 7
Efficiency factor for some ASR inhibiting
salts estimated using Eq. (5)

| | Efficiency at 28 days (%) | | | |
|---|---|---|---|---|
| Salt | OPC1 | OPC2 | OPC3 | Average |
| Magnesium acetate (2% MAc) | NA | 82.5% | 109.7% | 96.1% |
| Magnesium acetate (3% MAc) | NA | NA | 88.4% | 88.4% |
| Calcium acetate (2% CAc) | NA | 76.2% | 100.7% | 88.5% |
| Calcium acetate (3% CAc) | NA | NA | 76.9% | 76.9% |
| Calcium bromide (5% CB) | 46.4% | 33.6% | NA | 40.0% |
| Magnesium bromide (5% MB) | 43.7% | 35.1% | NA | 39.4% |
| Ferrous fumarate (6% F2Fu) | NA | NA | 37.4% | 37.4% |
| Ferrous fumarate (5% F2Fu) | NA | 26.9% | 37.8% | 32.4% |
| Calcium formate (4% CFo) | 36.9% | 28.2% | NA | 32.6% |
| Calcium nitrate (5% CN) | 38.9% | 26.1% | NA | 32.5% |
| Magnesium nitrate (5% MN) | NA | 26.9% | NA | 26.9% |
| Aluminum nitrate (5% AN) | NA | 27.7% | NA | 27.7% |
| Aluminum nitrate (10% AN) | 23.0% | NA | NA | 23.0% |
| Ferric nitrate (10% FN) | 22.5% | NA | NA | 22.5% |
| Magnesium sulfate (5% MS) | NA | 9.5% | NA | 9.5% |
| Aluminum fluoride (4% AF1) | NA | 3.4% | NA | 3.4% |
| Ferric fluoride (5% FF1) | NA | 2.2% | NA | 2.2% |

The calculated efficiencies are corroborated by the 7-day pore solution ICP-AES results that are shown in Table 8. ICP-AES does not directly measure the anion concentration, but it measures metallic ions (Na, K, Mg, Ca, Al, Fe, etc.) as well as S. The hydroxide ion concentration was determined through acid titration. Using the measured ion concentrations, charge balance was applied to determine the concentration of the only major ion left—the anion from the salt. In addition, the anion concentration at fresh state (shortly after mixing) was calculated from the mixture proportions of each paste and is included in the table. The −5.4 mmol/L in column (f) and OPC row does not represent any anion. It is shown here to establish the accuracy of the charge balance process.

TABLE 8
Concentration of major ions (in mmol/lit) in the pore solution of the pastes at 7
days (all other ions were <1 mmol/lit)

| | | | | | | | (g) | |
|---|---|---|---|---|---|---|---|---|
| | | | | | | | Salt’s | |
| | | | | | | (f) | anion | (h) |
| | (a) | (b) | (c) | (d) | (e) | Salt’s | at fresh | Ratio |
| Paste | K⁺ | Na⁺ | Ca²⁺ | OH⁻ | SO₄²⁻ | anion* | state | (f)/(g) |
| OPC | 385.2 | 171.1 | 1.6 | 545.8 | 9.6 | −5.4 | — | |
| 2% CBz | 420.1 | 199.8 | 3.7 | 272.9 | 6.1 | 342.2 | 132.1 | 2.59 |
| 2% MAc | 509.5 | 249.9 | 5.5 | 241.5 | 2.0 | 524.7 | 207.2 | 2.53 |
| 2% CAc | 552.4 | 275.6 | 7.2 | 209.9 | 1.6 | 629.2 | 252.5 | 2.49 |
| 5% CB | 462.0 | 222.0 | 5.2 | 199.5 | 4.7 | 485.3 | 470.8 | 1.03 |
| 5% MB | 428.2 | 202.8 | 3.6 | 272.9 | 6.0 | 353.2 | 380.5 | 0.93 |
| 4% CFo | 558.0 | 277.7 | 7.9 | 209.9 | 1.2 | 639.2 | 683.8 | 0.93 |
| 5% CN | 438.0 | 199.9 | 3.0 | 314.8 | 1.9 | 325.6 | 470.8 | 0.69 |
| 5% MN | 427.8 | 198.2 | 2.6 | 378.4 | 2.2 | 248.3 | 433.3 | 0.57 |

*calculated via charge balance

A few observations can be made from the data in Table 8. As the pastes hydrate between 0 and 7 days, the volume of their pore solution decreases and as such the concentration of the salt's anion should increase. This is observed for the benzoate and acetate salts as represented by the column (h). For the other salts, the salt's anion concentration remains the same or decreases between 0 and 7 days, indicating that the anion is partially removed from the pore solution over time. As mentioned before, salts whose anion does not largely remain in the pore solution exhibit a lower pH reduction efficiency. It is interesting to note that ranking the salts based on column (h), which represents how well the salt's anion persists in the pore solution, leads to the same ranking as when the salts are sorted by their estimated efficiency factor in Table 7. This confirms that the efficiency of each salt is directly related with the ability of its anion to remain in the pore solution over time. It is also noted that the concentration of alkali ions is higher in pastes containing the admixed salts in comparison with the OPC paste. The reason for this is unknown but may be due to lower uptake of alkalis by C-S-H at lower pH as less deprotonation of C-S-H surface is anticipated at lower pH.

Overall, based on the results and discussion provided in this section, four additional factors are introduced here to aid in identifying the most suitable ASR inhibiting salts:

Factor 4—In an embodiment, the calcium salt of the admixed anion should have a higher solubility than calcium hydroxide within the relevant pH range 13 to 14. Otherwise the admixed anion is almost entirely removed from the pore solution (e.g., in the case of fluoride salts) via precipitation of the calcium-anion salt and dissolution of Ca(OH)₂ which neutralizes the acidifying effect of the admixture.

Factor 5—In an embodiment, the salt should produce a pore solution pH in the range 12.0 to 13.50 to be considered “highly effective”, while salts that produce a long-term pH in the range 13.50 to 13.65 can be considered “moderately effective”. This is to ensure effective ASR mitigation without generating adverse early-age effects due to pH<12.

Factor 6—In an embodiment, the maximum salt dosage required to reduce the pH below 13.65 should be less than 10% of cement mass. This is for economic reasons and to minimize impact on cement hydration and strength development.

Factor 7—In an embodiment, the salt should not produce significant negative side effects on concrete performance. In this study, impacts on workability, strength development, setting of mortar and ASR performance of concrete were quantified. The ASR mitigation performance was also directly evaluated using ASTM C1293, the concrete prism test (see above). The impacts of the salt admixture on other durability metrics of concrete are the subject of our ongoing research.

By applying the factors 1 to 6, and considering the results presented in Tables 4 to 8, the twelve most promising salts identified are shown below.

Calcium benzoate.3H₂O (CBz);

Magnesium acetate.4H₂O (MAc);

Calcium acetate.1H₂O (CAc);

Calcium Nitrite (Cni);

Magnesium Nitrite (Mni);

Calcium bromide.2H₂O (CB);

Magnesium bromide.6H₂O (MB);

Ferrous fumarate (F2Fu);

Calcium formate (CFo);

Calcium nitrate.4H₂O (CN);

Magnesium nitrate.6H₂O (MN); and

Aluminum nitrate.9H₂O (AN).

These salts will be referred to by their abbreviated forms in the remainder of this document and are further tested based on factor 7 to evaluate their impact on the workability, strength, and setting of mortars, and ASR performance of concrete. Tests on calcium nitrite (Cni) and magnesium nitrite (Mni) are still pending and are in progress. Cni is currently being tested at 2% and 3% dosage as well, given the good performance at 5%. Also, one combination (4% CFo+1% CB) is tested (for the mortar tests alone) to show the possibility of combining these salts.

### Performance of Mixtures Incorporating the ASR Inhibiting Salts

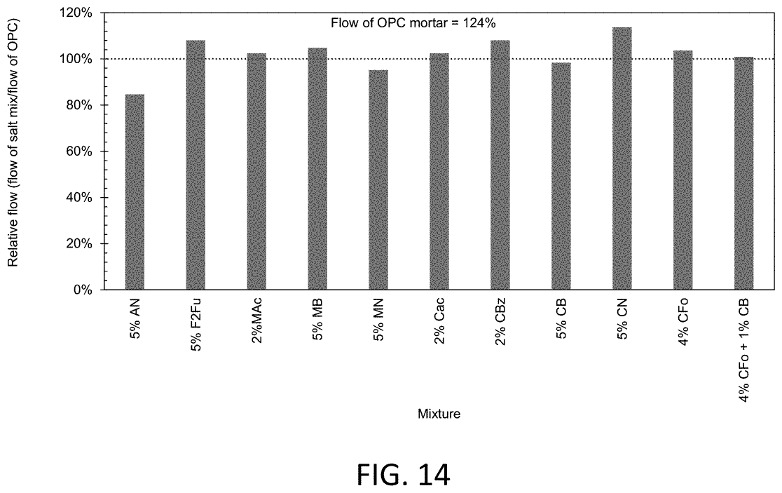

Separate mixtures were tested for of the 10 promising salts listed above (excluding calcium nitrite (Cni) and magnesium nitrite (Mni)) as well as the combination (4% CF+1% CB). The results of the mortar flow test, compressive strength, and setting time tests are shown in FIGS. 14, 15 and 16, respectively.

It can be seen (FIG. 14) that most salts do not negatively affect the flow. Except 5% AN which reduced the flow by 19% (likely due to enhanced formation of ettringite), all other salts either increased the flow or had no significant impact.

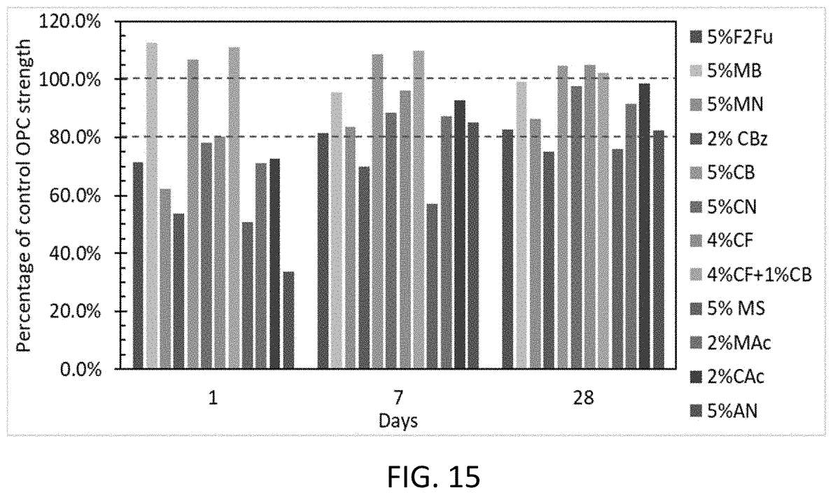

It can be seen from FIG. 15 that most of the salts (except those containing bromide) reduced the 1-day strength of the mortar. While the effect is severe in the case of 5% AN, 2% CBz, 5% MS, and 5% MN; the remaining salts manage to achieve at least 70% of the OPC strength at 1 day. By 7 days, most of the salts achieve at least 80% of the OPC strength and by 28 days most salts are approaching the OPC strength. 5% MS and 2% CBz did not reach at least 80% of the OPC strength at 7 or 28 days, and as such, were excluded from further consideration.

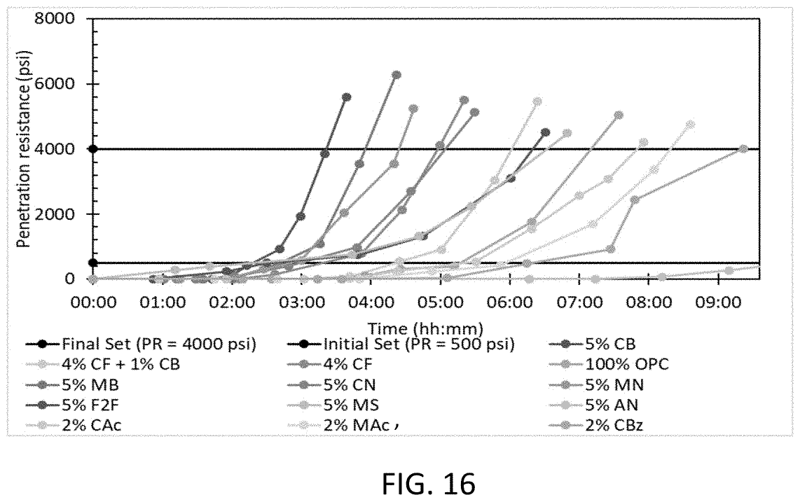

From the setting time results in FIG. 16, it can be seen that 5% AN performs very poorly. As such, AN was excluded from further consideration due to its poor 1-day strength and delayed setting, which is attributed to its low fresh pH and retardation of C₃S hydration, as mentioned earlier. Further, in FIG. 16, the salts with the most similar setting performance to the control (100% OPC2 mortars) are 2% CAc, 2% MAc, and 5% F2Fu. The majority of other salts including 5% CB, 5% MB, 5% MN, 4% CF, and 5% CN performed as set accelerators and may be suitable in cold weather construction while also providing ASR mitigation. The combination 4% CF+1% CB exhibited a performance that was more similar to 100% OPC2 than the individual salts did independently. Thus, salt combinations could also be potentially used to adjust for any setting time issues. It should be noted that the necessary dosage of each salt varies based on the alkali loading of concrete, the reactivity of aggregates, and the level of ASR mitigation intended. Since the accelerating/retarding effects of the ASR inhibiting salts can change significantly with dosage, trial batch testing is recommended to achieve a desired workability and setting performance using commercial admixtures.

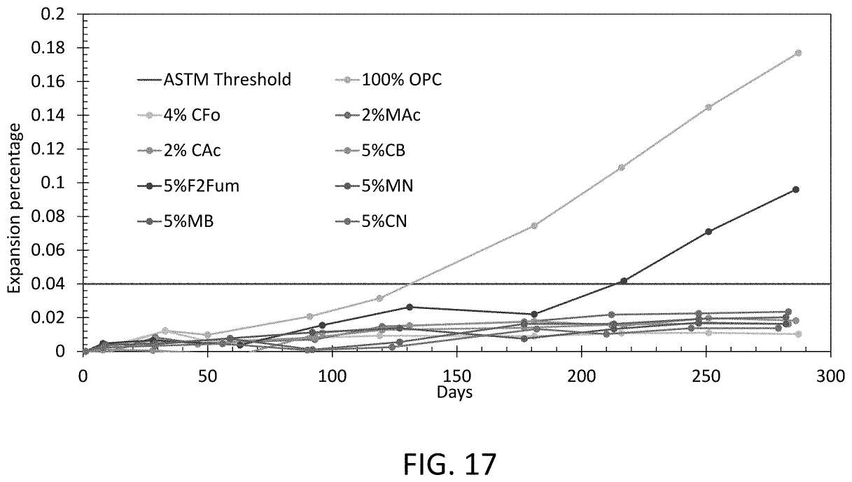

Finally, the performance of the promising salts in the ASR concrete prism test (ASTM C1293, see above) is shown in FIG. 17. All of the promising salts tested except ferrous fumarate are showing good performance. The reason for the poor performance of ferrous fumarate is not currently clear and as such, this salt has been excluded at this time from the final list of ASR inhibiting salts.

Overall, and after imposing factor 7 of the guidelines, the following 7 salts are deemed most promising for use as ASR inhibiting concrete admixtures: CAc, MAc, CFo, CB, MB, CN, and MN. Calcium nitrite (Cni) is also promising but is yet to be tested for factor 7. Magnesium nitrite (Mni) is being tested for factors 5 and 7. These salts are currently undergoing further concrete performance tests to evaluate their impact on concrete fresh state properties, mechanical properties, and durability.

### Commercial Use of ASR Inhibitor Salts

The above ASR-inhibiting salts may be introduced into concrete in several ways:
1) In powder form, inter-ground with Portland cement clinker;
2) In powder form, pre-blended with Portland cement;
3) In powder form, pre-blended or inter-ground with supplementary cementitious materials (SCMs), including but not limited to various forms of fly ash;
4) In powder form added to fresh concrete during mixing;
5) In pre-dissolved aqueous form (i.e., as a liquid chemical admixture) added to fresh concrete during mixing; and
6) In pre-dissolved aqueous form sprayed onto SCMs, including but not limited to various forms of fly ash.

### SUMMARY

Controlling the pH of concrete pore solution can mitigate ASR. This work presented a methodical approach for identifying a unique group of salts that are capable of regulating the pH of concrete without producing negative side-effects on other critical properties such as workability, setting, and strength development. This group includes a list of 7 most promising salts that can be used in a powder form or in a pre-dissolved aqueous form at a dosage of 5% or less based on portland cement mass. These 7 salts are: calcium acetate, magnesium acetate, calcium formate, calcium bromide, magnesium bromide, calcium nitrate, and magnesium nitrate. Additionally, calcium nitrite (currently being tested) and magnesium nitrite (to be tested in the near future) could also be potentially a part of the final list of promising salts. A blend of the above salts can be used as well. In addition, a blend of one or more of the above salts with a slowly dissolving source of aluminum (such as Al(OH)₃) can be used. It was observed that the pH-reduction efficiency of each salt is directly related with the ability of its anion to remain in the pore solution over time.

Due to the challenges with the current ASR mitigation strategies—cost, availability, and variability—these new ASR mitigation admixtures have the potential to be widely adopted by the concrete industry when commercialized. The use of the proposed ASR mitigation admixtures (which comprise certain inorganic and organic salts of aluminum, calcium, magnesium, and iron) should increase the longevity of key infrastructure and reduce their maintenance and life-cycle costs.

The ASR mitigation admixtures of the present invention have a number of key advantages over the existing ASR mitigation strategies. They are less expensive when compared to lithium; and when compared to SCMs, the supply stream of the ASR mitigation admixtures will be more consistent in terms of their availability, quality, and effectiveness against ASR, since these admixtures will be engineered products specifically designed for concrete as opposed to SCMs which are byproducts of other industries (such as power generation and iron smelting industries). As a result, the ASR mitigation admixtures can be dosed accurately and ensured to not have unwanted side-effects on the fresh and hardened properties of concrete. This contrasts with SCMs that often reduce the early-age strength and delay the setting time of concrete, especially in colder construction seasons.

A summary of the approach used in this study to identify the ASR inhibiting salts is shown in Table 9.

TABLE 9
Technical factors used to identify ASR-inhibiting salts for use in concrete

| | Salts examined further after |
|---|---|
| Factor for salts | applying each factor |
| 1- The salt should have an abundant multivalent | 174 |
| cation | |
| 2- The salt should be easily available, stable, non- | 35 |
| hazardous, inexpensive, and without known | |
| negative effects in concrete | |
| 3- The water solubility limit of the salt should be | 23 |
| higher than that of its hydroxide | |
| 4- The calcium salt of the admixed anion should have | 1 (Al) + 1 (Fe-II) + |
| a higher solubility than calcium hydroxide within | 0 (Fe-III) + 4 (Mg) + |
| the relevant pH range 13 to 14 | 6 (Ca) = 12 |
| 5- The salt should produce a pore solution pH in the | |
| range 12.0 to 13.50 to be considered “highly | |
| effective”, while salts that produce a long-term pH | |
| in the range 13.50 to 13.65 can be considered | |
| “moderately effective”. | |
| 6- The maximum salt dosage required to reduce the | |
| pH below 13.65 should be less than 10% of cement | |
| mass | |
| 7- The salt should not produce significant negative | 7 salts pass all technical |
| side effects on concrete performance | factors based on mortar and |
| | ASR tests. Two salts are still |
| | being tested. |

TABLE 10
List of 174 salts of Al, Fe-II, Fe-III, Mg, or Ca that were evaluated in this work.

| | | |
|---|---|---|
| | Experimentally | |
| Salt | tested? | Comments |

Aluminum (Al) salts

| | | |
|---|---|---|
| Aluminum acetate | No | Not available |
| Aluminum benzoate | No | Not available |
| Aluminum bromate | No | Not available |
| Aluminum bromide | No | High cost |
| Aluminum chlorate•9H₂O | No | Corrosion risk; toxic |
| Aluminum chloride | No | Corrosion risk |
| Aluminum chloride•6H₂O | No | Corrosion risk |
| Aluminum citrate | No | Not available |
| Aluminum fluoride | Yes at 4% | High cost; calcium fluoride solubility |
| | | too low. |
| Aluminum fluoride•xH₂O | No | High cost |
| Aluminum formate | No | Not available |
| Aluminum gluconate | No | Not available |
| Aluminum hypophosphite | No | Not available |
| Aluminum iodate | No | Not available |
| Aluminum iodide | No | High cost |
| Aluminum iodide•6H₂O | No | High cost |
| Aluminum lactate | No | High cost |
| Aluminum nitrate | No | Hydrated form was tested. |
| Aluminum nitrate•9H₂O | Yes at 5% | Early age pH ≈11 at 10% dosage. |
| | and 10% | Strength and setting issues at 5% |
| | | dosage. |
| Aluminum oleate | No | Not available |
| Aluminum oxalate•1H₂O | No | High cost; insoluble in water |
| Aluminum perchlorate | No | Toxicity |
| Aluminum | No | Toxicity |
| perchlorate•9H₂O | | |
| Aluminum phosphate | No | Solubility (7.9 × 10⁻¹⁰ M) too low. |
| | | Q/K_{pH = 13} = 2.65 × 10⁻⁸ |
| Aluminum | No | Solubility too low |
| phosphate•2H₂O | | |
| Aluminum propionate | No | Not available |
| Aluminum salicylate | No | High cost |
| Aluminum sulfate | No | Causes loss of workability and rapid |
| | | setting of concrete due to ettringite |
| | | formation. |
| Aluminum sulfate•18H₂O | No | Similar to the anhydrous form. |

Ferrous (Fe-II) salts

| | | |
|---|---|---|
| Ferrous acetate | No | High cost |
| Ferrous acetate•4H₂O | No | High cost |
| Ferrous bicarbonate | No | Not available |
| Ferrous bromate | No | Not available |
| Ferrous bromide | No | High cost |
| Ferrous bromide•6H₂O | No | High cost |
| Ferrous carbonate | No | Solubility (6.6 × 10⁻⁴ g/l) too low: |
| | | Q/K_{pH = 13} = 0.72 |
| Ferrous chloride | No | Corrosion risk |
| Ferrous chloride•xH₂O | No | Corrosion risk |
| Ferrous citrate | No | Not available |
| Ferrous dihydrogen | No | Not available |
| phosphate | | |
| Ferrous fluoride | No | High cost |
| Ferrous fluoride•4H₂O | No | High cost |
| Ferrous formate | No | Not available |
| Ferrous fumarate | Yes at 5%, 6%, | Failed C1293 test at 5%. |
| | and 10% | |
| Ferrous gluconate | No | Not available |
| Ferrous hydrogen | No | Not available |
| phosphate | | |
| Ferrous hypophosphite | No | Not available |
| Ferrous iodate | No | Not available |
| Ferrous iodide | No | High cost |
| Ferrous iodide•4H₂O | No | High cost |
| Ferrous lactate | No | Not available |
| Ferrous nitrate | No | Not available |
| Ferrous nitrate•6H₂O | No | Not available |
| Ferrous nitrite | No | Not available |
| Ferrous oleate | No | Not available |
| Ferrous oxalate•2H₂O | Yes at 10% | Calcium oxalate has low solubility. |
| Ferrous perchlorate | No | Physical hazard - 3 |
| Ferrous phosphate | No | Not available |
| Ferrous phosphite | No | Not available |
| Ferrous sulfate | No | Sulfate not suitable |
| Ferrous sulfate•7H₂O | No | Sulfate not suitable |
| Ferrous sulfite | No | Not available |

Ferric (Fe-III) salts

| | | |
|---|---|---|
| Ferric acetate | No | Not available |
| Ferric benzoate | No | Not available |
| Ferric bicarbonate | No | Not available |
| Ferric bromate | No | Not available |
| Ferric bromide | No | High cost |
| Ferric citrate•5H₂O | Yes at 10% | Severely affects hydration |
| Ferric chloride | No | Corrosion risk |
| Ferric chloride•6H₂O | No | Corrosion risk |
| Ferric fluoride | Yes at 5% | High cost; calcium fluoride has low |
| | | solubility. |
| Ferric fluoride•3H₂O | No | High cost |
| Ferric formate | No | Not available |
| Ferric glycerophosphate | No | Not available |
| Ferric hypophosphite | No | High cost; Insoluble |
| | | (<0.01 g/100 gH₂O) |
| Ferric iodate | No | Not available |
| Ferric nitrate | No | Hydrated form was considered. |
| Ferric nitrate•9H₂O | Yes at 10% | Early age pH = 11.65, later age pH |
| | | close to boundary at 10% dosage. |
| Ferric oxalate | No | Only hexahydrate form is available - |
| | | costly |
| Ferric oxide | No | Solubility too low |
| Ferric perchlorate•6H₂O | No | Toxicity |
| Ferric phosphate•2H₂O | Yes at 10% | High cost; calcium phosphate has low |
| | | solubility. |
| Ferric phosphide | No | High cost |
| Ferric pyrophosphate | No | Insoluble (<0.01 g/100 gH₂O) |
| Ferric sulfate | No | Only the hydrated form is available. |
| Ferric sulfate•5H₂O | No | Sulfate not suitable |

Magnesium (Mg) salts

| | | |
|---|---|---|
| Magnesium acetate | No | Only the hydrated form is available. |
| Magnesium acetate•4H₂O | Yes at 2%, 3%, | Acceptable |
| | 4%, 5%, and 10% | |
| Magnesium bicarbonate | No | Not available |
| Magnesium bromate•6H₂O | No | Not available |
| Magnesium bromide | No | Tested the hydrated form. |
| Magnesium | Yes at 5% | Acceptable |
| bromide•6H₂O | and 10% | |
| Magnesium carbonate | No | Not available. Solubility |
| | | (Q/K_{pH = 13} = 1.7 × 10⁵) too low. |
| Magnesium | No | Not available |
| carbonate•xH₂O | | |
| Magnesium chlorate•6H₂O | No | Corrosion risk |
| Magnesium chloride | No | Corrosion risk |
| Magnesium chloride•6H₂O | No | Corrosion risk |
| Magnesium citrate | Yes at 10% | Citrates negatively affect cement |
| | | hydration. |
| Magnesium citrate•14H₂O | No | Anhydrous form was tested. |
| Magnesium dibenzoate | No | Not available |
| Magnesium dihydrogen | No | Not available |
| phosphate | | |
| Magnesium fluoride | Yes at 5% | Calcium fluoride has low solubility |
| Magnesium formate•2H₂O | No | Primarily available in solution form - |
| | | high cost |
| Magnesium di- | No | High cost |
| gluconate•2H₂O | | |
| Magnesium | No | High cost |
| glycerophosphate | | |
| Magnesium hydrogen | Yes at 10% | Calcium Hydrogen Phosphate has |
| phosphate•3H₂O | | low solubility |
| Magnesium iodate | No | Not available |
| Magnesium iodide | No | High cost |
| Magnesium iodide•8H₂O | No | High cost |
| Magnesium lactate | No | High cost |
| Magnesium laurate | No | Not available |
| Magnesium malate | No | Not available |
| Magnesium myristate | | Not available |
| Magnesium nitrate | No | Not available |
| Magnesium nitrate•6H₂O | Yes at 5%, 6%, | Acceptable |
| | and 10% | |
| Magnesium nitrite | Not yet | May be acceptable. Must be tested. |
| Magnesium oleate | No | Not available |
| Magnesium oxalate•2H₂O | Yes at 10% | Calcium oxalate has low solubility |
| Magnesium perchlorate | No | Toxicity |
| Magnesium | No | Toxicity and corrosion risk |
| perchlorate• 6H₂O | | |
| Trimagnesium | No | Solubility too low |
| phosphate•xH₂O | | |
| Magnesium phosphonate | No | Not available |
| Magnesium stearate | No | Solubility too low. |
| Magnesium sulfate | Yes at 5% | Sulfates not suitable. |
| Magnesium sulfate•7H₂O | No | Tested the anhydrous form. |
| Magnesium sulfite | No | Not available |
| Magnesium sulfite.6H₂O | No | Not available |
| Magnesium tetrahydrogen | No | Not available |
| phosphate•2H₂O | | |

Calcium (Ca) salts

| | | |
|---|---|---|
| Calcium acetate | No | Hydrated form tested. |
| Calcium acetate•1H₂O | Yes at 2%, 3%, | Acceptable |
| | 4%, 5%, and 10% | |
| Calcium benzoate•3H₂O | Yes at 2%, 4%, | Efficiently reduces pH but affects |
| | 5% and 10% | strength |
| Calcium bicarbonate | No | Not available |
| Calcium bromate•H₂O | No | Not available |
| Calcium bromide | No | Tested the hydrated form |
| Calcium bromide•2H₂O | Yes at 5% | Acceptable |
| | and 10% | |
| Calcium carbonate | No | Solubility below Ca(OH)₂; Q/K < 1 |
| (Calcite) | | |
| Calcium carbonate | No | Solubility below Ca(OH)₂; Q/K < 1 |
| (Aragonite) | | |
| Calcium carbonate | No | Not available |
| (Vaterite) | | |
| Calcium chlorate | No | Not available |
| Calcium chloride | No | Corrosion risk |
| Calcium chloride•xH₂O | No | Corrosion risk |
| Calcium citrate•4H₂O | Yes at 10% | Solubility too low, Q/K_{pH = 13} = 0.57 < 1 |
| Calcium di-gluconate•H₂O | Yes at 10% | Rapid setting and poor strength. pH |
| | | measurement was not possible. |
| Calcium dihydrogen | Yes at 10% | Fresh pH was too low possibly due to |
| phosphate•H₂O | | deprotonation of the salt |
| Calcium fluoride | Yes at 10% | Solubility too low Q/K_{pH = 13} = 0.08 < 1 |
| Calcium formate | Yes at 4%, 5%, | Acceptable |
| | 10% | |
| Calcium fumarate | No | Not available |
| Calcium glycerophosphate | No | High cost |
| Calcium hydrogen | Yes at 10% | Solubility (Q/K_{pH = 13} = 0.45 < 1) too low |
| phosphate CaHPO₄•2H₂O | | |
| Calcium hypophosphite | No | Produces phosphine gas upon heating. |
| (phosphinate) | | |
| Calcium iodate | No | Hazardous |
| Calcium iodide•6H₂O | No | High cost |
| Calcium isobutyrate | No | Not available |
| Calcium lactate | Yes at 5% | Forms combustible dust - only tested |
| | (pre-suspended | in pre-suspended form |
| | form) | |
| Calcium 1-quinate | No | Not available |
| Calcium malate | No | Not available |
| Calcium methylbutyrate | No | High cost |
| Calcium nitrate | No | Not available |
| Calcium nitrate•4H₂O | Yes at 5%, 10% | Acceptable |
| Calcium nitrite.H₂O | Yes at 5%, 3%, | Available in liquid form |
| | and 2% | |
| Calcium oleate | No | Not available |
| Calcium oxalate | No | Solubility too low |
| | | (<0.001 g/100 gH₂O) |
| Calcium oxlate•H₂O | No | Solubility too low |
| | | (<0.001 g/100 gH₂O) |
| Calcium perchlorate | No | Not available; toxic |
| Calcium perchlorate•4H₂O | No | Physical (3) and health (2) hazard |
| Calcium permanganate | No | Not available |
| Calcium phosphate | No | Solubility too low (0.002 g/100 gH₂O) |
| Calcium phosphite | No | Not available |
| Calcium phosphonate•H₂O | No | Not available |
| Calcium propionate | Yes at 10% | No pore fluid and high porosity |
| Calcium salicylate | No | High cost |
| Calcium sulfate•2H₂O | No | Already present in cement |
| Calcium sulfite | No | Not available |
| | | Solubility: 0.0059 g/100 gH₂O too low |
| Calcium valerate | No | Not available |

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A cementitious composition comprising:
i) cement; and
ii) an admixture for mitigating alkali-silica reaction, the admixture comprising an organic or inorganic salt selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof:
wherein the organic or inorganic salt is present in the cementitious composition in an amount of between 0.5% to 12% based on the weight of solids of the organic or inorganic salt as a percentage of the weight of solids of the cement.

2. The cementitious composition of claim 1, wherein the cementitious composition comprises a slowly dissolving source of aluminum in an amount of between about 2% and 10% based on the weight of solids of the slowly dissolving source of aluminum as a percentage of the weight of solids of the cement.

3. The cementitious composition of claim 2, wherein the slowly dissolving source of aluminum comprises one or more of aluminum hydroxide, aluminum oxyhydroxide, aluminum phosphate, aluminum oxalate, aluminum oleate, aluminum hypophosphite, aluminum benzoate, aluminum fluoride.

4. The cementitious composition of claim 1, wherein the cementitious composition further comprises one or more additional additives selected from the group consisting of: water, coarse aggregates, fine aggregates, mineral fillers, retarders, accelerators, water-reducing additives, plasticizers, air entrainers, corrosion inhibitors, specific performance admixtures, lithium admixtures, supplementary cementitious materials (SCMs), fibers, and combinations thereof.

5. The cementitious composition of claim 1, wherein the organic or inorganic salt further comprises a coating of a polymeric or non-polymeric delayed release agent.

6. A concrete product comprising the cementitious composition of claim 1.

7. A method of mitigating alkali-silica reaction in a concrete product, the method comprising:
providing cement, cement clinker, or cement clinker derived material;
providing an organic or inorganic salt comprising an aluminum, calcium, magnesium, or iron cation;
mixing the cement, cement clinker, or cement clinker derived material with an amount of the organic or inorganic salt to form a cement mixture;
adding water and, optionally, aggregates or other concrete additives or both, to the cement mixture to form a fresh concrete mixture having a pH of between about 12.0 and 13.65; and
pouring and curing the fresh concrete mixture to form a concrete product having a pore solution pH that is maintained between about 12.0 and 13.65 over a period of 28 days after forming the fresh concrete;
wherein the cement, cement clinker, or cement clinker derived material and the organic or inorganic salt are provided in powder or granular form before or after mixing them, but before forming a fresh concrete mixture.

8. The method of claim 7, wherein the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof.

9. The method of claim 7, wherein the step of mixing the cement, cement clinker, or cement clinker derived material with an amount of an organic or inorganic salt to form a cement mixture comprises the step of adding the organic or inorganic salt in an amount of between about 0.5 wt % and 12 wt % based on the weight of solids of the organic or inorganic salt as a percentage of the weight of solids of the cement.

10. The method of claim 7, wherein the method, or any step thereof, further comprises the step of adding a slowly dissolving source of aluminum.

11. The method of claim 7, wherein the cement, cement clinker, or cement clinker derived material solids are dry-blended or inter-ground with the organic or inorganic salt solids at an amount of the organic or inorganic salt so that a homogeneous concrete mixture made with the cement mixture will have a pH of between about 12.0 and 13.65.

12. The method of claim 7, wherein the method, or any step thereof, further comprises the step of dry-blending or inter-grinding one or more supplementary cementitious material (SCM) with the organic or inorganic salt.

13. The method of claim 7, wherein the organic or inorganic salt is provided as a coating on an SCM.

14. The method of claim 7, wherein the organic or inorganic salt is dissolved or dispersed in a solvent to form a liquid admixture.

15. A method of mitigating alkali silica reaction in a concrete product, the method comprising:
providing cement;
mixing the cement with an organic or inorganic salt, which provides an aluminum, calcium, magnesium, or iron cation, and water and other concrete ingredients to form a fresh concrete mixture; and
pouring and curing the fresh concrete mixture to form a concrete product with a corresponding pore solution pH of between 12.0 and 13.65.

16. The method of claim 15, wherein the organic or inorganic salt is selected from the group consisting of: magnesium acetate, magnesium bromide, magnesium nitrate, magnesium nitrite, magnesium sulfate, calcium acetate, calcium benzoate, calcium bromide, calcium formate, calcium nitrate, calcium nitrite, and combinations thereof.

17. The method of claim 15, wherein the method, or any step thereof, further comprises the step of adding a slowly dissolving source of aluminum.

18. (canceled)

19. The method of claim 15, wherein the method, or any step thereof, further comprises the step of dry-blending or inter-grinding one or more SCM with the organic or inorganic salt.

20. The method of claim 15, wherein the organic or inorganic salt is provided as a coating on an SCM.

21. The method of claim 15, wherein the organic or inorganic salt is dissolved or dispersed in a solvent to form a liquid admixture.
